(19) United States
(12) Patent Application Publication
(10) Pub. No.: US 2025/0388279 A1
(43) Pub. Date: Dec. 25, 2025

(54) AUTOMATED ATTACHMENT OF SKIN SEGMENTS TO FRAMES

(71) Applicant: Divergent Technologies, Inc., Los Angeles, CA (US)

(72) Inventors: Bahram ISSARI, Laguna Niguel, CA (US); Michael Thomas KENWORTHY, Rancho Palos Verdes, CA (US); Matthew Cooper KELLER, Marina Del Rey, CA (US); Keith MCKAY, Laguna Niguel, CA (US); Gordon TAJIRI, Los Angeles, CA (US); Richard Winston HOYLE, Clarkston, MI (US); Stephen Paul OKUNIEWSKI, Hermosa Beach, CA (US); Ryan Thomas ANTENUCCI, Los Angeles, CA (US); Patrick Park ANGELO, Los Angeles, CA (US); Eric Paul MONTEITH, Long Beach, CA (US)

(21) Appl. No.: 19/244,917

(22) Filed: Jun. 20, 2025

Related U.S. Application Data
(60) Provisional application No. 63/662,373, filed on Jun. 20, 2024.

(51) Int. Cl. B62D 65/02; B62D 65/06

(52) U.S. Cl. CPC B62D 65/026; B62D 65/06

(57) ABSTRACT

An apparatus includes a skin connected to a structure. A window in the skin or structure allows radiation to cure an adhesive between the skin and structure to fix the skin to the structure. A structural connection is provided between the skin and structure and may include a structural adhesive. A protrusion may be on either the skin or the structure and contacts an adhesive within a feature of the skin or the structure to fix the skin and the structure. A method of forming the apparatus includes a robotic system including one or more robots joining the skin and structure. The one or more robots move the skin and/or the structure within a joining proximity of one another, apply a radiation to cure an adhesive between the skin and structure and form a structural connection between the skin and the structure.

### CROSS-REFERENCE TO RELATED APPLICATIONS

This application claims the benefit of U.S. Provisional Application No. 63/662,373, entitled “Automated attachment of skin segments to frames” and filed on Jun. 20, 2024, which is expressly incorporated by reference herein in its entirety.

### BACKGROUND

### Field

The present disclosure relates to apparatuses formed of components and methods of assembling components, and more specifically to techniques for components to be assembled using a robotic system.

### Background

Vehicles such as aircraft, automobile, truck, airplanes and helicopters are made of a large number of individual components joined together to form the body, frame, interior and exterior surfaces, etc. These components such as structural components provide form to the automobile, truck and aircraft, and respond appropriately to the many different types of forces that are generated or that result from various actions like accelerating and braking. These structural components also provide support. Structural components of varying sizes and geometries may be integrated in a vehicle such as a car or an aircraft, for example, to provide an interface between panels, extrusions, and/or other structures. Thus, structural components may be an integral part of vehicles such as a car or an aircraft.

These structural components are typically assembled manually, for example, by welding and/or using fasteners to connect the structural components together. This typical assembly is not cost effective and is an extremely time consuming process.

However, if components are robotically assembly, the components require the use of fixtures. For example, in automobile factories, each part of the automobile that will be robotically assembled requires a unique fixture that is specific to that part. Given the large number of individual parts in an automobile that are robotically assembled, an equally large number of fixtures are required. In fact, a modern automobile chassis can consist of thousands of assembled parts, each part requiring a specially-designed fixture for assembly. However, fixtures can be extremely expensive. In fact, it is not unusual for a single fixture for an automobile part to cost hundreds of thousands of dollars. The cost of the fixtures used in an automobile factory is a large portion of the cost of the entire factory. As a result, building a modern automobile factory requires a massive capital investment, making it necessary to build and sell hundreds of thousands of cars just to recapture the initial investment and break even.

In addition to their enormous cost, fixtures can only be used for the specific part for which they are designed. Therefore, if a part is changed in some way, for example, if the car model's design is updated, an entirely new fixture must be designed and built. This adds significant cost and time to the process of changing or updating car models. As a result, automobiles models are updated only infrequently, for example, every five or six years or more. In addition, the cost and inflexibility of fixtures has caused the automobile industry to look towards using common structures across different vehicle models, such as using the same subframe for a car model and an SUV model. However, this commonality can severely limit the design of each vehicle forced to share the structure. As a result, vehicles on the road begin to look more and more the same, and consumers are left with fewer distinct choices.

Since the dawn of robotic assembly of cars, automobile manufacturers have unquestionably relied on fixtures. This unquestioning reliance has, in part, created an automobile industry that is dominated by relatively few manufacturers that are able to invest the massive amount of capital required to build a modern automobile factory, and then build and sell the hundreds of thousands of that factory's particular car model, year after year over five or more years, in order to recover the initial investment and begin to generate a profit. This unquestioning reliance has also resulted in fewer choices for consumers as cars that look more and more alike each passing year.

Therefore, there is a need to assemble components in a precise, reproducible and timely manner as well as in an efficient and economical way. This disclosure solves this need with an apparatus and a process that forms, builds and assembles components together in a precise, reproducible, and timely manner in an efficient and economical way.

### SUMMARY

In contrast to conventional manufacturing, the present disclosure envisions assembly of components in an automatic manner such as robotically assembling the components in an efficient and economical manner. Such assembly operations may include joining two or more structures (e.g., additively manufactured structures such as nodes), parts, components, skins, and the like. In joining multiple structures with adhesive ensures sufficient strength to the assembly (i.e., the assembled structures) while meeting design requirements. Moreover, when assembling these structures in an automatic manner, such as robotic assembly, these assembled structures are also able to meet dimensional requirements.

For example, joining multiple structures may result in assembly of at least a portion of a body, frame, chassis, panel(s), base piece, skin, hood, roof, trunk, etc. of a vehicle including a fuselage, skin, wing, winglet, tail, etc. of an aircraft. Advantageously, the present disclosure describes such assembly operations through controlling a set of robots to join structures without the use of fixtures. Structures joined by the set of robots may be additively manufactured.

Because vehicles such as a car or an aircraft are to be safe, reliable, and so forth, approaches to accurately performing various assembly operations associated with production of vehicles such as a car or an aircraft may be beneficial. Such approaches to various assembly operations may be performed by at least one robotic apparatus (hereinafter, robot) that may be instructed via a set of instructions to cooperate in assembling at least a portion of a vehicle (e.g., body, chassis, frame, panel(s), base piece, skin, hood, roof, trunk, etc.) including an aircraft (e.g., fuselage, skin, wing, winglet, tail, etc.). Accordingly, a controller and/or other processing system may implement various techniques to generate and/or execute instructions for at least one robot that directs the at least one robot to one or more positions suitable for performing various assembly operations.

In the present disclosure, techniques, methods, apparatuses and approaches are described for directing a set of robots to join at least two structures without the use of fixtures when assembling at least a portion of a vehicle such as a car or an aircraft. Such techniques and approaches may be enabled through various systems, methods, apparatuses, and/or computer-readable media described herein.

By way of example, a computing system may direct a first robotic arm to a first position based on a first set of coordinates. The computing system may cause the first robotic arm to engage with a first structure based on the first position of the first robotic arm. Further, the computing system may direct the first robotic arm to a second position based on a second set of coordinates such that the first structure is brought within a joining proximity of a second structure without a fixture retaining the first structure and without a fixture retaining the second structure, wherein the first structure is configured to be joined with the second structure when the first and second structures are within the joining proximity, the joining proximity being a proximity at which the first and second structures can be joined together. Each of the first and second structures may be one or more components. For example, if the first or second structure includes two or more components, the two or more components may have been connected/joined by any of the various methods and techniques disclosed throughout the disclosure. Also throughout this disclosure, the terms component and structure are used interchangeably.

In one or more embodiments, the disclosure describes and provides a method of connecting a skin to a structure.

In one embodiment, the skin may include a window and the structure may include a complementary portion corresponding to the window. The method may include controlling a robotic system to i) move at least the skin or the structure such that the window and the complementary portion are proximate to each other; ii) apply a first adhesive between the window and the complementary portion, the first adhesive may be a radiation cured adhesive; iii) cure the first adhesive by applying a radiation to the first adhesive such that the skin is fixed to the structure and iv) form a structural connection between the skin and the structure. The structural connection may be separate from the first adhesive. The radiation may be applied through the window. The window may include one or more apertures.

In one embodiment, the structure may include a window and the skin may include a complementary portion corresponding to the window. The method may include controlling a robotic system to i) move at least the skin or the structure such that the window and the complementary portion are proximate to each other; ii) apply a first adhesive between the window and the complementary portion, the first adhesive may be a radiation cured adhesive; iii) cure the first adhesive by applying a radiation to the first adhesive such that the skin is fixed to the structure and iv) form a structural connection between the skin and the structure. The structural connection may be separate from the first adhesive. The radiation may be applied through the window. The window may include one or more apertures.

In one or more embodiments, forming a structural connection may include forming the structural connection such that the skin and the structure do not contact.

In one or more embodiments, forming a structural connection may include applying a second adhesive between the skin and the structure.

In one or more embodiments, forming the structural connection may include curing the second adhesive such that the skin is connected to the structure.

In one or more embodiments, forming a structural connection may include one or a combination of glueing, welding, brazing, riveting, screwing or fastening the skin to the structure.

In one or more embodiments, the first adhesive may include a first composition and the second adhesive may include a second composition. The first composition may be different from the second composition or the first composition may be the same as the second composition.

In one or more embodiments, the first adhesive may be cured or cures at a first rate and the second adhesive may be cured or cures at a second rate. The first rate may be different from the second rate.

In one or more embodiments, the first adhesive may span the window.

In one or more embodiments, moving at least the skin or the structure may include a robot moving the structure relative to the skin such that the window and the complementary portion are proximate to each other.

In one or more embodiments, moving at least the skin or the structure may include a robot moving the skin relative to the structure such that the window and the complementary portion are proximate to each other.

In one or more embodiments, moving at least the skin or the structure may include a robot moving both the skin and the structure such that such that the window and the complementary portion are proximate to each other.

In one or more embodiments, moving at least the skin or the structure may include retaining at least the skin or the structure without a fixture. Retaining the skin or the structure without a fixture may include controlling one or more robots of a robotic system to engage a corresponding attachment feature of at least the skin or the structure. For example, a first robot may engage a first attachment feature of the skin and a second robot may engage a second attachment feature of the structure.

In one or more embodiments, controlling the robotic system may include covering an outer surface of a frame with the skin. The frame may include one or more components. The one or more components may be connected/joined together.

In one or more embodiments, the method may include controlling a gap between the skin and the structure. Controlling the gap may include providing a spacing material between the skin and the structure.

In one or more embodiments, the spacing material may be transparent to radiation.

In one or more embodiments, a first adhesive and/or a second adhesive may contain a spacing material.

In one or more embodiments, at least the skin or the structure may include a spacing material.

In one or more embodiments, the method may include additively manufacturing at least the skin or the structure.

In one or more embodiments, the method may include co-printing a spacing material with at least the skin or the structure.

In one or more embodiments, the method may include obtaining information of a proximity regarding the skin or the structure.

In one or more embodiments, controlling the movement of at least the skin or the structure may be based on information such as the obtained information.

In one or more embodiments, the information may include force feedback.

In one or more embodiments, the information may include at least visual information or information of a weep tube.

In one or more embodiments, controlling the movement may include stopping the movement of the skin or the structure.

In one or more embodiments, the structure may include a frame. The frame may include one or more components. The one or more components may be connected/joined together.

In one or more embodiments, the structure may be at least a portion/part of a vehicle such as a car or an aircraft. The at least a portion/part of an aircraft may include a fuselage, a skin, a wing, a winglet, a tail, etc. The at least a portion/part of the vehicle may include a frame, a chassis, a base piece, a skin, a body, a hood, a roof, a trunk, one or more panels, etc.

In one or more embodiments, the structure/complementary portion may include a feature configured to contain the first adhesive. The feature may be at least on an inner surface or an outer surface of the structure.

In one or more embodiments, the structure may include a first feature configured to contain the second adhesive. The first feature may include a recess.

In one or more embodiments, the structure/complementary portion may include a second protrusion.

In one or more embodiments, the skin may include a first protrusion.

In one or more embodiments, the window may include a second feature configured to contain at least a portion of the first adhesive.

In one or more embodiments, the window may include an aperture and controlling the robotic system includes inserting the second protrusion within the aperture of the window.

In one or more embodiments, the second feature may be offset from a surface of the skin by an extension element. The extension element may include a plurality of elongated structures.

In one or more embodiments, the second feature may include at least one or more openings or one or more walls.

In one or more embodiments, one wall of the one or more walls may be configured to allow radiation to pass therethrough.

In one or more embodiments, one wall of the one or more walls may include an aperture.

In one or more embodiments, controlling the robotic system may include inserting at least a portion of the first protrusion within at least a portion of the recess.

In one or more embodiments, controlling the robotic system may include inserting at least a portion of the second protrusion within the second feature.

In one or more embodiments, controlling the robotic system may include inserting the second protrusion within the one or more apertures of the window.

In one or more embodiments, controlling the robotic system may comprise inserting the second protrusion through the aperture.

In one or more embodiments, the disclosure describes an apparatus. The apparatus may include a skin fixed and/or connected to a structure.

In one or more embodiments, the apparatus include a skin, a structure, a first adhesive and a structural adhesive. The skin may include a window and the structure may include a complementary portion. The window may include a first region of the skin and the complementary portion may correspond to the window. The first adhesive may fix the window to the complementary portion such that the first region is fixed to the complementary portion by the first adhesive. The first adhesive may be a radiation cured adhesive. The structural adhesive may be between a second region of the skin and the structure.

In one or more embodiments, the apparatus includes a skin, a structure, a first adhesive and a structural adhesive. The structure may include a window and the skin may include a complementary portion. The window may include a first region of the structure and the complementary portion may correspond to the window. The first adhesive may fix the window to the complementary portion such that the first region is fixed to the complementary portion by the first adhesive. The first adhesive may be a radiation cured adhesive. The structural adhesive may be between a second region of the skin and the structure.

In one or more embodiments, the skin may include a first attachment feature configured to be engaged by a robot.

In one or more embodiments, the structure may include a second attachment feature configured to be engaged by a robot.

In one or more embodiments, the structural connection may include a second adhesive between the skin and the structure.

In one or more embodiments, the structural connection may include one or a combination of glueing, welding, brazing, riveting, screwing or fastening the skin to the structure.

In one or more embodiments, the complementary portion may include a feature configured to contain the first adhesive. The feature may be at least on an inner surface or an outer surface of the structure.

In one or more embodiments, the structure may include a frame. An outer surface of the frame may be covered by the skin. The frame may include one or more components. The one or more components may be connected/joined together.

In one or more embodiments, the structure may be a portion/part of a vehicle such as a car or an aircraft. The at least a portion/part of an aircraft may include a fuselage, a skin, a wing, a winglet, a tail, etc. The at least a portion/part of the vehicle may include a frame, a chassis, a base piece, a skin, a body, a hood, a roof, a trunk, one or more panels, etc.

In one or more embodiments, the apparatus may include a spacing material between the skin and the structure. The spacing material may be transparent to radiation.

In one or more embodiments, the first adhesive may contain a spacing material.

In one or more embodiments, at least the skin or the structure may include a spacing material.

In one or more embodiments, the second adhesive may contain a spacing material.

In one or more embodiments, the first adhesive may span the window.

In one or more embodiments, the first adhesive may include a first composition and the second adhesive may include a second composition. The first composition may be different from the second composition or the first composition may be the same as the second composition.

In one or more embodiments, the first adhesive may be cured or cures at a first rate and the second adhesive may be cured or cures at a second rate. The first rate may be different from the second rate. The first adhesive may be cured by radiation.

In one or more embodiments, the second adhesive may be cured such that the skin is connected to the structure.

In one or more embodiments, the structure may include a first feature configured to contain the second adhesive. The first feature may include a recess.

In one or more embodiments, the skin may include a first protrusion within at least a portion of the recess.

In one or more embodiments, the skin/window may include a second feature configured to contain at least a portion of the first adhesive.

In one or more embodiments, the structure/complementary portion may include a second protrusion extending into at least a portion of the second feature.

In one or more embodiments, the second protrusion may extend within one or more apertures of the window.

In one or more embodiments, the window may include an aperture and the second protrusion extends within the aperture.

In one or more embodiments, the second feature may include at least one or more openings or one or more walls.

In one or more embodiments, one wall of the one or more walls may be configured to allow radiation to pass therethrough.

In one or more embodiments, one wall of the one or more walls may include an aperture.

In one or more embodiments, the second protrusion may extend through the aperture.

In one or more embodiments, the second feature may be offset from a surface of the skin by an extension element. The extension element may include a plurality of elongated structures.

It will be understood that other aspects of mechanisms for realizing assembly of at least a portion of a vehicle such as a car or an aircraft and other multi-part structures using a set of robots, including joining of components such as additively manufactured structures by the set of robots without fixtures, will become readily apparent to those skilled in the art from the following detailed description, wherein it is shown and described in several embodiments by way of illustration. As will be realized by those skilled in the art, the disclosed subject matter is capable of other and different embodiments and its several details are capable of modification in various other respects, all without departing from the present disclosure. Accordingly, the drawings and detailed description are to be regarded as illustrative in nature and not as restrictive.

### BRIEF DESCRIPTION OF THE DRAWINGS

FIG. 1 illustrates an example of a fixture, as is known in the art of automotive manufacturing.

FIG. 2 illustrates an example embodiment of certain aspects of a Direct Metal Deposition (DMD) 3-D printer.

FIG. 3 illustrates a conceptual flow diagram of a 3-D printing process using a 3-D printer.

FIGS. 4A-4D illustrate example powder bed fusion (PBF) systems during different stages of operation.

FIG. 5 illustrates a perspective view of an example assembly system, which includes a plurality of robots configured to assemble components for at least a portion of a vehicle such as a car or an aircraft.

FIGS. 6A-6G illustrate perspective views of an example assembly system, which includes a plurality of robots configured to perform various example operations for component assembly of at least a portion of a vehicle such as a car or an aircraft.

FIG. 7 is a flowchart illustrating an example method of controlling at least one robot for various example operations associated with joining structures in a fixtureless assembly system.

FIG. 8 is a flowchart illustrating an example method of connecting a skin to a structure by controlling a robotic system.

FIG. 9 is a block diagram of an example controller processing system configured to execute one or more sets of instructions to direct at least one robot for various operations associated with assembly of at least a portion of a vehicle such as a car or an aircraft.

FIG. 10 illustrates an example of an assembled structure being a frame of a vehicle such as a car or an aircraft assembled by the example assembly systems and operations of FIGS. 2-9.

FIG. 11A illustrates an example in exploded and assembled views of an embodiment of a skin and a structure.

FIG. 11B illustrates an example in exploded and assembled views of an embodiment of a skin and a structure.

FIG. 12 illustrates an example of an apparatus, which may be formed by the example assembly systems and operations of FIGS. 2-9.

FIG. 13 illustrates an example of an apparatus including a radiation source configured to provide radiation to cure an adhesive. The apparatus may be formed by the example assembly systems and operations of FIGS. 2-9.

FIG. 14 illustrates an example of a structure including adhesives. An apparatus may include the structure, and the structure and the apparatus may be formed by the example assembly systems and operations of FIGS. 2-9.

FIG. 15 illustrates an example of a skin having windows. An apparatus may include the skin, and the skin and the apparatus may be formed by the example assembly systems and operations of FIGS. 2-9.

FIG. 16 illustrates an example of a structure including adhesives and features on an inner surface of the structure. An apparatus may include the structure, and the structure and the apparatus may be formed by the example assembly systems and operations of FIGS. 2-9.

FIG. 17 illustrates an example of a skin having windows. An apparatus may include the skin, and the skin and the apparatus may be formed by the example assembly systems and operations of FIGS. 2-9.

FIG. 18 illustrates an example of an structure including adhesives, and features on an outer surface of the structure. An apparatus may include the structure, and the structure and the apparatus may be formed by the example assembly systems and operations of FIGS. 2-9.

FIG. 19 illustrates an example of an structure connected to a skin including windows corresponding to features positioned on an outer surface of the structure. An apparatus may include the structure, and the structure and the apparatus may be formed by the example assembly systems and operations of FIGS. 2-9.

FIG. 20 illustrates an example of an assembled and joined view of an apparatus including a skin and a structure. The apparatus may be formed by the example assembly systems and operations of FIGS. 2-9.

FIG. 21 illustrates an example of a structure protrusions and a groove. An apparatus may include the structure, and the structure and the apparatus may be formed by the example assembly systems and operations of FIGS. 2-9.

FIG. 22 illustrates an example of a skin including apertures and a tongue. An apparatus may include the skin, and the skin and the apparatus may be formed by the example assembly systems and operations of FIGS. 2-9.

FIG. 23 illustrates an example of a skin including features configured to contain an adhesive. An apparatus may include the skin, and the skin and the apparatus may be formed by the example assembly systems and operations of FIGS. 2-9.

FIG. 24 illustrates an example front view of an assembled and joined view of an apparatus including a skin and a structure. The apparatus may be formed by the example assembly systems and operations of FIGS. 2-9.

FIG. 25 an example of a structure including a plurality of features configured to contain an adhesive and a plurality of protrusions An apparatus may include the structure, and the structure and the apparatus may be formed by the example assembly systems and operations of FIGS. 2-9.

FIG. 26 illustrates an example of a skin having a plurality of protrusions and a groove. An apparatus may include the skin, and the skin and the apparatus may be formed by the example assembly systems and operations of FIGS. 2-9.

FIG. 27 illustrates an example of a structure including a tongue and plurality of apertures. An apparatus may include the structure, and the structure and the apparatus may be formed by the example assembly systems and operations of FIGS. 2-9.

FIG. 28 illustrates an example of a structure including a plurality of features including a wall and openings. The structure may be formed by the example assembly systems and operations of FIGS. 2-9.

FIG. 29 illustrates an example front view of an assembled and joined view of an apparatus including a skin and a structure. The apparatus may be formed by the example assembly systems and operations of FIGS. 2-9.

FIG. 30 illustrates an example of a spacing/gap between features of components that are configured to be joined together such that the components do not contact one another at the joined surfaces of the components. The example components and features may be formed by the example assembly systems and operations of FIGS. 2-9.

### DETAILED DESCRIPTION

The disclosure provides precise, reproducible, timely efficient and economical techniques for joining components such as a skin and a structure. For example, an apparatus may be formed by a first robot moving a skin and/or a second robot moving a structure such that the skin and structure are within a joining proximity of one another. One of the robots applies radiation to a radiation cured/curable adhesive, which is located between the skin and structure in order to fix the skin to the structure and one of the robots is configured to form a structural connected between the skin and structure. This process may be repeated to join more structures and/or skins to the prior joined skin and/or structure. Because robots may perform the above operations in precise, reproducible and timely efficient manners as well as there being no requirement for the use of capital intensive fixtures in forming the apparatus, this disclosure has provided a solution to assembling and joining a plurality of parts in an overall efficient manufacturing process. More details of the apparatus and the method of forming the apparatus will be provided in the detailed description section of this disclosure.

In contrast, the automobile industry's unquestioning reliance on fixtures has created significant disadvantages that continue to be simply accepted year after year. Fixtures are specifically designed to match a single part, therefore, robotically assembling a complex structure like an automobile chassis can require thousands of fixtures. In addition, changing the chassis design can require creating an entirely new set of fixtures. Because fixtures can be quite complex and expensive to build, any new design or change in the current design can be incredibly expensive.

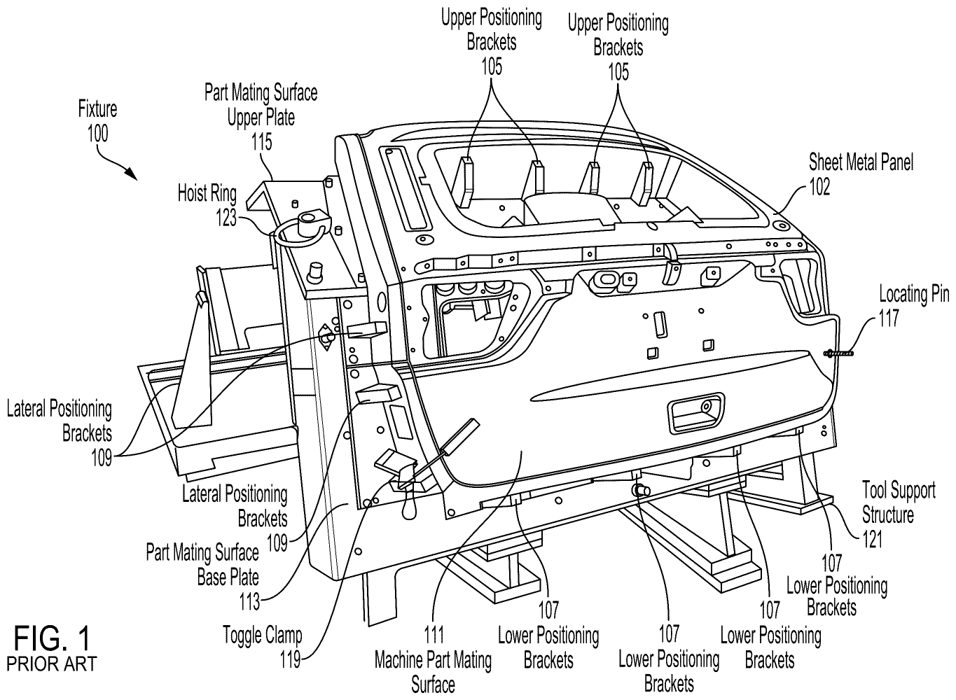

In this regard, FIG. 1 illustrates an example of a fixture that are conventionally used in manufacturing including automotive manufacturing. A fixture is designed to retain and/or position a structure or portion of the structure, for example, a part of a vehicle chassis, during pre-assembly, assembly, and/or post-assembly operations, such as on an assembly line. In so doing, the fixture can provide a mechanism by which the structure can be engaged and retained by a robotic arm. In addition, the fixture may provide rigidity to prevent the fixture from moving and/or deflecting during a joining operation. Further, the fixture may serve as a reference point for a joining operation to be performed; that is, the joining operation may be performed on the structure based on the assumption that the structure is retained at a certain position by the fixture. Thus, a fixture does one of the following: retains a part for joining, positions a part to allow joining, aides in the joining of parts, fixes a part for joining (e.g., if the part would flex when being held by the robot or otherwise lacks the rigidity necessary for various joining operations), and the like.

The present disclosure describes various techniques and approaches to assemble at least a portion of a vehicle such as a car or an aircraft without the use of fixtures. For example, the present disclosure describes one or more robots that are configured to directly engage with a structure, e.g., using an end effector of a robotic arm. By omitting fixtures, the present disclosure may provide various techniques and approaches for assembly of components for vehicles such as a car or an aircraft that are more economical in terms of cost, space, complexity, and/or accuracy than current methods of assembling components for vehicles.

FIG. 1 illustrates conventional fixture 100 designed to retain a particular sheet metal panel 102 (e.g., a door panel, a floor panel, and the like) of a vehicle during various assembly operations. In this example, fixture 100 provides strength and rigidity for sheet metal panel 102 to prevent unintended movement and/or deflection during a joining operation. Fixture 100 includes multiple upper positioning brackets 105 that retain an upper portion of sheet metal panel 102, multiple lower positioning brackets 107 that retain a lower portion of the sheet metal panel, and multiple lateral positioning brackets 109 that retain the side portions of the sheet metal panel. Fixture 100 also includes machine part mating surface 111, part mating surface base plate 113, and part mating surface upper plate 115 that provide rigidity to sheet metal panel 102. Fixture 100 also includes locating pin 117 to guide sheet metal panel 102, and toggle clamp 119 to lock the sheet metal panel into position on the fixture. Fixture 100 also includes tool support structure 121 to support all of the other components of the fixture. Because fixture 100 is a large, heavy structure, the fixture also includes hoist ring 123 to allow the fixture to be moved and positioned.

Fixture 100 is designed to be engage in a particular way and retained by a robotic arm because panel 102 cannot be directly engaged and retained by the robotic arm. The joining operation performed on panel 102 requires fixture 100 to provide a reference point or frame of reference so that the position of panel 102 can be assumed and/or estimated. Such assumptions and/or estimations are prone to errors, such as when panel 102 moves in an unintended manner and/or unintentionally deflects. These errors can accumulate over the assembly process. Thus, relatively large design tolerances may be needed, particularly when multiple other parts must be joined with panel 102, because precision may be difficult to achieve.

Additive Manufacturing (3-D Printing). Additive manufacturing (AM) is advantageously a non-design specific manufacturing technique. AM provides the ability to create complex components/structures within a part. Component and structure are interchangeably used throughout this disclosure. For example, structures such as skins, nodes and other structures and these structures may be produced using AM. A node is a structure that may include one or more interfaces used to connect to other components such as for example, skins, tubes, extrusions, panels, other nodes, and the like. Using AM, a node may be constructed to include additional features and functions, depending on the objectives of the node. For example, a node may be printed with one or more ports that enable the node to secure two parts by injecting an adhesive rather than welding multiple parts together, as is traditionally done in manufacturing complex products. Alternatively, some components may be connected to a node using a brazing slurry, a thermoplastic, a thermoset, or another connection feature, any of which can be used interchangeably in place of an adhesive or in addition to an adhesive. Thus, while welding techniques may be suitable with respect to certain embodiments, additive manufacturing provides significant flexibility in enabling the use of alternative or additional connection techniques.

A variety of different AM techniques may be used to 3-D print components composed of various types of materials. For example, Directed Energy Deposition (DED) AM systems, which uses a directed energy source configured to provide laser or electron beams to melt a material such as metal. These systems utilize both powder and wire feeds. The wire feed systems advantageously have higher deposition rates than other prominent AM techniques. Single Pass Jetting (SPJ) combines two powder spreaders and a single print unit to spread metal powder and to print a structure in a single pass with little or no wasted motion. As another illustration, electron beam additive manufacturing processes use an electron beam to fuse metal via wire feedstock or sintering on a powder bed in a vacuum chamber. Atomic Diffusion Additive Manufacturing (ADAM) is still another technology, which components are printed, layer-by-layer, using a metal powder in a plastic binder. After printing, plastic binders are removed and the entire part (e.g., structure) is sintered at once into a desired metal structure.

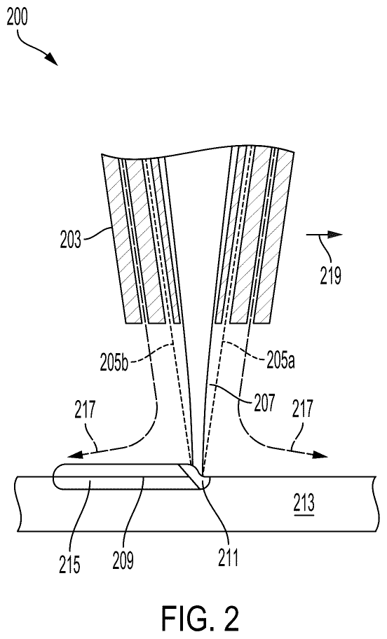

One of several such AM techniques, as noted, is Direct Metal Deposition (DMD). FIG. 2 illustrates an example embodiment of certain aspects of a DMD 3-D printer 200. DMD printer 200 uses feed nozzle 203 moving in direction 219 to propel powder streams 205a and 205b into laser beam 207, which is directed toward workpiece 213 that may be supported by a substrate. Feed nozzle 203 may also include mechanisms for streaming shield gas 217 to protect the welded area from oxygen, water vapor, or other components.

The powdered metal is then fused by laser beam 207 in melt pool region 211, which may then bond to workpiece 213 as a region of deposited material 209. Dilution area 215 may include a region of workpiece 213 where the deposited powder is integrated with the local material of workpiece 213. Feed nozzle 203 may be supported by a computer numerical controlled (CNC) robot or a gantry, or other computer-controlled mechanism. Feed nozzle 203 may be moved under computer control multiple times along a predetermined direction of the substrate until an initial layer of deposited material 209 is formed over a desired area of workpiece 213. Feed nozzle 203 can then scan the region immediately above the prior layer to deposit successive layers until the desired structure is formed. In general, feed nozzle 203 may be configured to move with respect to all three axes (e.g., (x,y,z)), and in some instances to rotate on its own axis by a predetermined amount.

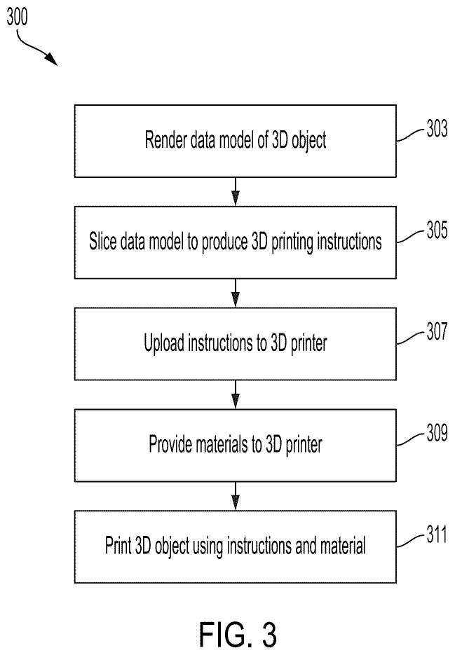

FIG. 3 provides flow diagram 300 illustrating an example process of 3-D printing. A model such as a data model of the desired 3-D object to be printed is rendered (303). A data model is a virtual design of the 3-D object. Thus, the data model may reflect the geometrical and structural features of the 3-D object, as well as its material composition. The data model may be created using a variety of methods, including computer-aided engineering (CAE)-based optimization, 3-D modeling, camera imaging and photogrammetry software. CAE-based optimization may include, for example, cloud-based optimization, fatigue analysis, linear or non-linear finite element analysis (FEA), and durability analysis.

3-D modeling software, in turn, may include one of numerous commercially available 3-D modeling software applications. Data models may be rendered using a suitable computer-aided design (CAD) package, for example in an STL format. STL is one example of a file format associated with commercially available stereolithography-based CAD software. A CAD program may be used to create the data model of the 3-D object as an STL file. Thereupon, the STL file may undergo a process whereby errors in the file are identified and resolved.

Following error resolution, the data model can be ‘sliced’ (305) by a software application known as a slicer to thereby produce a set of instructions for 3-D printing the object, with the instructions being compatible and associated with the particular 3-D printing technology to be utilized. Numerous slicer programs are commercially available. Generally, the slicer program converts the data model into a series of individual layers representing thin slices (e.g., 100 microns thick) of the object to be printed, along with a file containing the printer-specific instructions for 3-D printing these successive individual layers to produce an actual 3-D printed representation of the data model.

The layers associated with 3-D printers and related print instructions need not be planar or identical in thickness. For example, in some embodiments depending on factors like the technical sophistication of the 3-D printing equipment and the specific manufacturing objectives, etc., the layers in a 3-D printed structure may be non-planar and/or may vary in one or more instances with respect to their individual thicknesses.

A common type of file used for slicing data models into layers is a G-code file, which is a numerical control programming language that includes instructions for 3-D printing the object. The G-code file, or other file constituting the instructions, is uploaded (307) to the 3-D printer. Because the file containing these instructions is typically configured to be operable with a specific 3-D printing process, it will be appreciated that many formats of the instruction file are possible depending on the 3-D printing technology used.

In addition to the printing instructions that dictate what and how an object is to be printed, the appropriate physical materials necessary for use by the 3-D printer in printing the object are provided (309) to the 3-D printer using any of several conventional and often printer-specific methods. In DMD techniques, for example, one or more metal powders may be provided for layering structures with such metals or metal alloys. In selective laser melting (SLM), selective laser sintering (SLS), and other powder bed fusion (PBF)-based AM methods (see below), the materials may be provided as powders into chambers that feed the powders to a build platform. Depending on the 3-D printer, other techniques for providing printing materials may be used.

The respective data slices of the 3-D object are then printed (311) based on the provided instructions using the material(s). In 3-D printers that use laser sintering, a laser scans a powder bed and melts the powder together where a structure is desired, and avoids scanning areas where the sliced data indicates that nothing is to be printed. This process may be repeated thousands of times until the desired structure is formed, after which the printed part (e.g., component such as a skin or a structure) is removed from the printer. In fused deposition modelling, as described above, parts are printed by applying successive layers of model and support materials to a substrate. In general, any suitable 3-D printing technology may be employed for purposes of the present disclosure.

Another AM technique is powder-bed fusion (PBF). Like DMD, PBF creates ‘build pieces’ layer-by-layer. Each layer or ‘slice’ is formed by depositing a layer of powder and exposing portions of the powder to an energy beam. The energy beam is applied to melt areas of the powder layer that coincide with the cross-section of the build piece in the layer. The melted powder cools and fuses to form a slice of the build piece. The process may be repeated to form the next slice of the build piece, and so on. Each layer is deposited on top of the previous layer. The resulting structure is a build piece assembled slice-by-slice from the ground up.

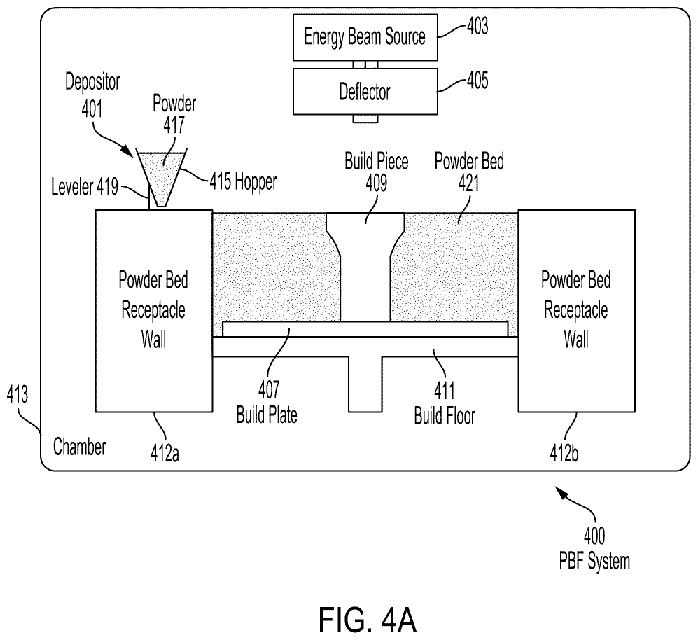

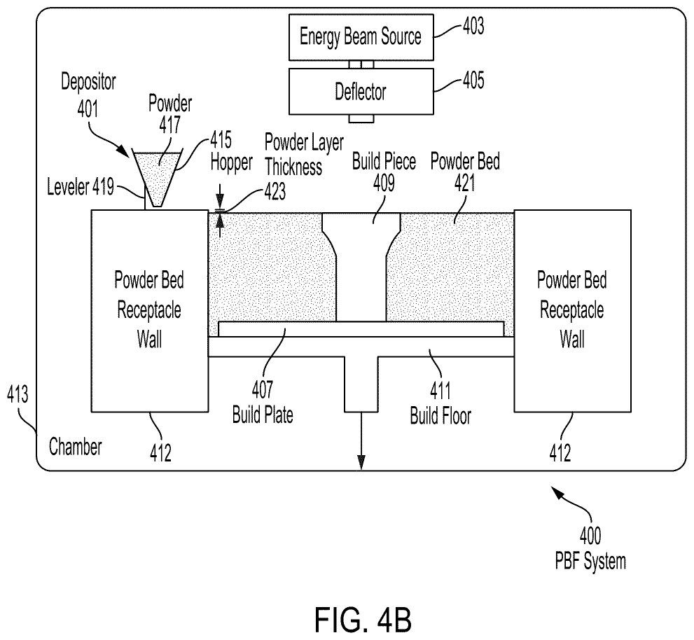

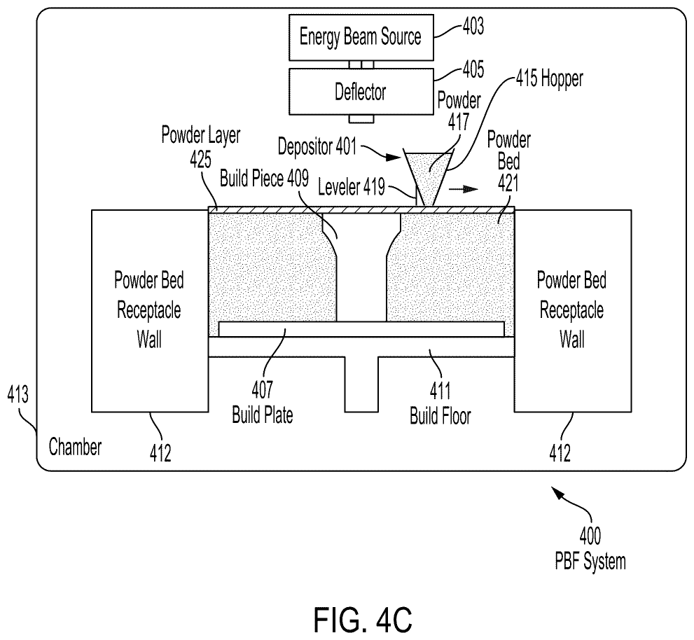

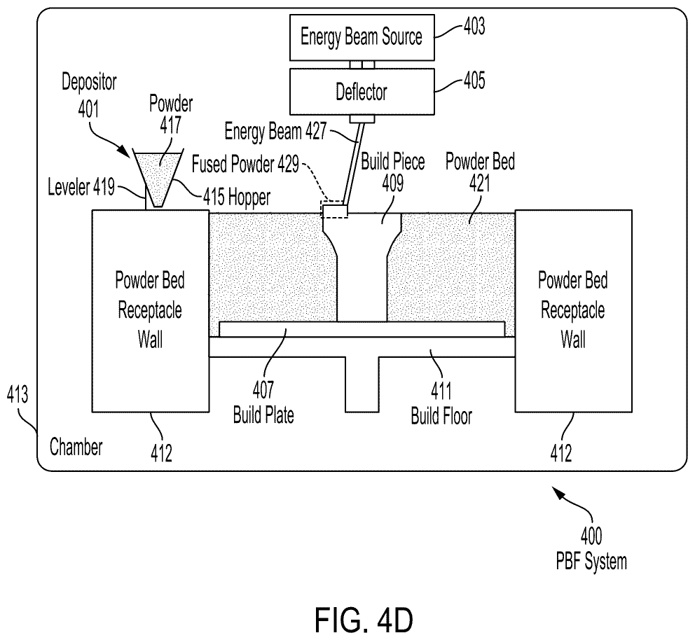

FIGS. 4A through 4D illustrate respective side views of an example PBF system 400 during different stages of operation. As noted above, the particular embodiment illustrated in FIGS. 4A through 4D is one of many suitable examples of a PBF system acceptable for use in the present disclosure. It should also be noted that elements of FIGS. 4A through 4D and the other figures in the present disclosure are not necessarily drawn to scale, but may be drawn larger or smaller for the purpose of better illustration of concepts described herein. PBF system 400 can include depositor 401 that can deposit each layer of powder such as metal powder, energy beam source 403 that can generate an energy beam, deflector 405 that can apply the energy beam to fuse the powder, and build plate 407 that can support one or more build pieces, such as build piece 409. PBF system 400 can also include build floor 411 positioned within a powder bed receptacle. Powder bed receptacle walls 412a,412b of the powder bed receptacle generally define the boundaries of the powder bed receptacle, which is sandwiched between walls 412a,412b from the side and abuts a portion of build floor 411 below. Build floor 411 can progressively lower build plate 407 so that depositor 401 can deposit a next layer. The entire mechanism may reside in chamber 413 that can enclose the other components of the PBF system, thereby protecting the equipment, enabling atmospheric and temperature regulation and mitigating contamination risks. Depositor 401 can include hopper 415 that contains powder 417, such as a metal powder, and leveler 419 that can level the top of each layer of deposited powder.

Referring specifically to FIG. 4A, this figure shows PBF system 400 after a slice of build piece 409 has been fused, but before the next layer of powder has been deposited. In fact, FIG. 4A illustrates a time at which PBF system 400 has already deposited and fused slices in multiple layers, e.g., 150 layers, to form the current state of build piece 409, e.g., formed of 150 slices. The multiple layers already deposited have created powder bed 421, which includes powder that was deposited but not fused.

FIG. 4B shows PBF system 400 at a stage in which build floor 411 can lower by powder layer thickness 423. The lowering of build floor 411 causes build piece 409 and powder bed 421 to drop by powder layer thickness 423, so that the top of build piece 409 and powder bed 421 are lower than the top of the powder bed receptacle walls 412 by an amount equal to the powder layer thickness. In this way, for example, a space with a consistent thickness equal to powder layer thickness 423 can be created over the top of build piece 409 and powder bed 421.

FIG. 4C shows PBF system 400 at a stage in which depositor 401 is positioned to deposit powder 417 in a space created over the top surfaces of build piece 409 and powder bed 421 and bounded by powder bed receptacle walls 412. In this example, depositor 401 progressively moves over the defined space while releasing powder 417 from hopper 415. Leveler 419 can level the released powder to form powder layer 425 that has a thickness substantially equal to powder layer thickness 423 (see FIG. 4B). Thus, the powder in a PBF system can be supported by a powder support structure, which can include, for example, build plate 407, build floor 411, build piece 409, walls 412, etc. It should be noted that the illustrated thickness of powder layer 425 (i.e., powder layer thickness 423 (FIG. 4B)) is greater than an actual thickness used for the example involving 150 previously deposited layers discussed above with reference to FIG. 4A.

FIG. 4D shows PBF system 400 at a stage in which, following the deposition of powder layer 425 (FIG. 4C), energy beam source 403 generates energy beam 427, and deflector 405 applies the energy beam to fuse the next slice in build piece 409. In various example embodiments, energy beam source 403 can be an electron beam source, in which case energy beam 427 constitutes an electron beam. Deflector 405 can include deflection plates that can generate an electric field or a magnetic field that selectively deflects the electron beam to cause the electron beam to scan across areas designated to be fused. In various embodiments, energy beam source 403 can be a laser, in which case energy beam 427 is a laser beam. Deflector 405 can include an optical system that uses reflection and/or refraction to manipulate the laser beam to scan selected areas to be fused.

In various embodiments, deflector 405 can include one or more gimbals and actuators that can rotate and/or translate the energy beam source to position the energy beam. In various embodiments, energy beam source 403 and/or deflector 405 can modulate the energy beam, e.g., turn the energy beam on and off as the deflector scans so that the energy beam is applied only in the appropriate areas of the powder layer. For example, in various embodiments, the energy beam can be modulated by a digital signal processor (DSP).

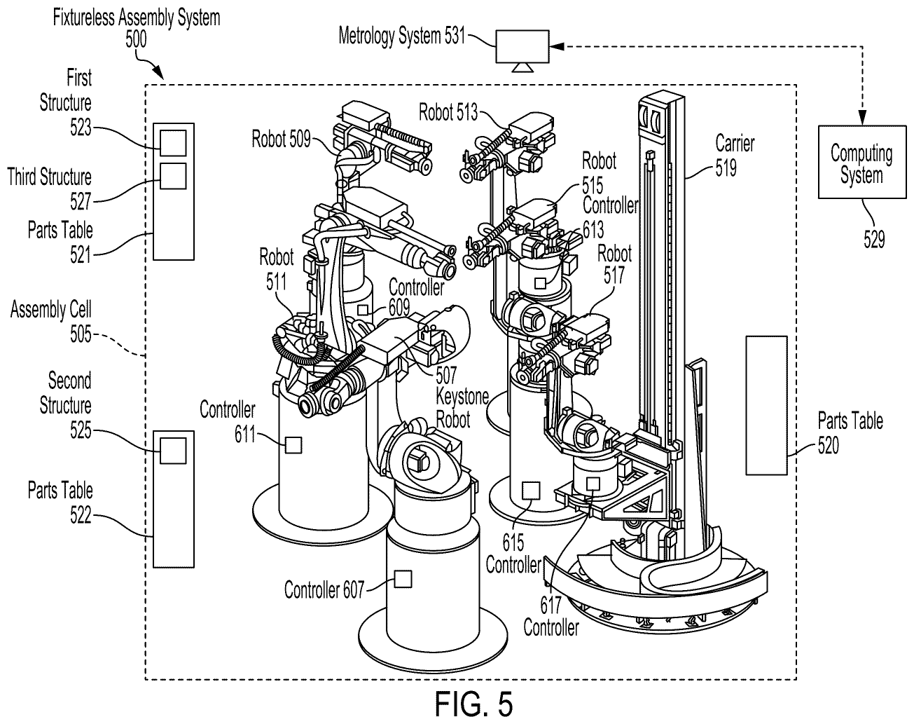

Turning now to FIGS. 5 through 29, various embodiments are provided for controlling robots to assemble at least two components/structures, for example, without the use of fixtures. For example, the at least two structures may be a skin and a structure or a plurality of skins or a skin and a plurality of structures or a plurality of skins and a structure or a plurality of structures. The at least two assembled components/structures may be at least a portion of a vehicle, such as an aircraft. For example, the structures may be at least a portion of a frame, a chassis, a base piece, a skin, a body, a hood, a roof, a trunk, one or more panels, etc. of a vehicle. In another example, the structures may be at least a portion of a fuselage, a skin, a wing, a winglet, a tail, etc. of an aircraft. At least one of the at least two structures may be additively manufactured, e.g., as described with respect to FIGS. 2, 3, and 4A through 4D, above. In some embodiments, at least one of the at least two structures may be a piece, part, node, component, and/or other structure, which may include two structures that previously have been joined.

According to various embodiments, such structures to be joined in association with assembly of a vehicle, such as an aircraft, and may be additively manufactured with one or more features that may facilitate or enable various assembly operations (e.g., joining) without the use of fixtures, such as one or more features to prevent or reduce unintended movement of a structure and/or deflection of the structure during one or more fixtureless assembly operations. For example, one or more structures to be joined in association with fixtureless assembly of a vehicle such as a car or an aircraft may be additively manufactured with one or more features such as attachment features designed to provide stability, strength, and/or rigidity during various fixtureless assembly operations. Examples of such features may include mesh, honeycomb, and/or lattice substructures, which may be co-printed with the structure (e.g., when the structure is additively manufactured) and which may be internal and/or external to the structure. An example of an attachment feature may be a recess or notch in a surface of the structure such as a node or a skin. The attachment feature facilitates or enables engagement and retention (e.g., gripping) of the structure by an end effector of a robot. The attachment feature may be co-printed with the structure.

According to various embodiments described herein, an assembly system may include a robotic system. The robotic system includes one or more robots, at least one robot may be positioned to join one structure with another structure without the use of fixtures. Various assembly operations may be performed, potentially repeatedly, so that multiple structures may be joined for fixtureless assembly of at least a portion of a vehicle (e.g., vehicle chassis, body, one or more panels, frame, base piece, skin, hood, roof, trunk, and the like) including aircraft (e.g., aircraft fuselage, skin, wing, winglet, tail and the like).

A first robot may be configured to engage with and retain a first structure to which one or more other structures may be joined during various operations performed in association with fixtureless assembly of at least a portion of a vehicle such as a car or an aircraft. For example, the first robot may engage an attachment feature of the first structure. The structure may be a section of a vehicle chassis, body, one or more panels, frame, base piece, skin, hood, roof or trunk including an aircraft fuselage, skin, wing, winglet or tail. The one or more other structures may be other sections of the vehicle chassis, body, one or more panels, frame, base piece, hood, roof or trunk including aircraft fuselage, skin, wing, winglet or tail.

Illustratively, the first robot may engage and retain a first structure that is to be joined with a second structure, and the second structure may be engaged and retained by a second robot. For example, the first robot may engage a first attachment feature of the first structure and the second robot may engage a second attachment feature of the second structure. Various operations performed with the first structure (e.g., joining the first structure with one or more other structures, which may include two or more previously joined structures) may be performed at least partially within an assembly cell that includes a plurality of robots. Accordingly, at least one of the robots may be directed (e.g., controlled) during a fixtureless operation with the first structure in order to function in accordance with precision commensurate with the fixtureless operation.

The present disclosure provides various different embodiments of controlling and/or directing one or more robots of a robotic system, where the one or more robots are at least partially within an assembly system for assembly operations (including pre- and/or post-assembly operations). It will be appreciated that various embodiments described herein may be practiced together. For example, an embodiment described with respect to one illustration of the present disclosure may be implemented in another embodiment described with respect to another illustration of the present disclosure. Although embodiments disclosed herein include assembling a skin and a structure fixturelessly, it should be understood that assembly using fixtures can be performed without departing from the present disclosure. For example, the skin and/or the structure may be retained by a fixture during assembly.

With reference to FIG. 5, the figure illustrates a perspective view of a fixtureless assembly system. (e.g., fixtureless assembly system 500) Fixtureless assembly system 500 may be employed in various operations associated with fixtureless assembly of a vehicle, e.g. an aircraft, such as robotic system assembling of a node-based vehicle. Fixtureless assembly system 500 may include one or more elements associated with at least a portion of the assembly of a vehicle without any fixtures. For example, one or more elements of fixtureless assembly system 500 may be configured for one or more operations of a robotic system in which a first structure is joined with one or more other structures without the use of any fixtures during robotic assembly of a node-based vehicle.

An assembly cell (e.g., assembly cell 505) may be configured at the location of fixtureless assembly system 500. Assembly cell 505 may be a vertical assembly cell. Within assembly cell 505, fixtureless assembly system 500 may include a robotic system, which may include one or more robots 507, 509, 511, 513, 515, 517. Robot 507 may be referred to as a keystone robot. Fixtureless assembly system 500 may include parts tables 520, 521, and 522 that can hold parts and structures for the robots to access. For example, first structure 523, second structure 525, and third structure 527 may be positioned on one of parts tables 521, 522 to be picked up by the robots and assembled together. In various embodiments, each of the structures can weigh at least 10 g, 100 g, 500 g, 1 kg, 5 kg, 10 kg, or more. In various embodiments, each of the structures can have a volume of at least 10 ml, 100 ml, 500 ml, 1000 ml, 5000 ml, 10,000 ml, or more. In various embodiments, one or more of the structures can be an additively manufactured structure, such as a complex node or a skin.

Fixtureless assembly system 500 may also include computing system 529 to issue commands to the various controllers of the robots of assembly cell 505, as described in more detail below. In this example, computing system 529 is communicatively connected to the robots of the robotic system through a wireless communication. Fixtureless assembly system 500 may also include metrology system 531 that can accurately measure the positions of the robots and/or the arms of the robots and/or the structures held by the robots, as described in more detail below.

In contrast to conventional robotic assembly factories, structures can be assembled without fixtures in fixtureless assembly system 500. For example, structures need not be connected within any fixtures, such as the fixture described above in FIG. 1. Instead, at least one of the robotic systems' robot in assembly cell 505 may provide the functionality expected from fixtures, as described in this disclosure. For example, robots may be configured to directly contact (e.g., using an end effector of a robotic arm) structures to be assembled within assembly cell 505 so that those structures may be engaged and retained without any fixtures. For example, the one or more robots may engage an attachment feature of each structure. Further, at least one of the robots may provide the functionality expected from a fixture or a positioner and/or fixture table. For example, keystone robot 507 may replace a fixture or a positioner and/or fixture table in fixtureless assembly system 500.

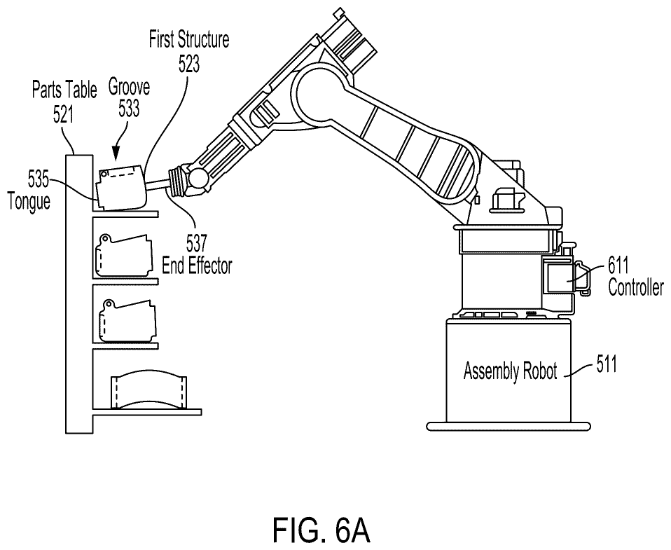

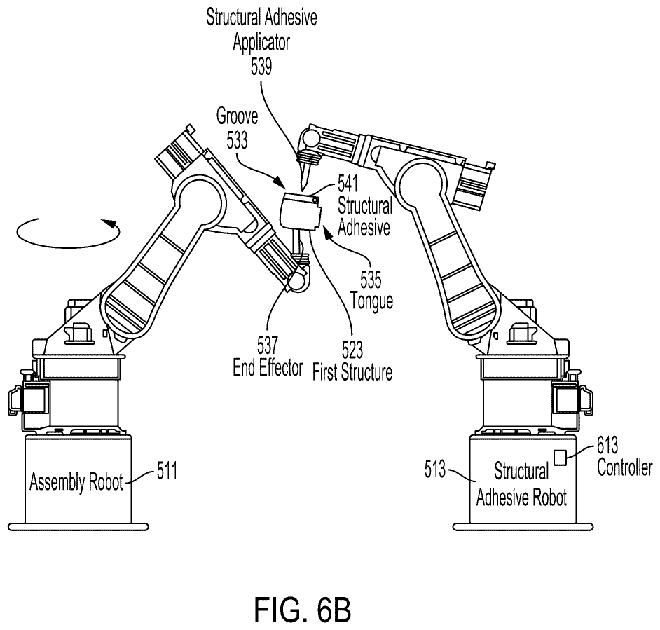

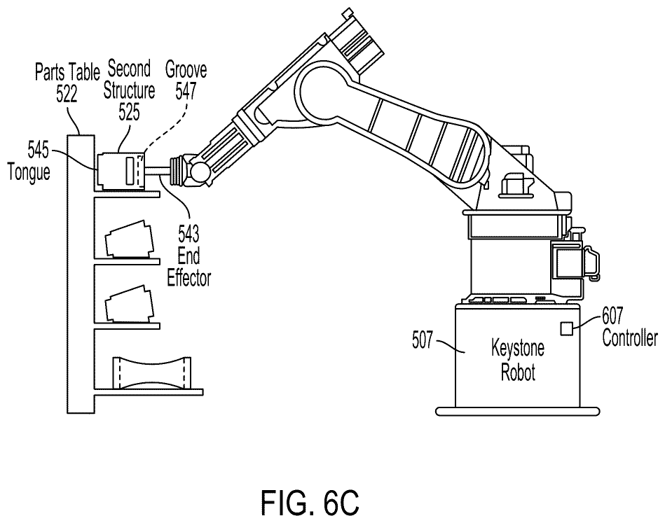

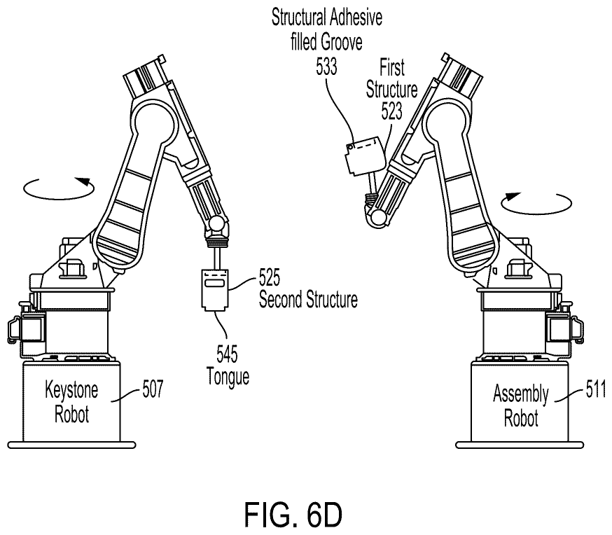

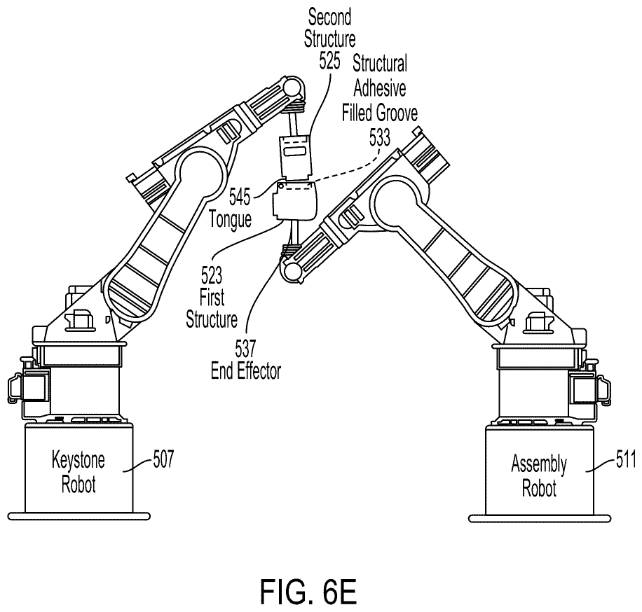

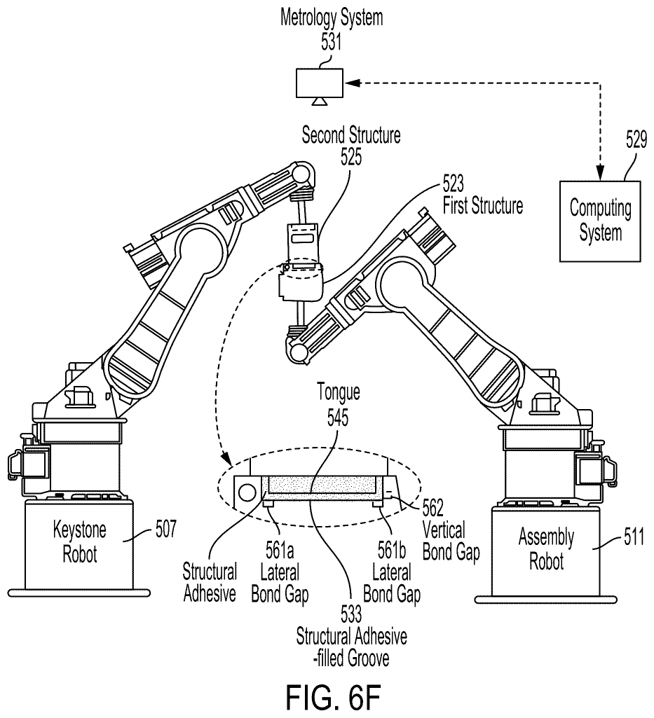

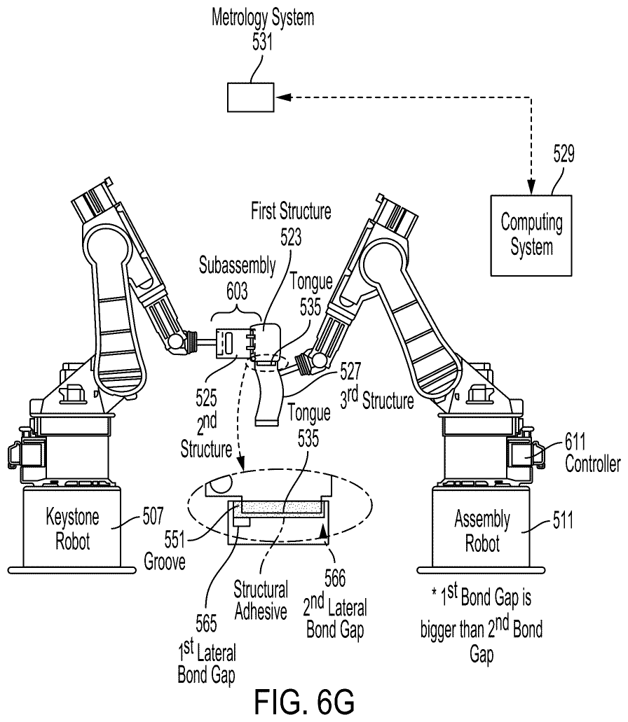

Keystone robot 507 may include a base and a robotic arm (see, e.g., FIGS. 6B and 6C, described below). The robotic arm may be configured for movement, which may be directed by computer-executable instructions loaded into a processor communicatively connected with keystone robot 507. Keystone robot 507 may contact a surface of assembly cell 505 (e.g., a floor of the assembly cell) through the base.

Keystone robot 507 may include and/or be connected with an end effector that is configured to engage and retain a structure, e.g., a portion of a vehicle such as a car or an aircraft. An end effector may be a component configured to interface with at least one structure. Examples of the end effectors may include jaws, grippers, pins, or other similar components capable of facilitating fixtureless engagement and retention of a structure by a robot. In some embodiments, the structure may be a section of a vehicle such as a car or an aircraft. For example, the structure may comprise a fuselage or a portion of a fuselage or a skin of a fuselage.

In some embodiments, keystone robot 507 may retain the connection with a structure through an end effector (e.g., second structure 525 and end effector 543 illustrated in FIG. 6C and described in more detail below) while a set of other structures is connected (either directly or indirectly) to the structure. Keystone robot 507 may be configured to engage and retain the structure without any fixtures—e.g., the fixture described above (e.g., in FIG. 1) present in fixtureless assembly system 500. In some embodiments, structures to be retained by at least one of the robots (e.g., the first structure) may be additively manufactured or co-printed with one or more features such as attachment features that facilitate engagement and retention of those structures by at least one of the robots without the use of any fixtures.

For example, a structure may be co-printed or additively manufactured with one or more features that increase the strength of the structure, such as a mesh, honeycomb, and/or lattice arrangement. Such features may stiffen the structure to prevent unintended movement of the structure during the assembly process. In another example, a structure may be co-printed or additively manufactured with one or more attachment features that facilitates engagement and retention of the structure by an end effector, such as protrusion(s) and/or recess(es) suitable to be engaged (e.g., gripped) by an end effector. The aforementioned features and attachment features of a structure may be co-printed with the structure, such that they are integral with the structure, and therefore may be of the same material(s) as the structure.

In retaining the structure, keystone robot 507 may position (e.g., move) the structure; that is, the position of the structure may be controlled by keystone robot 507 when retained by the keystone robot. Keystone robot 507 may retain the structure by “holding” or “grasping” the structure, e.g., using an end effector of a robotic arm of the keystone robot. For example, keystone robot 507 may retain the structure by causing gripper fingers, jaws, and the like to contact one or more surfaces of the structure and apply sufficient pressure thereto such that the keystone robot controls the position of the structure. That is, the structure may be prevented from moving freely in space when retained by keystone robot 507, and movement of the structure may be constrained by the keystone robot. As described above, the structure may include one or more features such as attachment features that facilitates the fixtureless engagement and retention of the structure by keystone robot 507.

As other structures (including subassemblies, substructures of structures, a skin, etc.) are connected to the structure, keystone robot 507 may retain the engagement with the structure through the end effector. The aggregate of the structure and one or more structures connected thereto may be referred to as a structure itself, but may also be referred to as an assembly or a subassembly. Keystone robot 507 may retain an engagement with an assembly once the keystone robot has engaged the structure.

In some embodiments, robots 509 and 511 of assembly cell 505 may be similar to keystone robot 507 and, thus, may include respective end effectors configured to engage with structures that may be connected with the structure retained by the keystone robot. In some embodiments, robots 509, 511 may be referred to as assembly robots and/or materials handling robots.

In some embodiments, robot 513 of assembly cell 505 may be used to affect a structural connection between structures. In the illustrative example of FIGS. 6A through 6G, robot 513 may be referred to as a structural adhesive robot. Structural adhesive robot 513 may be similar to the keystone robot 507, except the structural adhesive robot may include a tool at the distal end of the robotic arm that is configured to apply structural adhesive to at least one surface of structures fixturelessly retained by the keystone robot and structures fixturelessly retained by assembly robots 509, 511 before or after the structures are positioned at joining proximities with respect to other structures for joining with the other structures. The joining proximity can be a position that allows a first structure to be joined to a second structure. For example, a joining proximity may be a first surface of a first structure having a distance ranging from about 0.05 mm to about 150 mm from a second surface of a second structure. The first surface of the first structure may be a surface that will be connected to the second structure. The second surface of the second structure may be a surface that will be connected to the first structure. In various embodiments, the first and second structures may be joined though the application of an adhesive while the structures are within the joining proximity and subsequent curing of the adhesive. However, structural adhesives might take a relatively long time to cure. If this is the case, the robots retaining the first and second structures, for example, might have to hold the structures at the joining proximity for a long time in order for the structures to be joined by the structural adhesive once it finally cures. This would prevent the robots from being used for other tasks, such as continuing to pick up and assemble structures, for a long time while the structural adhesive cures. In order to allow more efficient use of the robots, for example, in various embodiments a quick-cure adhesive may be additionally applied to join the structures quickly and retain the structures so that the structural adhesive can cure without requiring both robots to hold the structures. In this regard, robotic system of fixtureless assembly system 500 includes robot 515, which may be used to apply a quick-cure adhesive and to cure the adhesive quickly. The quick-cure adhesive may be cured via radiation. The quick-cure adhesive may be an adhesive cured by ultraviolet (UV) radiation (i.e., a quick-cure UV adhesive). In this example embodiment, a quick-cure UV adhesive may be used, and robot 515 may be referred to as a UV robot. UV robot 515 may be similar to keystone robot 507, except the UV robot may include a tool at the distal end of the robotic arm that is configured to apply a quick-cure UV adhesive and to cure the adhesive, e.g., when a first structure is positioned within the joining proximity with respect to a second structure. That is, UV robot 515 may cure an adhesive after the adhesive is applied to the first structure and/or the second structure or to a feature of the first and/or second structure when the structures are within the joining proximity obtained through direction of at least one of the robotic arms of keystone robot 507 and/or assembly robots 509, 511.

In contrast to various other assembly systems that may include a fixture or a positioner and/or fixture table, described above, the use of a curable adhesive (e.g., quick-cure adhesive) may provide a partial adhesive bond that provides a way to retain the first and second structures during the joining process without the use of fixtures. The partial adhesive bond may provide one way to replace various fixtures that would otherwise be employed for engagement and retention of structures in an assembly system that, for example, uses a fixture or a positioner and/or fixture table. Another potential benefit of fixtureless assembly, particularly using a curable adhesive, is improved access to various structures of a structural assembly in comparison with the use of fixtures and/or other part-retention tools, which inherently occlude access to sections of the structures to which they are attached.

Moreover, at least partially replacing fixtures and/or other part-retention tools with curable adhesives may provide a more reliable connection at one or more locations on a structural assembly in need of support-particularly where such locations in need of support are rendered nearly or entirely inaccessible by the fixtures and/or other part-retention tools. In addition, at least partially replacing fixtures and/or other part-retention tools with curable adhesives may provide the ability to add more structures to a structural assembly before application of a (permanent) structural adhesive-particularly where fixtures and/or other part-retention tools would hinder access for joining additional structures.

In various embodiments, a robot may be used for multiple different roles. For example, robot 517 may perform the role of an assembly robot, such as assembly robots 509, 511, and the role of a UV robot, such as UV robot 515. In this regard, robot 517 may be referred to as an assembly/UV robot. Assembly/UV robot 517 may offer functionality similar to each of the assembly robots when the distal end of the robotic arm of the assembly/UV robot includes an end effector (e.g., connected via a tool flange). However, assembly/UV robot 517 may offer functionality similar to UV robot 515 when the distal end of the robotic arm of the assembly/UV robot includes a tool configured to applied UV adhesive and to emit radiation such as UV light to cure the UV adhesive.

The quick-cure adhesive applied by UV robot 515 and assembly/UV robot 517 may provide a partial adhesive bond in that the adhesive may retain the relative positions of a first structure and a second structure within the joining proximity until the structural adhesive may be applied and/or cured to form a structural connection, which permanently joining the first structure and the second structure, after which the adhesive providing the partial adhesive bond may be removed (e.g., as with temporary adhesives) or may not be removed (e.g., as with complementary adhesives).

In fixtureless assembly system 500, at least one surface of the first structure and/or second structure to which adhesive is to be applied may be determined based on gravity and/or other forces that cause loads to be applied on various structures and/or connections of the assembly. Finite element method (FEM) analyses may be used to determine at least one surface of the first structure and/or the second structure, as well as one or more discrete areas on the at least one surface, to which the adhesive is to be applied. For example, FEM analyses may indicate one or more connections of a structural assembly that may be unlikely/unable or possible or optimally possible to support sections of the structural assembly disposed about the one or more connections.

In assembling at least a portion of a vehicle such as a car or an aircraft in assembly cell 505, the second structure may be joined directly to the first structure by directing the various fixtureless robots 507, 509, 511, 513, 515, 517 as described herein. Additional structures may be indirectly joined to the first structure. For example, the first structure may be directly joined to the second structure through movement(s) of keystone robot 507, structural adhesive robot 513, at least one assembly robot 509, 511, and/or UV robot 515. Thereafter, the first structure, joined with the second structure, may be indirectly joined to an additional structure as the additional structure is directly joined to the second structure. Thus, the first structure, which may continue to be retained by keystone robot 507, may evolve throughout an assembly process as additional structures are directly or indirectly joined to it.

In some embodiments, assembly robots 509, 511 may fixturelessly join (i.e., join in a fixtureless manner) two or more structures together, e.g., with a partial, quick-cure adhesive bond, before fixturelessly joining (i.e., join in a fixtureless manner) those two or more structures with the first structure retained by keystone robot 507. The two or more structures that are joined to one another prior to being joined with a structural assembly may also be a structure, and may further be referred to as a subassembly. Accordingly, when a structure forms a portion of a structural subassembly that is connected with the first structure through movements of keystone robot 507, structural adhesive robot 513, at least one assembly robot 509, 511, and UV robot 515, a structure of the structural subassembly may be indirectly connected to the first structure when the structural subassembly is joined to a structural assembly including the first structure.

In some embodiments, the structural adhesive may be applied, e.g., deposited on a surface or in a recess (e.g., a groove, grooves, an indentation, indentations, and the like) of one of the structures, before the first and second structures are brought within the joining proximity. For example, structural adhesive robot 513 may include a dispenser for a structural adhesive and may apply the structural adhesive prior to the structures being brought within the joining proximity. In some embodiments, a structural adhesive may be applied after a structural assembly is fully assembled, for example, once each structure of the portion of the vehicle such as a car or an aircraft is brought to their respective joining proximities and fixed relative to the joining proximities by applications of quick cure UV adhesive. For example, the structural adhesive may be applied to one or more joints or other connections between the first structure and the second structure. The structural adhesive may be applied at a time after the last adhesive curing by the UV robot 515 is performed. In some embodiments, the structural adhesive may be applied separately from fixtureless assembly system 500.

After the assembly is complete, i.e., all of the structures have been assembled, retained with a partial adhesive bond, e.g., with applications of quick cure UV adhesive, and with structural adhesive having been applied, the structural adhesive may be cured. In one embodiment, the quick cure adhesive is cured at a first rate and the structural adhesive is cured at a second rate such that the first rate is different from the second rate. Upon curing the structural adhesive, the portion of the vehicle such as a car or an aircraft may be completed and, therefore, may be suitable for use in the vehicle such as a car or an aircraft. For example, a completed structural assembly may meet any applicable industry and/or safety standards defined for consumer and/or commercial vehicles such as a car or an aircraft. In some embodiments, the adhesive applied by the UV robot to achieve the partial adhesive bond for retaining the structures may be removed, for example, after the structural adhesive is cured. In some embodiments, the adhesive for the partial adhesive bond may be left attached to the structures.

According to various embodiments, one or more of robots 507, 509, 511, 513, 515, 517 may be secured to a surface of assembly cell 505 through a respective base of each of the robots. For example, one or more of the robots may have a base that is bolted to the floor of the assembly cell. In various other embodiments, one or more of the robots may include or may be connected with a component configured to move the robot within assembly cell 505. For example, carrier 519 in assembly cell 505 may be connected to assembly/UV robot 517 or any robot of the robotic system.

Referring to FIGS. 6A through 6G, these figures illustrate various configurations of robots 507, 509, 511, 513, 515, 517 during various operations of fixtureless assembly system 500. FIGS. 6A through 6G illustrate example fixtureless joining operations according to various embodiments.

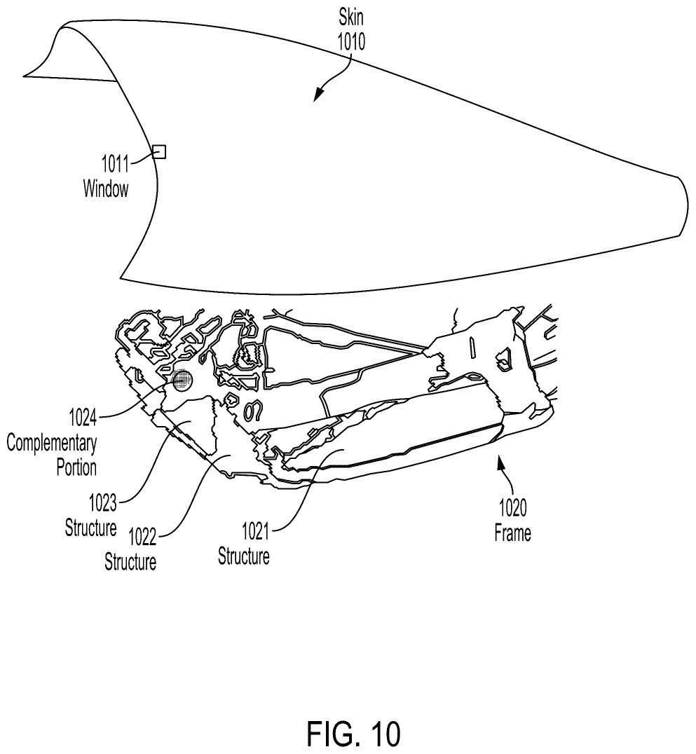

First, an example control system of the robotic system will be described. Each of the robots 507, 509, 511, 513, 515, 517 may be communicatively connected with a controller, such as a respective one of controllers 607, 609, 611, 613, 615, 617 shown in FIGS. 5 and 6A through 6G. Each of controllers 607, 609, 611, 613, 615, 617 may include, for example, a memory and a processor communicatively connected to the memory (e.g., as described with respect to FIG. 10, below). According to some other embodiments, one or more of controllers 607, 609, 611, 613, 615, 617 may be implemented as a single controller that is communicatively connected to one or more of the robots controlled by the single controller.

Computer-readable instructions for performing fixtureless assembly can be stored on the memories of controllers 607, 609, 611, 613, 615, 617, and the processors of the controllers can execute the instructions to cause robots 507, 509, 511, 513, 515, 517 to perform various fixtureless operations, such as those described with respect to FIGS. 6A through 6G.

Controllers 607, 609, 611, 613, 615, 617 may be communicatively connected to one or more components of an associated robot 507, 509, 511, 513, 515, or 517, for example, via a wired (e.g., bus or other interconnect) and/or wireless (e.g., wireless local area network, wireless intranet) connection. Each of the controllers may issue commands, requests, etc., to one or more components of the associated robot, for example, in order to perform various fixtureless operations.

According to some embodiments, controllers 607, 609, 611, 613, 615, 617 may issue commands, etc., to a robotic arm of the associated robot 507, 509, 511, 513, 515, or 517 and, for example, may direct the robotic arms based on a set of absolute coordinates relative to a global cell reference frame of assembly cell 505. In various embodiments, controllers 607, 609, 611, 613, 615, 617 may issue commands, etc., to tools connected to the distal ends of the robotic arms. For example, the controllers may control operations of the tool, including depositing a controlled amount of adhesive on a surface of the first structure and/or second structure by an adhesive applicator, exposing adhesive deposited on the structures to radiation such as UV light for a controlled duration by a curing tool, and so forth. In various embodiments, controllers 607, 609, 611, 613, 615, 617 may issue commands, etc., to end effectors at the distal ends of the robotic arms. For example, the controllers may control operations of the end effectors, including, engaging, retaining, and/or manipulating a structure.

According to various other aspects, a computing system, such as computing system 529, similarly having a processor and memory, may be communicatively connected with one or more of controllers 607, 609, 611, 613, 615, 617. In various embodiments, the computing system may be communicatively connected with the controllers via a wired and/or wireless connection, such as a local area network, an intranet, a wide area network, and so forth. In some embodiments, the computing system may be implemented in one or more of controllers 607, 609, 611, 613, 615, 617. In some other embodiments, the computing system may be located outside assembly cell 505. One example of such a computing system is described below with respect to FIG. 10.

The processor of the computing system may execute instructions loaded from memory, and the execution of the instructions may cause the computing system to issue commands, etc., to the controllers 607, 609, 611, 613, 615, 617, such as by transmitting a message including the command, etc., to one or more of the controllers over a network connection or other communication link.

According to some embodiments, one or more of the commands may indicate a set of coordinates and may indicate an action to be performed by one of robots 507, 509, 511, 513, 515, 517 associated with the one of the controllers that receives the command. Examples of actions that may be indicated by commands include directing movement of a robotic arm, operating a tool, engaging a structure by an end effector, rotating and/or translating a structure, and so forth. For example, a command issued by a computing system may cause controller 609 of assembly robot 509 to direct a robotic arm of assembly robot 509 so that a distal end of the robotic arm may be located based on a set of coordinates that is indicated by the command.

The instructions loaded from memory and executed by the processor of the computing system, which cause the controllers to control actions of the robots may be based on computer-aided design (CAD) data. For example, a CAD model of assembly cell 505 (e.g., including CAD models of the physical robots) may be constructed and used to generate the commands issued by the computing system.

In some embodiments, one or more CAD models may represent locations corresponding to various elements within the assembly cell 505. Specifically, a CAD model may represent the locations corresponding to one or more of robots 507, 509, 511, 513, 515, 517. In addition, a CAD model may represent locations corresponding to structures and repositories of the structures (e.g., storage elements, such as parts tables, within fixtureless assembly system 500 at which structures may be located before being engaged by an assembly robot). In various embodiments, a CAD model may represent sets of coordinates corresponding to respective initial or base positions of each of robots 507, 509, 511, 513, 515, 517.

For such CAD modeling, a reference frame for a coordinate system may be defined. The coordinate system may include absolute coordinates, relative coordinates, or a combination thereof. For a set of absolute coordinates, the coordinate frame may be a global coordinate frame or global cell reference frame, and the coordinate frame may include (e.g., may be bounded by and/or may be defined by) assembly cell 505.

The coordinate frame may be established based on one or more ground references in assembly cell 505—such as one or more laser prisms, each of which may be measured in the assembly cell so that, in the aggregate, a reference frame is defined with a number of reference points corresponding to the number of laser prisms. Thus, a CAD model corresponding to assembly cell 505 may be an as-built CAD model, which may represent the assembly cell more accurately than a nominal CAD model. Absolute coordinates based on CAD modeling may provide a degree of accuracy that is acceptable for fixtureless assembly of vehicles such as a car or an aircraft. For example, directing robots 507, 509, 511, 513, 515, 517 based on absolute coordinates established through CAD modeling may adhere to various industry and/or safety standards that are to be observed when assembling a vehicle such as a car or an aircraft.

In various embodiments, relative coordinates may be used for fixtureless assembly system 500, for example, as an alternative or supplement to an absolute coordinate system. In particular, relative coordinates may be used for some portions of the fixtureless joining process in which a second structure may be joined to the first structure and/or joined to another structure. For example, a controller associated with an assembly robot may direct robotic arm of the assembly robot to a joining position based on a set of absolute coordinates defined with respect to the global cell reference frame. The position of the robotic arm may be measured (e.g., by the controller of the assembly robot, by the controller of the keystone robot, by another controller and/or processing system, etc.) after assembly robot reaches the joining position based on the set of absolute coordinates, and the measured position of assembly robot may be provided to controller of the keystone robot. The controller of the keystone robot may position the robotic arm of the keystone robot based on the measured position of the assembly robot's robotic arm. Thus, the keystone robot's arm may be positioned relative to the assembly robot's arm, for example, instead of correcting the respective positions of each of the keystone robot and the assembly robot according to the global cell reference frame while the controllers may remain agnostic to the positions of the keystone robot or the assembly robot.

In addition, a CAD model may represent one or more of the operations that are to be performed within assembly cell 505 for construction of at least a portion of a vehicle such as a car or an aircraft. In other words, a CAD model may simulate the assembly procedure of fixtureless assembly system 500 and, therefore, may simulate each of the movements and/or actions performed by one or more of the robots. The CAD simulation may be translated into a set of discrete operations (e.g., a discrete operation may include direction for an associated set of coordinates), which may be physically performed by one or more of the robots.

By way of illustration, movements of the assembly robot and the structural adhesive robot within the reference frame of assembly cell 505 may be simulated in order to model absolute coordinates (and, optionally, times) for operations of the assembly robot and the structural adhesive robot. For example, a CAD model may simulate three operations: (1) a first time and first set of coordinates for fixtureless engagement of a structure positioned on a parts table by an end effector of an assembly robot, (2) a second time and second set of coordinates for directing the assembly robot to position the structure proximate to a structural adhesive robot for application of an adhesive, and (3) a third time and third set of coordinates for directing the structural adhesive robot to apply adhesive to a surface of the structure. Subsequently, the example simulated operations may be translated to one or more sets of discrete instructions, which may be loaded into memory of one or more controllers communicatively connected to the assembly and structural adhesive robots. When executed by the processors of the respective controllers, the sets of discrete instructions may cause the robots in fixtureless assembly system 500 to perform the operations simulated through the CAD model.

Each of robots 507, 509, 511, 513, 515, 517 may include features that are common across all or some of the robots. For example, all of the robots may include a base, each of which having a surface (e.g., a bottom surface) that contacts assembly cell 505 (e.g., rests on or is secured to a floor of the assembly cell). Each base may have another surface (e.g., a top surface and/or a surface disposed on the base opposite from the surface contacting assembly cell 505) and, at a respective other surface, a base may connect with a proximal end of a respective robotic arm of a respective one of the robots.

In some embodiments, a base may be connected to the proximal end of a robotic arm through at least one rotation and/or translation mechanism. The at least one rotation and/or translation mechanism may provide at least one degree of freedom in movement of an end effector or other tool of the robotic arm. Correspondingly, the at least one rotation and/or translation mechanism may provide at least one degree of freedom in movement of a structure that is engaged and retained by an end effector or other tool of the robotic arm.

Each robotic arm of robots 507, 509, 511, 513, 515, 517 may include a distal end, oppositely disposed from the proximal end of the robotic arm. As described herein (e.g., with respect to FIGS. 6A through 6G, below), each robotic arm of each of the robots may include an end effector and/or a tool, such as an adhesive application tool, curing tool, and so forth. An end effector or a tool may be at the distal end of a robotic arm. In some embodiments, the distal end of a robotic arm may be connected to an end effector or a tool (or tool flange) through at least one rotation and/or translation mechanism, which may provide at least one degree of freedom in movement of the tool and/or movement of a structure engaged and retained by the tool of the robotic arm.

In some embodiments, the distal end of a robotic arm may include a tool flange, and a tool included at the tool flange. For example, a tool may be connected to the distal end of a robotic arm directly to or indirectly (i.e., coupled) to the tool flange. A tool flange may be configured to include a plurality of tools. In this way, for example, the assembly/UV robot 517 may offer functionality similar to each of the assembly robots 509, 511 when a distal end of a robotic arm of the assembly/UV robot includes an end effector (e.g., connected or coupled to the tool flange). In addition, assembly/UV robot 517 may offer functionality similar to UV robot 515 when the distal end of the robotic arm of the assembly/UV robot includes a tool configured to apply UV adhesive and to emit UV light to cure the adhesive.

According to some embodiments, a tool flange and/or tool may provide one or more additional degrees of freedom for rotation and/or translation of a structure engaged and retained by the tool. Such additional degrees of freedom may supplement the one or more degrees of freedom provided through one or more mechanisms connecting a base to the proximal end of a robotic arm and/or connecting the distal end of a robotic arm to the tool (or tool flange). Illustratively, a robotic arm of at least one of robots 507, 509, 511, 513, 515, 517 may include at least one joint configured for rotation and/or translation at a distal and/or proximal end, such as an articulating joint, a ball joint, and/or other similar joint.

One or more of the respective connections of robots 507, 509, 511, 513, 515, 517 (e.g., one or more rotational and/or translational mechanisms connecting various components of one of the robots), a respective tool flange, and/or a respective tool may provide at least a portion (and potentially all) of six degrees of freedom (6DoF) for a structure engaged and retained by the robots. The 6DoF may include forward/backward (e.g., surge), up/down (e.g., heave), left/right (e.g., sway) for translation in space and may further include yaw, pitch, and roll for rotation in space. Access to various portions of a structure may be attainable through one or more of the 6DoF, as opposed to retention of a structure using a fixture, which cannot offer 6DoF in movement of a structure and also blocks access to a significant portion of a structure attached thereto.

In assembly systems including fixtures, positioners, and/or fixture tables, 6DoF may be unattainable during the assembly process, for example, because at least one of the fixture, positioner, and/or fixture table may prevent one or more of surge, heave, sway, yaw, pitch, and/or roll of a structure to which the fixture is attached. Coupled with the reduction in available space commensurate with use of a fixture, positioner, and/or fixture table for accessing and/or manipulating a structure, the unattainable one(s) of the 6DoF may render some significant portions of the structure inaccessible.

The inaccessibility of portions of the structure make the assembly process of a vehicle such as a car or an aircraft difficult. For example, the inaccessibility of a surface of a structure at which another structure is to be joined may render a structural assembly unsuitable for use in a vehicle such as a car or an aircraft that is to meet various industry and/or safety standards for commercial and/or consumer vehicles such as a car or an aircraft.

In contrast, fixtureless robotic operations for constructing a structural assembly as described herein (e.g., with respect to the fixtureless assembly system 500) may feature a greater number of degrees of freedom (e.g., all 6DoF) than assembly systems that rely on fixtures, positioners, and/or fixture tables. Commensurately, fixtureless robotic operations (e.g., fixtureless assembly system 500) may reduce the complexities and/or difficulties otherwise inherent with the manipulation and/or accessibility of a structure, thereby increasing the likelihood that a structural assembly derived through fixtureless assembly system 500 may meet various industry and/or safety standards.

Example operations of fixtureless assembly system 500 will now be described in FIGS. 6A through 6G. As described herein, the example operations may be caused by at least one of controllers 607, 609, 611, 613, 615, 617 communicatively coupled with robots 507, 509, 511, 513, 515, 517. In some embodiments, computing system 529 may issue commands to controllers 607, 609, 611, 613, 615, 617 to cause the example operations. Computing system 529 and/or controllers 607, 609, 611, 613, 615, 617 may cause the example operations based on CAD data, which may model the physical robots performing the example operations, and/or positional data, which may be provided by metrology system 531.

For the example operations of fixtureless assembly system 500, robots 507, 509, 511, 513, 515, 517 may be positioned relatively proximate to one another, e.g., at distances suitable for the example operations described below. For example, a proximity of the structures (e.g., a skin and a structure) for joining/connecting may be a first surface of a first structure having a distance ranging from about 0.05 mm to about 150 mm from a second surface of a second structure. The first surface of the first structure may be a surface that will be connected to the second structure. The second surface of the second structure may be a surface that will be connected to the first structure. In some embodiments, one or more robots 507, 509, 511, 513, 515, 517 may be positioned in fixtureless assembly system 500 at locations suitable for the one or more example operations prior to the example operations described below. At such locations, the respective bases of those one or more robots may be static throughout the example operations of fixtureless assembly system 500. However, movement of the robotics arms of robots 507, 509, 511, 513, 515, 517 may be controlled in coordination at various stages of fixtureless assembly system 500, such as by rotating about the respective bases, turn at a hinge, and/or otherwise articulate.

In some other embodiments, different robots 507, 509, 511, 513, 515, 517 may be dynamically (re) positioned at different distances from one another at different stages of fixtureless assembly. Carrier 519 may be configured to move one or more robots 507, 509, 511, 513, 515, 517 to their respective positions, e.g., according to execution by one or more processors of one or more sets of instructions associated with the fixtureless assembly. Whether static or dynamic, the respective locations at which each of robots 507, 509, 511, 513, 515, 517 is positioned may be based on one or more sets of coordinates associated with fixtureless assembly system 500 (e.g., one or more sets of absolute coordinates).

Referring first to FIG. 6A, assembly robot 511 can engage first structure 523. First structure 523 may include one or more features that enable joining of first structure 523 with one or more other structures. In one embodiment, the first structure may be a skin and the other structure may be a single structure or a plurality of connected structures. In one embodiment, the first structure may be a single structure or a plurality of connected structures and the other structure may be a skin. In all of the figures in which a groove is illustrated, a recess may be considered as the illustrated groove in all of the figures and disclosure. Similarly, in all of the figures in which a tongue is illustrated, a protrusion may be considered as the illustrated tongue in all of the figures and disclosure. Illustratively, first structure 523 may include a recess such as groove 533 on a first surface and may include a protrusion such as tongue 535 on a second surface. The first surface and the second surface of first structure 523 may be different sides of the first structure (e.g., the first surface may be on a left or top side of first structure 523 and the second surface may be on a right or bottom side of first structure 523, or vice versa).

Assembly robot 511 may be located relatively proximate to parts table 521. At such a location, the robotic arm of assembly robot 511 may be within a proximity at which the robotic arm of assembly robot 511 is able to reach at least a portion of the parts located on parts table 521. In the example embodiment of FIG. 6A, assembly robot 511 may be located at one side of parts table 521, and a recess such as groove 533 of first structure 523 may be relatively closer to assembly robot 511 than a protrusion such as tongue 535 of first structure 523 at such a location of assembly robot 511.

Assembly robot 511 may be connected to end effector 537. Illustratively, the distal end of the robotic arm of assembly robot 511 may be connected to end effector 537, which may be built onto the distal end of the robotic arm or may be attached to the robotic arm (and may be fixed or removable). End effector 537 of assembly robot 511 may be configured to engage (e.g., pick up) and retain one or more structures. For example, end effector 537 of assembly robot 511 may be configured to engage with different structures, such as via one or more features (e.g., one or more attachment features) of the different structures. Some examples of such an end effector may include jaws or grippers.

Assembly robot 511 may engage with first structure 523, e.g., approximately at a side of the first structure that does not have a recess such as groove 533 or a protrusion such as tongue 535. Specifically, the robotic arm of assembly robot 511 may move to a position at which end effector 537 of assembly robot 511 can engage first structure 523. At this position, end effector 537 of assembly robot 511 engages with first structure 523, e.g., at the different side and/or surface than a recess such as groove 533 or a protrusion such as tongue 535. Once engaged, assembly robot 511 may retain first structure 523, e.g., by means of end effector 537. When first structure 523 is retained by assembly robot 511, assembly robot 511 may move first structure 523 to one or more positions at which one or more example operations of fixtureless assembly may be performed, as further described below.

Next referring to FIG. 6B, assembly robot 511 may turn to face structural adhesive robot 513. The distal end of the robotic arm of assembly robot 511 may be positioned toward structural adhesive robot 513, and similarly, the distal end of the robotic arm of structural adhesive robot 513 may be positioned toward assembly robot 511. At this example location illustrated in FIG. 6B, assembly robot 511 may move first structure 523 to a position at which the first structure is approximately between assembly robot 511 and structural adhesive robot 513. Further, assembly robot 511 may orient first structure 523 so that a recess such as groove 533 is facing approximately upward, such as by causing the robotic arm of assembly robot 511 and/or end effector 537 of assembly robot 511 to move such that first structure 523 is oriented approximately upward.

Structural adhesive robot 513 may be connected to structural adhesive applicator 539 or another similar tool. Illustratively, structural adhesive applicator 539 may be built onto the distal end of the robotic arm or may be attached to the robotic arm (and may be fixed or removable). Structural adhesive applicator 539 may be configured to deposit adhesive on structural surfaces.

When first structure 523 is suitably positioned (e.g., between the two robots 511, 513), structural adhesive robot 513 may cause application of the adhesive to first structure 523. Specifically, structural adhesive robot 513 may deposit the adhesive onto a surface or into a recess such as groove 533 of first structure 523. To do so, structural adhesive robot 513 may move its robotic arm to a position such that structural adhesive applicator 539 is above the recess, (e.g., groove 533) and is sufficiently close so that a controlled amount of the adhesive can be deposited within a defined area while avoiding deposition of the adhesive on unintended surfaces. At such an above position, an adhesive application tip of structural adhesive applicator 539 may be approximately directly above the recess, (e.g., groove 533) and may be pointed downward into the recess (e.g., groove 533).

After being deposited, the controlled amount of adhesive may be on the surface of the first structure or at least partially fill groove 533. In some embodiments, the controlled amount of adhesive may entirely or nearly entirely fill groove 533. The amount of adhesive, however, may be controlled such that the adhesive does not overflow outside groove 533 and onto the first surface of first structure 523 that bounds groove 533. For example, the amount of adhesive deposited in groove 533 may be controlled such that the adhesive does not leak onto any of the surfaces of first structure 523 when a protrusion, such as a tongue, of another structure is inserted into the recess such as groove 533 when first structure 523 is joined with the other structure.

Turning to FIG. 6C, keystone robot 507 can engage second structure 525. Similar to first structure 523, second structure 525 may include one or more features that enable joining of second structure 525 with one or more other structures. In the illustrated embodiment, second structure 525 may include a recess such as groove 547 on a first surface and may include a protrusion such as tongue 545 on a second surface. The first surface and the second surface of second structure 525 may be on approximately opposite sides to one another.

Second structure 525 may be located on parts table 522, and keystone robot 507 may be located relatively proximate to parts table 522. At such a location, the robotic arm of keystone robot 507 may be within a proximity at which the robotic arm of keystone robot 507 is able to reach at least a portion of the parts located on parts table 522. In the example embodiment of FIG. 6C, keystone robot 507 may be located at one side of parts table 522, and a protrusion such as tongue 545 of second structure 525 may be positioned toward the side of parts table 522 that is relatively opposite from the one side at which keystone robot 507 is located. At this position, a recess such as groove 547 of second structure 525 pointing towards keystone robot 507.

Keystone robot 507 may be connected to end effector 543. Illustratively, the distal end of the robotic arm of keystone robot 507 may be connected to end effector 543, which may be built onto the distal end of the robotic arm or may be attached to the robotic arm (and may be fixed or removable). End effector 543 of keystone robot 507 may be configured to engage (e.g., pick up) and retain one or more structures. For example, end effector 543 of keystone robot 507 may be configured to fixturelessly engage with different structures, such as via one or more features (e.g., one or more attachment features) of the different structures. Some examples of such an end effector may include jaws or grippers.

Keystone robot 507 may engage with second structure 525 at the first surface, i.e., the surface on which groove 547 is located. Specifically, the robotic arm of keystone robot 507 may be moved to a position at which the keystone robot can engage second structure 525, and keystone robot 507 may then engage and retain second structure 525 at the first surface using end effector 543.

With respect to FIG. 6D, keystone robot 507 may turn to face assembly robot 511, and the assembly robot may turn to face the keystone robot. The distal end of the robotic arm of keystone robot 507 may be positioned toward assembly robot 511, and similarly, the distal end of the robotic arm of assembly robot 511 may be positioned toward keystone robot 507.

At this example location illustrated in FIG. 6D, keystone robot 507 may move second structure 525 to a position at which second structure 525 is approximately between keystone robot 507 and assembly robot 511. Further, keystone robot 507 may orient second structure 525 so that a protrusion such as tongue 545 of second structure 525 is facing approximately downward, such as by causing the robotic arm of keystone robot 507 and/or end effector 543 of keystone robot 507 to move such that second structure 525 is oriented approximately downward.

In some embodiments, keystone robot 507 may move second structure 525 according to one or more vectors, which may be based on CAD modeling. Each of the one or more vectors may indicate a magnitude (e.g., distance) and a direction according to which second structure 525 is to be moved by keystone robot 507. Each vector may be intended to bring second structure 525 within the proximity of joining/connecting to another structure, (e.g., first structure 523) although some vectors may be intermediary vectors intended to bring second structure 525 to a position at which a vector for joining first and second structures 523, 525 can be applied.

Assembly robot 511 may position first structure 523 relatively closer to assembly robot 511 than keystone robot 507. In some embodiments, assembly robot 511 may position first structure 523 to be at least partially above at least a portion of second structure 525. For example, assembly robot 511 may retain first structure 523 at an approximately overhead position.

Now referring to FIG. 6E, assembly robot 511 and keystone robot 507 may move first structure 523 and second structure 525, respectively, to positions close to each other, but not close enough to be joined. Further, first structure 523 may be positioned to be below second structure 525, for example, such that first structure 523 and second structure 525 may at least partially overlap in the elevational plane (or vertical space).

Assembly robot 511 may orient first structure 523 so that a recess such as groove 533 of first structure 523 is facing approximately upward, having the controlled amount of adhesive previously deposited therein. For example, assembly robot 511 may cause its robotic arm and/or end effector 537 to move such that groove 533 of first structure 523 is oriented approximately upward. Thus, groove 533 of first structure 523 may face a protrusion such as tongue 545 of second structure 525.

Similar to the movement of second structure 525 by keystone robot 507, assembly robot 511 may move first structure 523 according to one or more vectors, which may be based on CAD modeling. Each of the one or more vectors may indicate a magnitude (e.g., distance) and a direction according to which first structure 523 is to be moved by assembly robot 511. Each vector may be intended to bring first structure 523 within the proximity of joining/connecting to another structure, (e.g., second structure 525) although some vectors may be intermediary vectors intended to bring first structure 523 to a position at which a vector for joining first and second structures 523, 525 can be applied.

Keystone robot 507 may retain second structure 525 at the previously described position with tongue 545 oriented approximately downwardly; although second structure 525 may now be positioned above first structure 523 due to the movement of first structure 523 caused by assembly robot 511. However, first and second structures 523, 525 may not yet be within the joining proximity at which the first structure can be joined with the second structure.

FIG. 6F illustrates how first structure 523 and second structure 525 may be brought within the joining proximity at which the two structures can be joined. The joining proximity can be a position that allows a first structure to be joined to a second structure. For example, a joining proximity may be a first surface of a first structure having a distance ranging from about 0.05 mm to about 150 mm from a second surface of a second structure. The first surface of the first structure may be a surface that will be connected to the second structure. The second surface of the second structure may be a surface that will be connected to the first structure. To bring first and second structures 523, 525 within the joining proximity, one or both of the first and/or second structures may be moved by one or both of assembly robot 511 and/or keystone robot 507, respectively. For example, assembly robot 511 may cause the distal end of its robotic arm, at which first structure 523 is engaged, to move in an approximately upwardly direction toward second structure 525. Additionally or alternatively, keystone robot 507 may cause the distal end of its robotic arm, at which second structure 525 is engaged, to move in an approximately downwardly direction toward first structure 523.

In various embodiments, joining structures that are engaged by robots in fixtureless assembly system 500 may be accomplished using a “move-measure-correct” procedure. In effect, the move-measure-correct procedure may include moving at least one structure toward the joining proximity, measuring at least one difference between the current position of one of the structures (e.g., the physical position of the structure) and the position at which the structures can be joined (e.g., the joining proximity), and correcting the position of at least one of the structures such that the structures can be brought within the joining proximity, at which the structures can be joined. The move-measure-correct procedure may be repeated for one or more of the structures to be joined until the structures are brought within the joining proximity, at which point the joining operation can be accomplished such that the structures are joined (e.g., within acceptable tolerances). It is possible that the structures can be brought within the joining proximity in one step, thus repeating the procedure may not be necessary in all cases.

The move-measure-correct procedure may use metrology system 531, which may be configured to determine (e.g., detect, calculate, measure, capture, etc.) positional data associated with assembly cell 505. The positional data may include a set of measurements or other values indicative of one or more positions of structures and/or robots (e.g., including robotic arms and/or components connected with robots, such as tools, flanges, end effectors, and so forth). Metrology system 531 may include one or more devices located in and/or proximate to assembly cell 505 and may include, for example, a tracker-machine control sensor (T-MAC), a laser metrology device (e.g., configured for laser scanning and/or tracking), a photogrammetry device, a camera (e.g., configured to capture still images and/or video), and/or another device configured to similarly determine positional data.

In some embodiments, metrology system 531 may determine positional data based on at least one target in assembly cell 505, which may be located on one or more of the robots (e.g., including robotic arms and/or components connected with robots, such as tools, flanges, end effectors, and so forth), one or more of the structures to be joined, and/or elsewhere in assembly cell 505. The at least one target may be detectable/identifiable by metrology system 531 in assembly cell 505—for example, the at least one target may be reflective and/or may be of a specific shape so as to distinguish the at least one target in assembly cell 505.

Metrology system 531 may provide the positional data to computing system 529. For example, the positional data may indicate a set of coordinates associated with the structure. The set of coordinates may include at least one of a set of absolute coordinates (e.g., a global coordinate frame for assembly cell 505) and/or a set of relative coordinates (e.g., relative to the joining proximity and/or relative to the other one of the structures).

The positional data may be used to determine (e.g., measure or calculate) the difference between the current position of one of the structures and the joining proximity by computing system 529. For example, computing system 529 may determine a difference between the set of coordinates indicated by the positional data and a set or expected coordinates, which may be the coordinates at which the structure is expected to be located in order to be brought within the joining proximity.

If necessary, the position of at least one of the structures can be corrected based on the determined difference. For example, robot imperfections and/or other imprecisions in fixtureless assembly system 500 may cause structures to drift or otherwise become unaligned with the joining proximity and/or the vectors or coordinates according to which structures are to be moved to be brought within the joining proximity. If the determined difference is not within the acceptable tolerances of the joining proximity, computing system 529 can determine a vector and/or set of coordinates according to which one of the structures is to be moved so that the structure can be brought within the joining proximity.

Computing system 529 may then issue a command to one of controllers 607, 609, 611, 613, 615, 617 communicatively connected with one of robots 507, 509, 511, 513, 515, 517 that is retaining the structure, and the issued command may cause the controller to correct the position of the structure such that the structure is brought within the joining proximity. For example, one of robots 507, 509, 511, 513, 515, 517 may move the structure according to the determined vector and/or set of coordinates based on the issued command.

In the context of FIG. 6F, metrology system 531 may determine positional data associated with at least one of first structure 523 and/or second structure 525 in assembly cell 505. For example, metrology system 531 may determine a set of coordinates associated with first structure 523. The set of coordinates may indicate the physical position of first structure 523 in assembly cell 505 and/or relative to the joining proximity or second structure 525.

Metrology system 531 may provide the positional data to computing system 529. Computing system 529 may receive the positional data and, based on the positional data, may determine a set of corrective operations to be applied so that first structure 523 can be brought within the joining proximity and joined/connected with second structure 525. For example, computing system 529 may determine a difference between the set of coordinates associated with first structure 523 and the joining proximity.

Based on the determined difference, computing system 529 may determine the set of corrective operations to be applied to first structure 523 such that first structure 523 can be brought within the joining proximity. In some embodiments, the set of corrective operations may include a set of vectors that each indicate a magnitude and a direction based on which first structure 523 can be moved within the joining proximity. In some other embodiments, the set of corrective operations may include a set of coordinates associated with bringing first structure 523 within the joining proximity, such as a set of coordinates according to which the robotic arm of assembly robot 511 is to be controlled so that first structure 523 is brought within the joining proximity.

Computing system 529 may provide the set of corrective operations to controller 611 communicatively connected with assembly robot 511, such as by issuing a set of commands to controller 611. Controller 611 may apply the set of commands by controlling the robotic arm of assembly robot 511 according to the set of corrective operations indicated by the set of commands.

In some embodiments, metrology system 531 may again determine positional data associated with at least one of first structure 523 and/or second structure 525 after the aforementioned set of corrective operations is applied. Computing system 529 may receive the subsequent positional data and, based on the subsequent positional data, may determine the next set of corrective operations, if needed to bring first structure 523 and second structure 525 within the joining proximity. If the next set of corrective operations is needed, computing system 529 may issue the next set of commands to one of controller 607 or controller 611 (e.g., depending on which of first structure 523 or second structure 525 is to be moved). The controller receiving the next set of commands may control the corresponding one of keystone robot 507 or assembly robot 511 according to the next set of corrective operations. The move-measure-correct procedure may be iteratively repeated until computing system 529 determines first structure 523 and second structure 525 are at the joining proximity and no further corrective operations should be applied. Thus, first structure 523 and second structure 525 may be joined/connected at the joining proximity.

When structures are within the joining proximity, at least a portion of one structure may overlap with at least a portion of another structure in at least one of the azimuthal (or horizon) plane and/or the elevational plane. According to such an overlap, one or more features of one structure may connect with one or more complementary features of another structure, e.g., by interlocking or fitting together, such as when a protrusion of one structure is inserted into a recess of another structure. In the illustrated example operations of fixtureless assembly system 500, the protrusion (e.g., tongue 545) of second structure 525 may be positioned within at least a portion of the recess (e.g., groove 533) of first structure 523 when first structure 523 and second structure 525 are within the joining proximity, thereby creating a joint, for example a tongue-and-groove joint.

In some embodiments, tongue 545 of second structure 525 may not contact first structure 523 at the joining proximity. In other words, the robots can be controlled to bring the structures within joining proximity while preventing the structures from contacting each other. For example, tongue 545 of second structure 525 may be within groove 533 of first structure 523, but lateral bond gaps, such as lateral bond gaps 561a, 561b, collectively referred to herein as lateral bond gaps 561 between the tongue and the sides of the groove, and vertical bond gap 562 between the tongue and the bottom of the groove, can exist (i.e., be caused) because the tongue is inserted in the groove without contacting the sides and bottom. Rather, tongue 545 of second structure 525 may merely contact the structural adhesive deposited in groove 533 of first structure 523 (as shown above in FIG. 6B) when first structure 523 and second structure 525 are at the joining proximity. In some further embodiments, however, the surface surrounding groove 533 of first structure 523 may contact the surface surrounding tongue 545 of second structure 525.

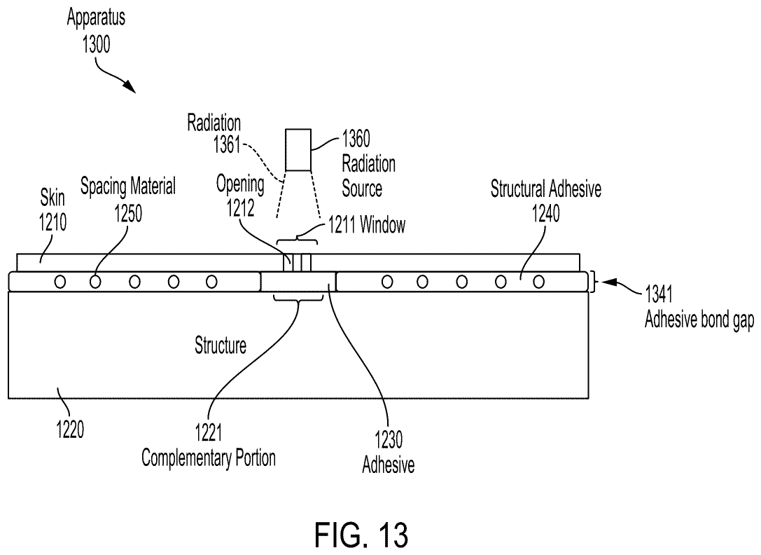

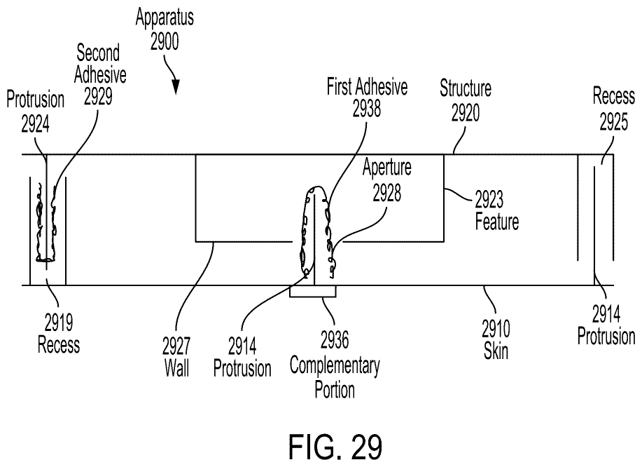

The bond gaps (e.g., 1341 and 3080 in respective FIGS. 13 and 29) resulting from joining without contact can provide a significant advantage in assembling multi-part structures. Specifically, for each individual joining operation, there may be spatial errors that might be caused by, for example, improper positioning of the structures, variations in the dimensions of the structures (e.g., a 3D printed structure might not have the exact dimensions as expected, due to the nature of 3D printing). In typical joining operations, these errors can add together with each joining operation of the multi-part structures, causing the final assembly to have large errors in dimension. However, the bond gaps resulting from contact-free joining can absorb the dimensional errors of each individual joining. The joining illustrated in FIG. 6G provides more details of how bond gaps can absorb dimensional errors.

FIG. 6G illustrates how bond gaps can absorb dimensional errors and having subassembly 603 and third structure 527 brought within the joining proximity at which the subassembly and the third structure can be joined. One or both of subassembly 603 and/or third structure 527 may be moved by one or both of keystone robot 507 and/or assembly robot 511, respectively. For example, assembly robot 511 may cause the distal end of its robotic arm, at which third structure 527 is engaged, to move in an approximately upwardly direction toward subassembly 603. Additionally or alternatively, keystone robot 507 may cause the distal end of its robotic arm, at which subassembly 603 is retained, to move in an approximately downwardly direction toward third structure 527.

Similar to the example operations described above in FIG. 6F, metrology system 531 may determine positional data associated with at least one of subassembly 603 and/or third structure 527 in assembly cell 505. For example, metrology system 531 may determine a set of coordinates associated with third structure 527. The set of coordinates may indicate the physical position of third structure 527 in assembly cell 505 and/or relative to the joining proximity or subassembly 603.

Metrology system 531 may provide the positional data to computing system 529. Computing system 529 may receive the positional data and, based on the positional data, may determine a set of corrective operations to be applied so that third structure 527 can be brought within the joining proximity and joined with subassembly 603, and specifically, by inserting tongue 535 of first structure 523 into groove 551 of third structure 527 having the structural adhesive. For example, computing system 529 may determine a difference between the set of coordinates associated with third structure 527 and the joining proximity.

Based on the determined difference, computing system 529 may determine the set of corrective operations to be applied to third structure 527 such that the third structure can be brought within the joining proximity. In some embodiments, the set of corrective operations may include a set of vectors that each indicate a magnitude and a direction based on which third structure 527 can be moved within the joining proximity. In some other embodiments, the set of corrective operations may include a set of coordinates associated with bringing third structure 527 within the joining proximity, such as a set of coordinates according to which the robotic arm of assembly robot 511 is to be controlled so that third structure 527 is brought within the joining proximity.

Computing system 529 may provide the set of corrective operations to controller 611 communicatively connected with assembly robot 511, such as by issuing a set of commands to controller 611. Controller 611 may apply the set of commands by controlling the robotic arm of assembly robot 511 according to the set of corrective operations indicated by the set of commands.

In some embodiments, computing system 529 may receive positional data from metrology system 531 indicating that subassembly 603 and third structure 527 are within the joining proximity. For example, computing system 529 may determine, from received positional data, that third structure 527 is positioned within acceptable tolerances of joining third structure 527 and subassembly 603. The acceptable tolerances may be provided by bond gaps, similar to the bond gaps shown in FIG. 6F. However, in the joining operation shown in FIG. 6G, the lateral bond gaps are not equal. Specifically, first lateral bond gap 565 is bigger (e.g., wider) than second lateral bond gap 566. The difference in size of the first and second lateral bond gaps could be caused, for example, because the protrusion such as a tongue was printed incorrectly, such that the tongue was shifted to one side (from the perspective of the figure). However, because the bond gaps allow for some amount of dimensional error, the ultimate position of the remaining portion of subassembly 603 may be accurately positioned relative to third structure 527. In this way, for example, bond gaps resulting from contact-free joining can offset dimensional errors, thus allowing large, multi-structure assemblies to have greater dimensional accuracy. In the automotive and aerospace fields, in particular, dimensional accuracy is a critical element of quality construction. Thus, fixtureless, contact-free joining of structures can provide significant advantages.

In some embodiments, exposing the UV adhesive previously applied to temporarily bond the structures together to the temperature of an oven for the duration sufficient to cure the structural adhesive may cause the UV adhesive to disintegrate or otherwise burn off. After the duration sufficient to cure the structural adhesive, the bonded structures may be removed from the oven and these bonded structures may then be included in a vehicle for example, as a frame, chassis, body, panel, or other vehicular component including an aircraft fuselage, skin, wing, winglet, tail, or other aircraft component.

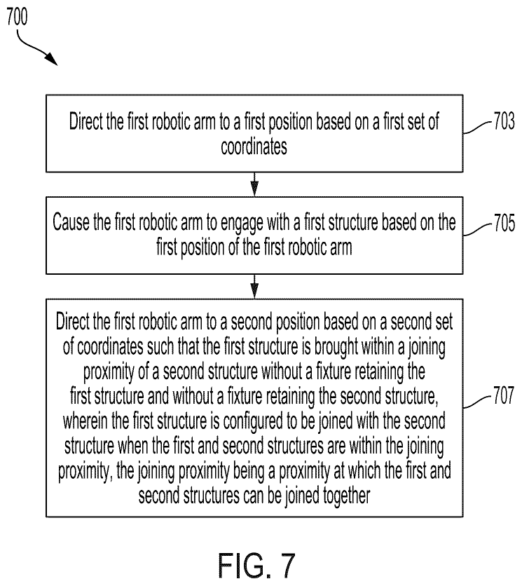

FIG. 7 is a flow diagram of an example method (i.e., method 700) of a fixtureless assembly system including at least two robots. One or more of the illustrated operations may be transposed, omitted, and/or contemporaneously performed.

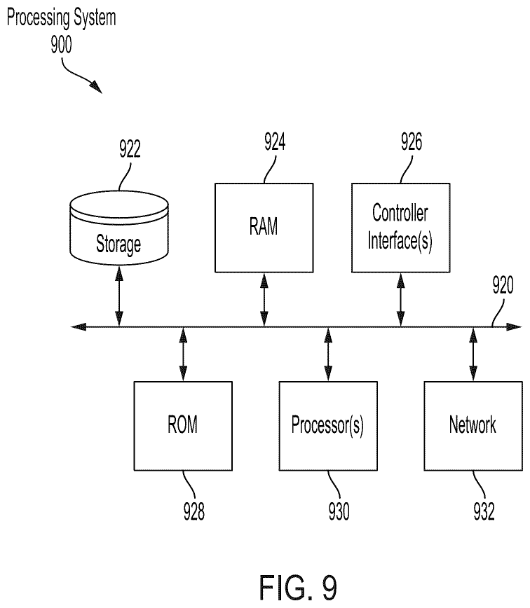

Method 700 may be performed in a fixtureless assembly system, such as fixtureless assembly system 500 of FIG. 5, and example assembly systems FIGS. 6A through 6G. In some embodiments, a computing system may perform method 700, such as by one or more of controllers 607, 609, 611, 613, 615, 617 and/or computing system 529, which may be, for example, a processing system such as processing system 900 described below in FIG. 9. A computing system performing method 700 may include a memory and at least one processor connected to the memory, and the at least one processor may be configured to perform the operations of method 700. The computer performing method 700 may be communicatively connected with one or more of a switch and/or one or more robots (e.g., one or more of robots 507, 509, 511, 513, 515, 517). The computing system may be communicatively connected with one or more of the aforementioned components via one or more networks.

By way of example, the computing system performing method 700 may comprise at least one controller communicatively connected with a robot such as a keystone. The computing system may direct a first robotic arm to a first position based on a first set of coordinates (block 703). The computing system may cause the first robotic arm to engage with a first structure based on the first position of the first robotic arm (block 705). Further, the computing system may direct the first robotic arm to a second position based on a second set of coordinates such that the first structure is brought within a joining proximity of a second structure without a fixture retaining the first structure and without a fixture retaining the second structure, wherein the first structure is configured to be joined with the second structure when the first and second structures are within the joining proximity, the joining proximity being a proximity at which the first and second structures can be joined together (block 707).

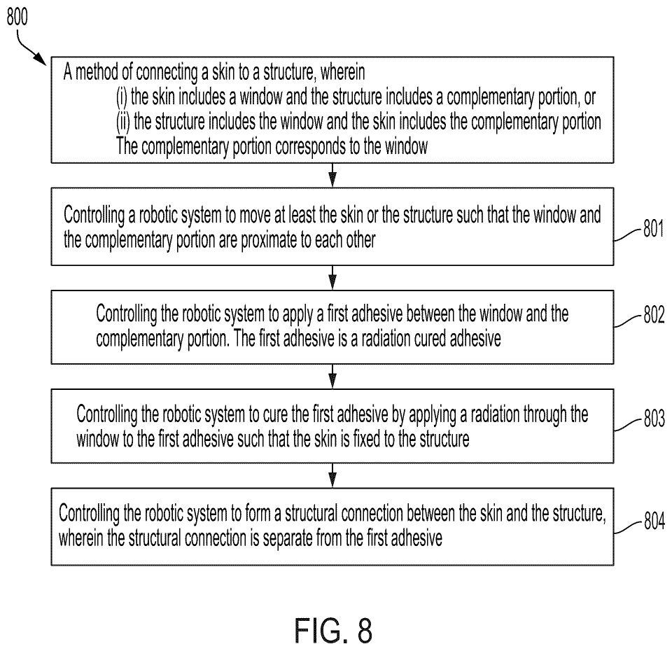

FIG. 8 is a flow diagram of an example method (i.e., method 800) of connecting a skin to a structure by controlling a robotic system. One or more of the illustrated operations may be transposed, omitted, and/or contemporaneously performed.

Method 800 may be performed in a fixtureless assembly system, such as fixtureless assembly system 500 of FIG. 5, and example assembly systems FIGS. 6A through 6G. In some embodiments, a computing system may perform method 800, such as by one or more of controllers 607, 609, 611, 613, 615, 617 and/or computing system 529, which may be, for example, a processing system such as processing system 900 described below in FIG. 9. A computing system performing method 800 may include a memory and at least one processor connected to the memory, and the at least one processor may be configured to perform the operations of method 800. The computer performing method 800 may be communicatively connected to a robotic system, which includes one or more of a switch and/or one or more robots (e.g., one or more of robots 507, 509, 511, 513, 515, 517) The computing system may be communicatively connected with one or more of the aforementioned components via one or more networks.

By way of example, the computing system and/or the robotic system performing method 800 may comprise at one or more controllers communicatively connected with corresponding one or more robots. However, one controller may be communicate with and control each robot. In some embodiments, the method may include (i) the skin comprises a window and the structure comprises a complementary portion, or (ii) the structure comprises the window and the skin comprises the complementary portion, where the complementary portion corresponds to the window (block 800). The computing system may include controlling a robotic system to move at least the skin or the structure such that the window and the complementary portion are proximate to each other (block 801). For example, a first robot may engage with the skin via a first engagement feature of the skin and a second robot may engage with the structure via a second engagement feature of the structure. The first robot may move the skin and/or the second robot may move the structure such that the skin and structure are within a joining proximity (e.g., a joining proximity between the skin and the structure, where the joining proximity may be a first surface of the skin having a distance ranging from about 0.05 mm to about 150 mm from a second surface of a structure). The computing system may include controlling the robotic system to apply a first adhesive between the window and the complementary portion (block 802). For example, a robot may apply the adhesive between the window and the complementary portion via a tool connected to the robot's arm or an end effector of the robot. Applying the adhesive may include providing the adhesive on a surface of the skin and/or the structure. The computing system may include controlling the robotic system to cure the first adhesive by applying a radiation through the window to the first adhesive such that the skin is fixed to the structure (block 803). For example, a robot may apply radiation to the adhesive through the window via a tool connected to the robot's arm or an end effector of the robot. The computing system may include controlling the robotic system to form a structural connection between the skin and the structure, where the structural connection in the method may be separate from the first adhesive (block 804). One example is a robot may apply a structural adhesive between the window and the complementary portion via a tool connected to the robot's arm or an end effector of the robot. Another example is a robot forming the structural connection with a tool connected to the robot's arm or an end effector of the robot configured to apply or perform one or a combination of glueing, welding, brazing, riveting, screwing or fastening the skin to the structure. The first adhesive in the method may include a radiation cured/curable adhesive.

With respect to FIG. 9, an example block diagram illustrates an embodiment of processing system 900. Processing system 900 may comprise at least one controller associated with at least one robot. For example, referring to FIG. 5, processing system 900 may be an embodiment of at least one of controllers 607, 609, 611, 613, 615, 617 associated with at least one of robots 507, 509, 511, 513, 515, 517. In another example, referring to FIGS. 6A through 6G, processing system 900 may be an embodiment of all of the controllers (e.g., controllers 607, 609, 611, 613, 615, 617).

Processing system 900 may include various types of machine-readable media and interfaces. As illustrated, processing system 900 includes at least one interconnect 920 (e.g., at least one bus), permanent storage device 922, random-access memory (RAM) 924, at least one controller interface(s) 926, read-only memory (ROM) 928, at least one processor(s) 930, and network component 932.

Interconnect 920 may communicatively connect components and/or devices that are collocated with processing system 900, such as internal components and/or internal devices within a housing of processing system 900. For example, interconnect 920 may communicatively connect processor(s) 930 with permanent storage device 922, RAM 924, and/or ROM 928. Processor(s) 930 may be configured to access and load computer-executable instructions from at least one of permanent storage device 922, RAM 924, and/or ROM 928.

Permanent storage 922 may be non-volatile memory that stores instructions and data, independent of the power state (e.g., on or off) of processing system 900. For example, permanent storage 922 may be a hard disk, flash drive, or another read/write memory device.

ROM 928 may store static instructions enabling basic functionality of processing system 900, as well as the components therein. For example, ROM 928 may store instructions for processor(s) 930 to execute a set of processes associated with a robot of at least a portion of a vehicle such as a car or an aircraft, for example, as described with respect to one or more of the robots, above. Examples of ROM 928 may include erasable programmable ROM (EPROM) or electrically EPROM (EEPROM), compact disc ROM (CD-ROM) or other optical disk storage, magnetic disk storage or other magnetic storage devices, and/or another computer-accessible and computer-readable medium that may store program code as instructions and/or data structures.

RAM 924 may include volatile read/write memory. RAM 924 may store computer-executable instructions associated with runtime operation(s) by processor(s) 930. In addition, RAM 924 may store real-time data captured during assembly of at least a portion of a vehicle such as a car or an aircraft, for example, as described with respect to one or more of FIGS. 5 through 8, above.

Processor(s) 930 may be implemented with one or more general-purpose and/or special-purpose processors. Examples of general-purpose and/or special-purpose processors may include microprocessors, microcontrollers, DSP processors, and/or any other suitable circuitry configured to execute instructions loaded from at least one of permanent storage device 922, RAM 924, and/or ROM 928. Alternatively or additionally, processor(s) 930 may be implemented as dedicated hardware, such as at least one field programmable gate array (FPGA), at least one programmable logic device (PLD), at least one controller, at least one state machine, a set of logic gates, at least one discrete hardware component, or any other suitable circuitry and/or combination thereof.

Interconnect 920 may further communicatively connect processing system 900 with one or more controller interface(s) 926. Controller interface(s) 926 may communicatively connect processing system 900 with various circuitry associated with one or more robots, for example, during assembly of at least a portion of a vehicle such as a car or an aircraft. Instructions executed by processor(s) 930 may cause instructions to be communicated with a robot through controller interface(s) 926, which may cause movement and/or other actions of the robot in association with assembly of at least a portion of a vehicle such as a car or an aircraft. For example, instructions executed by processor(s) 930 may cause signals to be sent through controller interface(s) 926 to circuitry and/or other machinery of a robot in order to direct movement and/or other actions of the robot in association with assembly of at least a portion of a vehicle such as a car or an aircraft.

In some embodiments, processing system 900 may include network component 932. Network component 932 may be configured to communicate over a network, for example, in order to transmit and/or receive instructions associated with assembly of at least a portion of a vehicle such as a car or an aircraft. Instructions communicated over a network through network component 932 may include instructions associated with assembly of at least a portion of a vehicle such as a car or an aircraft, and may be communicated before, during, and/or after assembly of at least a portion of a vehicle such as a car or an aircraft. Examples of a network through which network component 932 may communicate may include a local area network (LAN), a wide area network (WAN), the Internet, an intranet, or another wired or wireless network.

Various aspects described herein may be implemented at least partially as software processes of a computer-programming product. Such processes may be specified as a set of instructions recorded on a machine-readable storage medium. When a set of instructions is executed by processor(s) 930, the set of instructions may cause the processor(s) to perform operations indicated and recorded in the set of instructions.

FIGS. 10-29 provide and illustrate further details of apparatuses, components and methods that may be formed and assembled by the above example assembly systems and operations of FIGS. 2-9.

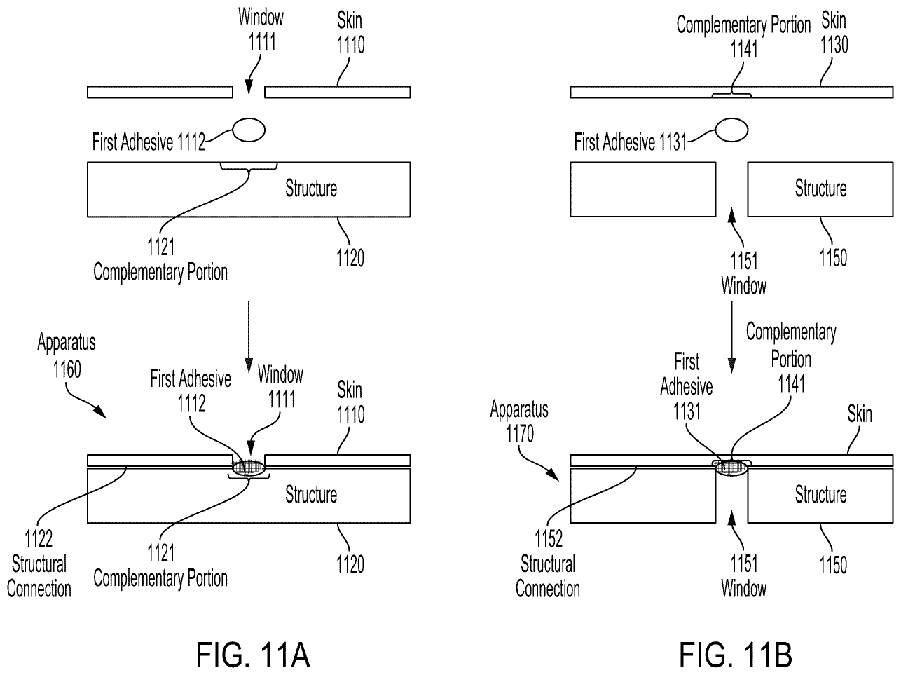

FIG. 10 illustrates an example exploded view of a skin (e.g., 1010) and components/structures (e.g., structures 1021,1022,1023) formed and assembled, for example by the example assembly systems and operations of FIGS. 2-9, where the components/structures form at least a portion of a frame (e.g., frame 1020). The skin and/or structures may be the skin and/or the structures provided in the below disclosure associated with at least FIGS. 11A through 29. Skin 1010 may cover and connect to at least a portion of the frame (e.g., an exterior surface of the frame). For example, frame 1020 may include complementary portion 1024 configured to be coupled/fixed/connected to window 1011 of the skin. An adhesive may be provided in the window and radiation may be applied to the adhesive the cure the adhesive and fix the skin to the complementary portion of the structure. For example, the complementary portion being associated with a first adhesive such as a quick cure adhesive and includes a region of the structure where the first adhesive fixes the skin to the structure.

The complementary portion may be a surface of the structure/frame including a flat or curved surface. Frame 1020 may be at least a portion of a vehicle, for example an aircraft or a car. In one embodiment, the entire exterior surface of the frame may be covered by and connect to the skin. For example, if the frame is a wing, a tail or a fuselage of an aircraft, the skin may cover and connect to the entire wing, tail or fuselage surface (i.e., outer surface) exposed to atmospheric airflow.

FIG. 11A illustrates an example in exploded and assembled views of a skin and a structure. The top illustration in FIG. 11A shows the various parts of an apparatus 1160 before a structural connection and an adhesive connection is made. The bottom illustration of FIG. 11A shows the various parts of the apparatus in an assembled form, which includes the structural connection and the adhesive connection. The apparatus may include a skin 1110 and a structure 1120. The skin may including a window 1111 and the structure may include a complementary portion 1121 corresponding to the window. In the top illustration, a first adhesive 1112 is applied between the skin and the structure and shows the complementary portion corresponding to the window (e.g., below the window) before the skin and/or the structure is moved toward the other. The bottom illustration shows when the skin and the structure are within a joining proximity and the first adhesive 1112 fixes the skin to the structure and a structural connection 1122 is made between the skin and the structure forming the apparatus. For example, the complementary portion being associated with the first adhesive includes a region of the structure where the first adhesive fixes the skin to the structure. Thus, apparatus 1160 may include the skin including the window, the structure including a complementary portion, a first adhesive between the skin and the structure and within at least a portion of the window fixing the skin and the structure, and structural connection 1122 between the skin and the structure. Radiation from a radiation source may be applied through the window to the first adhesive to cure the first adhesive and fix the skin to the structure. The first adhesive may be a quick-cure adhesive. The quick-cure adhesive may be cured via radiation. The quick-cure adhesive may be an adhesive cured by ultraviolet (UV) radiation (i.e., a quick-cure UV adhesive). The joining proximity can be a position that allows the skin to be joined to the structure. For example, a joining proximity may be a first surface of the skin having a distance ranging from about 0.05 mm to about 150 mm from a second surface of a structure. The structural connection may include or a combination of glueing, welding, brazing, riveting, screwing or fastening the skin to the structure. For example, the structural connection may include a structural adhesive between the skin and the structure and one or more rivets connecting the skin to the structure.

FIG. 11B illustrates an example in exploded and assembled views of a skin and a structure. The top illustration in FIG. 11B shows the various parts of an apparatus 1160 before a structural connection and an adhesive connection is made. The bottom illustration of FIG. 11B shows the various parts of the apparatus in an assembled form, which includes the structural connection and the adhesive connection. The apparatus may include a skin 1110 and a structure 1120. The skin may including a window 1111 and the structure may include a complementary portion 1121 corresponding to the window. In the top illustration, a first adhesive 1112 is applied between the skin and the structure and shows the complementary portion corresponding to the window (e.g., below the window) before the skin and/or the structure is moved toward the other. The bottom illustration shows when the skin and the structure are within a joining proximity and the first adhesive fixes the skin to the structure and a structural connection 1122 is made between the skin and the structure forming the apparatus. Thus, apparatus 1160 may include the skin including the window, the structure including a complementary portion, a first adhesive between the skin and the structure and within at least a portion of the window fixing the skin and the structure, and a structural connection 1122 between the skin and the structure. For example, the complementary portion being associated with the first adhesive includes a region of the structure where the first adhesive fixes the skin to the structure. Radiation from a radiation source may be applied through the window to the first adhesive to cure the first adhesive and fix the skin to the structure. The first adhesive may be a quick-cure adhesive. The quick-cure adhesive may be cured via radiation. The quick-cure adhesive may be an adhesive cured by ultraviolet (UV) radiation (i.e., a quick-cure UV adhesive). The joining proximity can be a position that allows the skin to be joined to the structure. For example, a joining proximity may be a first surface of the skin having a distance ranging from about 0.05 mm to about 150 mm from a second surface of a structure. The structural connection may include or a combination of glueing, welding, brazing, riveting, screwing or fastening the skin to the structure. For example, the structural connection may include a structural adhesive between the skin and the structure and one or more rivets connecting the skin to the structure.

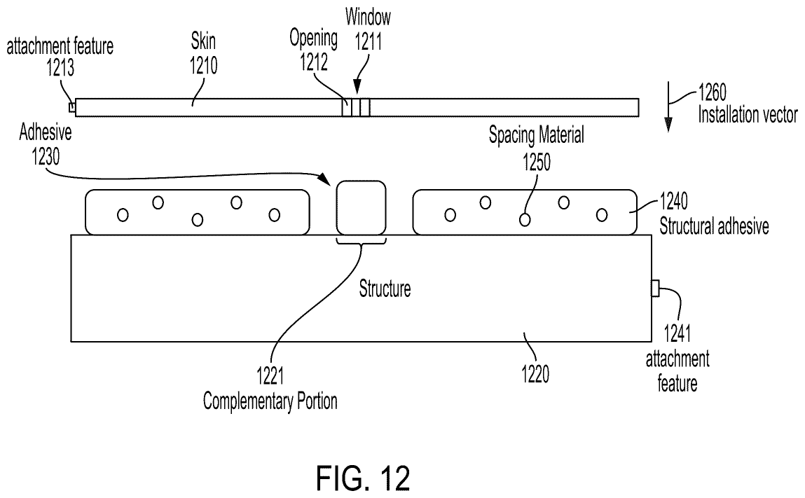

FIG. 12 illustrates an exploded view of an embodiment including a skin 1210, a structure 1220, an adhesive 1230 and an structural adhesive 1240. The skin may include window 1211 and attachment feature 1213. However, there may be more than one window in the skin. Window 1211 may include one or more openings 1212. Structure 1220 may include a complementary portion 1221 and an attachment feature 1241. The complementary portion may correspond to the window such that adhesive 1230 is between the window of the skin and the complementary portion of the structure. For example, the complementary portion being associated with the first adhesive includes a region of the structure where the first adhesive fixes the skin to the structure. Adhesive 1230 may be position between the skin and the structure. Adhesive 1230 may span (i.e., has a length and/or width that is at least equal to the respective length and/or width of the window) window 1211. Adhesive 1230 may be a quick-cure adhesive. A structural adhesive 1240 or other material such as a glue, a weld, a brazing material, rivets, screws or fasteners, etc. or a combination thereof may be position between the skin and the structure. Installation vector 1260 illustrated an example of skin 1210 moving by a robot of the robotic system (e.g., performed by any of the robots and assembly system examples illustrated and disclosed in FIGS. 6A-9) toward structure 1220 so the skin and structure may be connected together. However, a robot of the robotic system may move structure 1220 toward skin 1210 so the skin and structure may be connected together. In one embodiment, adhesive 1230 may be applied to a region of the skin. One or a combination of a structural adhesive, a glue, a weld, a brazing material, rivets, screws or fasteners, may be applied to a region of the structure. In one embodiment, adhesive 1230 may be applied to a region of the structure and structural adhesive 1240 may be applied a region of the skin. Optionally, a spacing material 1250 may be between the skin and the structure. The optional spacing material may be contained within adhesive 1230. Optional, a spacing material may be contained within structural adhesive 1240. Optional, a spacing material may be contained within both adhesive 1230 and structural adhesive 1240. The spacing material may be transparent.

FIG. 13 illustrates an assembled and joined view of an embodiment of an apparatus (i.e., apparatus 1300) including the skin 1210, the structure 1220, the adhesive 1230 and the structural adhesive 1240 or other material such as a glue, a weld, a brazing material, rivets, screws or fasteners, etc. or a combination thereof. The radiation source 1360 is configured to generate/produce the radiation 1361. The radiation may go through the window and be applied to the adhesive to cure or at least partially cure the adhesive such that the cured or at least partially cured adhesive fixes the skin to the structure. The radiation source may be various types of lamps, light emitting diodes (LED)'s or lasers. For example, the radiation source is positioned relative to the apparatus such that the radiation is able to go through one or more openings of the window and cure adhesive 1230. Adhesive 1230 may be a quick-cure adhesive. For example, the radiation source may be located above or to a side of the windows' opening such that the radiation passes through the one or more openings 1212 and is able to cure the adhesive. However, the radiation source may be positioned below the one or more openings when the radiation is capable of curing adhesive 1230. Radiation 1361 may be an electromagnetic radiation such as visible light (i.e., wavelengths of 400-750 nanometers) or ultraviolet (UV) radiation (i.e., wavelengths of 10-400 nanometers). In one embodiment, the adhesive 1230 and the structural adhesive 1240 are position between the skin and the structure. Adhesive 1230 may span (i.e., has a length and/or width that is at least equal to the respective length and/or width of the window) window the 1211. In one embodiment, the adhesive 1230 may be applied to a region of the skin and the structural adhesive may be applied to a region of the structure. In one embodiment, the adhesive 1230 may be applied to a region of the structure and the structural adhesive 1240 may be applied a region of the skin. A structural connection may include a structural adhesive or the structure adhesive connecting the skin to the structure. Optionally, the apparatus 1300 may include the spacing material 1350 between the skin and the structure to control a bond gap (e.g., bond gap 1341) between the skin and the structure. Optionally, the apparatus may be place in a heater such as an oven to cure the material such as a structural adhesive. Thus, the structural connection may include heating of the material. The structure and/or the skin of the apparatus may be made by 3D printing such as powder bed fusion (PBF) printing or made in any way known in the manufacturing art.

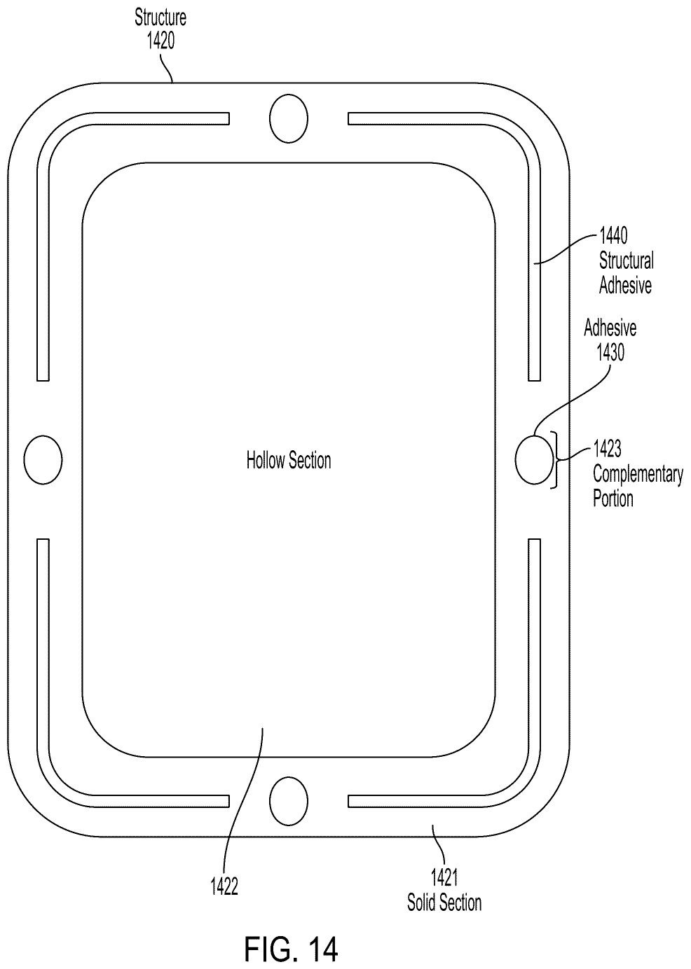

FIGS. 14 through 19 illustrate various skins and structures that may be used as the skin and structure of the apparatus illustrated in FIG. 13.

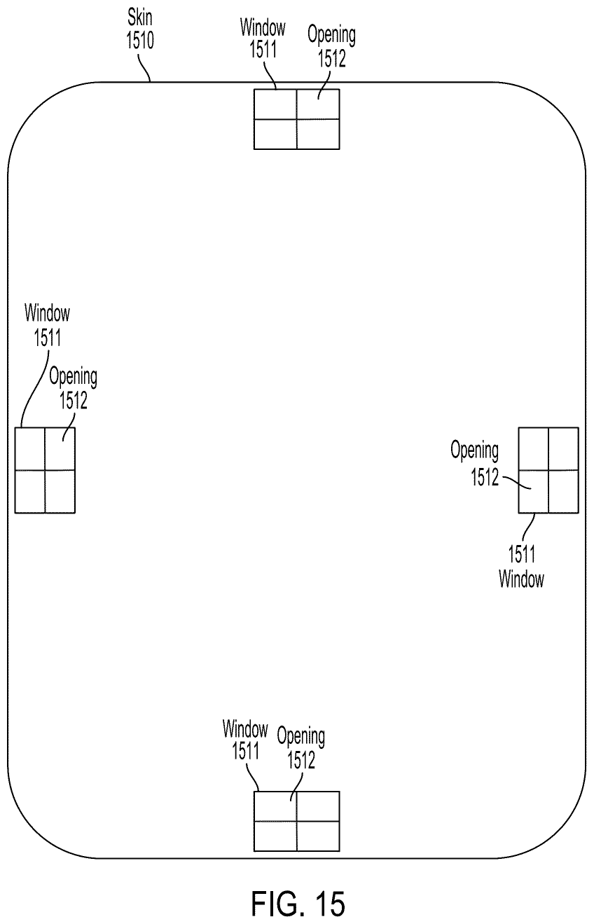

FIG. 14 illustrates a structure 1420, which may be the structure of the apparatus in FIG. 13. Structure 1420 may include a complementary portion 1423, a solid section 1421 and a hollow section 1422. An adhesive 1430 may be applied to a surface of the structure. However, the adhesive may be applied to a surface of a skin 1520, which is the skin that may connected to structure 1420 and explained below. The adhesive may be a quick-cure adhesive. A structural adhesive 1440 or a glue, a weld, a brazing material, rivets, screws or fasteners or a combination thereof, may be placed in regions of the structure. For example, the structural adhesive may be a continuous amount of material around at least a portion of the structure or may include a plurality of segments of material, where each segment of the structural adhesive is in a region of the structure. However, the structural adhesive may be applied to a surface of a skin (e.g., skin 1510), which may be connected to structure 1420 and shown and explained below with FIG. 15. Structure 1420 may be made by 3D printing such as powder bed fusion (PBF) printing or made in any way known in the manufacturing art.

FIG. 15 illustrates a corresponding skin 1510 to structure 1420, which includes skin 1510 is connected to structure 1420 and each window 1511 of the skin corresponds to the complementary portion of the structure. For example, skin 1510 may be the skin illustrated in FIG. 13 and structure 1420 may be the structure illustrated in FIG. 13, and form an apparatus similar to the apparatus of FIG. 13. Skin 1510 includes a plurality of windows 1511 and each window may include a plurality of openings 1512. FIG. 15 illustrates four windows however, more than four windows or less than four windows may be included within the skin. Each window in FIG. 15 illustrate four openings. However, a window may include more than four openings or less than four openings. For example, the skin may have three windows and each of the windows may be located in a region of the skin to perform a function and/or satisfy one or more design requirements. An example of the window performing a function may be to locate the window in a region of the skin to provide access for radiation to cure an adhesive (e.g., adhesive 1430). An example of a window satisfying one or more design requirements may be to provide teach window in a region of the skin to reduce airflow disturbance or provide efficient fixturing of the skin to the structure. The number of openings in each window may be the same or different. For example, if the skin includes six windows, each of the six windows may have four openings, or three windows may have four openings and the other three windows may have one, six or eight openings. The skin may be made by 3D printing such as powder bed fusion (PBF) printing or made in any way known in the manufacturing art. The skin may be comprised of an alloy, sheet metal, plastics, carbon fiber or a combination thereof.

For example, the skin may be comprised of an alloy such as a high temperature and/or high strength alloy (e.g., a nickel (Ni) or aluminum (Al) based alloy). However, the skin may be comprised of a combination of an alloy and a plastic such as a polymer. For example, the skin may be a unitary structure (i.e., a one piece structure) made entirely from metal such as an alloy or may be made entirely from a plastic. Another example may be the skin is made from connecting/joining a plurality of structures (i.e., skins) together and connected/joined by the example assembly systems and operations of FIGS. 2-9. Each of the joined/connected structures (i.e., skins), which form the skin, may be comprised of an alloy or a plastic or a combination of an alloy and a plastic. For example, if the skin is comprised of six structures joined together, two of the pieces may comprise a first alloy, another piece may comprise a second alloy, another two pieces may comprise a first plastic and the last piece may comprise a combination of a second plastic and a third alloy. Each of the first, second and third alloys may be different or the same and each of the first and second plastics may be different or the same.

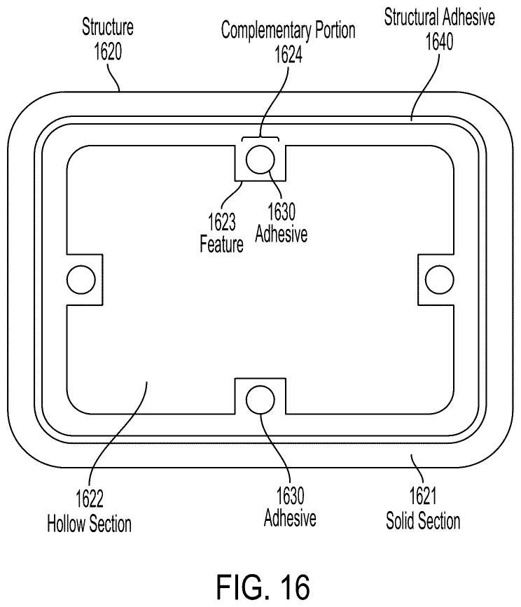

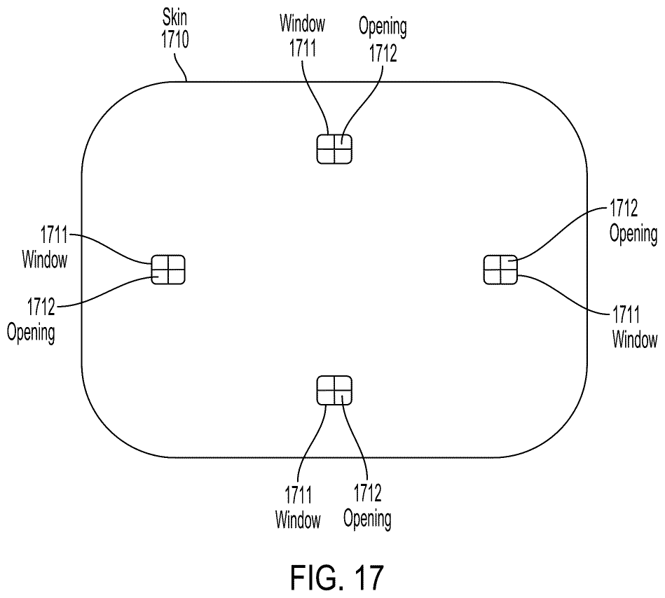

FIG. 16 illustrates a structure 1620, which may be the structure of the apparatus in FIG. 13. Structure 1620 may include a complementary portion 1624, a solid section 1621, a hollow section 1622 and a plurality of features 1623. FIG. 16 illustrates four features on an inner surface/side of the structure. However, more than four features or less than four features may be included with the structure. Each feature may be located in a region of the structure to perform a function and/or satisfy one or more design requirements. An adhesive 1630 may be placed in a plurality of regions such as in at least a portion of each of the features of the structure. However, the adhesive may not be in at least a portion of each of the features of the structure. For example, if the structure includes six features, the adhesive may be in at least a portion of three of the features such that the adhesive may be in the number of features of the structure such that the radiation from the radiation source (see FIG. 13) may cure the adhesive. A structural adhesive 1640 or a glue, a weld, a brazing material, rivets, screws or fasteners or a combination thereof, may be placed in regions of the structure. For example, the structural adhesive may be a continuous amount of material around at least a portion of the structure or may include a plurality of segments of material, where each segment of the structural adhesive is in a region of the structure. However, the structural adhesive may be applied to a surface of a skin (e.g., skin 1710), which may be connected to the structure and shown and explained below with FIG. 17. For example, each feature may be located in a region of the structure to provide access for radiation to cure an adhesive (e.g., adhesive 1630). An example of the features satisfying one or more design requirements may be to provide the features in a corresponding region of the structure to provide efficient fixturing of the skin to the structure. The features may be integral with the structure (i.e., the features and the structure form a single piece). For example, the structure may be 3D printed (e.g., powder bed fusion printed) such that the 3D printed structure includes the features. However, the features may be separate from the structure and joined/connected to the structure in any know joining method.

FIG. 17 illustrates a corresponding skin 1710 to structure 1620, which includes skin 1710 is connected to structure 1620 and each window 1711 of the skin corresponds to the feature of the structure. For example, skin 1710 may be the skin illustrated in FIG. 13 and structure 1620 may be the structure illustrated in FIG. 13, and form an apparatus similar to the apparatus of FIG. 13. Skin 1710 includes a plurality of windows 1711 and each window may include a plurality of openings 1712. FIG. 17 illustrates four windows however, more than four windows or less than four windows may be included within the skin. Each window in FIG. 17 illustrate four openings. However, a window may include more than four openings or less than four openings. For example, the skin may have three windows and each of the windows may be located in a region of the skin to perform a function and/or satisfy one or more design requirements. An example of the window performing a function may be to locate the window in a region of the skin to provide access for radiation to cure an adhesive (e.g., adhesive 1630). An example of a window satisfying one or more design requirements may be to provide each window in a region of the skin to reduce airflow disturbance or provide efficient fixturing of the skin to the structure. The number of openings in each window may be the same or different. For example, if the skin includes six windows, each of the six windows may have four openings, or three windows may have four openings and the other three windows may have one, six or eight openings. The skin may be made by 3D printing such as powder bed fusion (PBF) printing or made in any way known in the manufacturing art. The skin may be comprised of an alloy, sheet metal, plastics, carbon fiber or a combination thereof. For example, the skin may be comprised of an alloy such as a high temperature and/or high strength alloy (e.g., a nickel (Ni) or aluminum (Al) based alloy). However, the skin may be comprised of a combination of an alloy and a plastic such as a polymer. For example, the skin may be a unitary structure (i.e., a one piece structure) made entirely from metal such as an alloy or may be made entirely from a plastic. Another example may be the skin is made from connecting/joining a plurality of structures (i.e., skins) together and connected/joined by the example assembly systems and operations of FIGS. 2-9. Each of the joined/connected structures (i.e., skins), which form the skin, may be comprised of an alloy or a plastic or a combination of an alloy and a plastic. For example, if the skin is comprised of six structures joined together, two of the pieces may comprise a first alloy, another piece may comprise a second alloy, another two pieces may comprise a first plastic and the last piece may comprise a combination of a second plastic and a third alloy. Each of the first, second and third alloys may be different or the same and each of the first and second plastics may be different or the same.

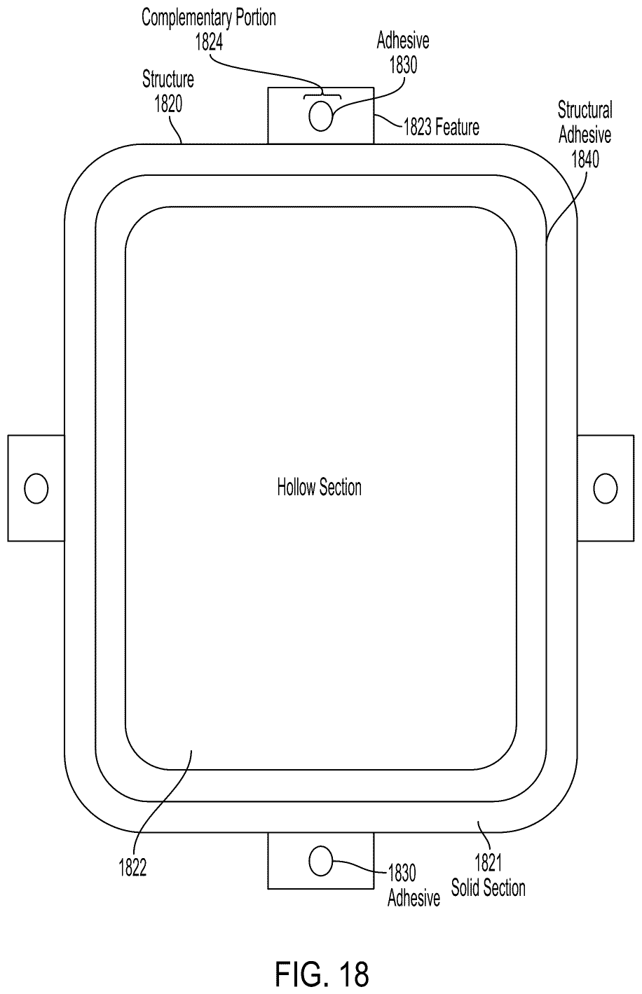

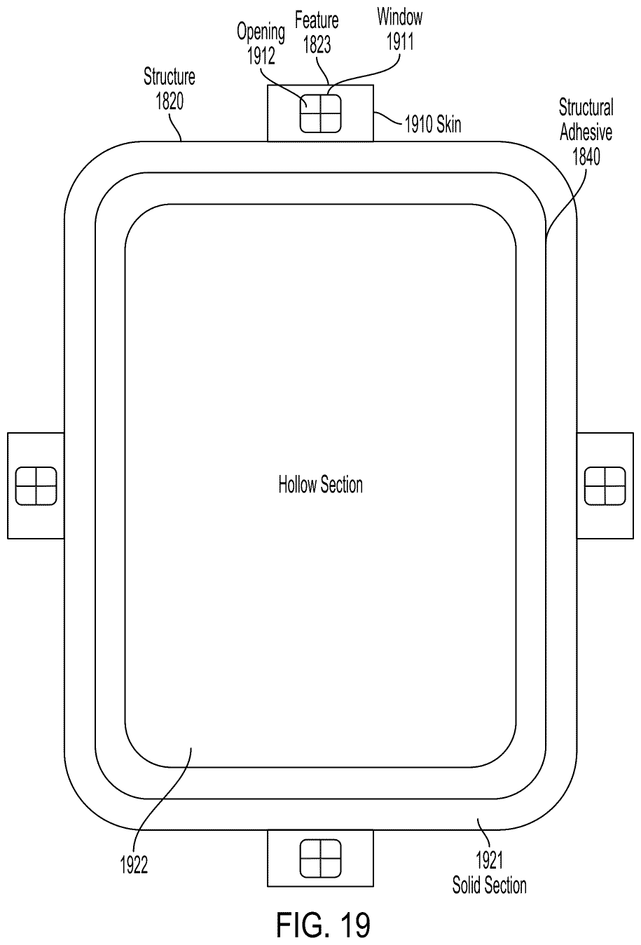

FIG. 18 illustrates a structure 1820, which may be the structure of the apparatus in FIG. 13. Structure 1820 may include a complementary portion 1824, a solid section 1821, a hollow section 1822 and a plurality of features 1823. FIG. 18 illustrates four features on an outer surface/side of the structure. However, more than four features or less than four features may be included with the structure. Each feature may be located in a region of the structure to perform a function and/or satisfy one or more design requirements. An adhesive 1830 may be placed in a plurality of regions such as in at least a portion of each of the features of the structure. However, the adhesive may not be in at least a portion of each of the features of the structure. For example, if the structure includes six features, the adhesive may be in at least a portion of three of the features such that the adhesive may be in the number of features of the structure such that the radiation from the radiation source (see FIG. 13) may cure the adhesive. A structural adhesive 1840 or a glue, a weld, a brazing material, rivets, screws or fasteners or a combination thereof, may be placed in regions of the structure. For example, the structural adhesive may be a continuous amount of material around at least a portion of the structure or may include a plurality of segments of material, where each segment of the structural adhesive is in a region of the structure. However, the structural adhesive may be applied to a surface of a skin which may be connected to the structure and shown and explained below with FIG. 19. For example, each feature may be located in a region of the structure to provide access for radiation to cure an adhesive (e.g., adhesive 1830). An example of the features satisfying one or more design requirements may be to provide the features in a corresponding region of the structure to provide efficient fixturing of the skin to the structure. The features may be integral with the structure (i.e., the features and the structure form a single piece). For example, the structure may be 3D printed (e.g., powder bed fusion printed) such that the 3D printed structure includes the features. However, the features may be separate from the structure and joined/connected to the structure in any know joining method.

FIG. 19 illustrates a corresponding skin 1910 connected to the structure (i.e., structure 1820) and each window 1911 of the skin corresponds to the feature of the structure. For example, skin 1910 may be the skin illustrated in FIG. 13 and structure 1820 may be the structure illustrated in FIG. 13, and form an apparatus similar to the apparatus of FIG. 13. Skin 1910 includes a plurality of windows 1911 and each window may include a plurality of openings 1912. FIG. 19 illustrates four windows however, more than four windows or less than four windows may be included within the skin. Each window in FIG. 19 illustrate four openings. However, a window may include more than four openings or less than four openings. For example, the skin may have three windows and each of the windows may be located in a region of the skin to perform a function and/or satisfy one or more design requirements. An example of the window performing a function may be to locate the window in a region of the skin to provide access for radiation to cure an adhesive (e.g., adhesive 1830). An example of a window satisfying one or more design requirements may be to provide each window in a region of the skin to reduce airflow disturbance or provide efficient fixturing of the skin to the structure. The number of openings in each window may be the same or different. For example, if the skin includes six windows, each of the six windows may have four openings, or three windows may have four openings and the other three windows may have one, six or eight openings. The skin may be made by 3D printing such as powder bed fusion (PBF) printing or made in any way known in the manufacturing art. The skin may be comprised of an alloy, sheet metal, plastics, carbon fiber or a combination thereof. For example, the skin may be comprised of an alloy such as a high temperature and/or high strength alloy (e.g., a nickel (Ni) or aluminum (Al) based alloy). However, the skin may be comprised of a combination of an alloy and a plastic such as a polymer. For example, the skin may be a unitary structure (i.e., a one piece structure) made entirely from metal such as an alloy or may be made entirely from a plastic. Another example may be the skin is made from connecting/joining a plurality of structures (i.e., skins) together and connected/joined by the example assembly systems and operations of FIGS. 2-9. Each of the joined/connected structures (i.e., skins), which form the skin, may be comprised of an alloy or a plastic or a combination of an alloy and a plastic. For example, if the skin is comprised of six structures joined together, two of the pieces may comprise a first alloy, another piece may comprise a second alloy, another two pieces may comprise a first plastic and the last piece may comprise a combination of a second plastic and a third alloy. Each of the first, second and third alloys may be different or the same and each of the first and second plastics may be different or the same.

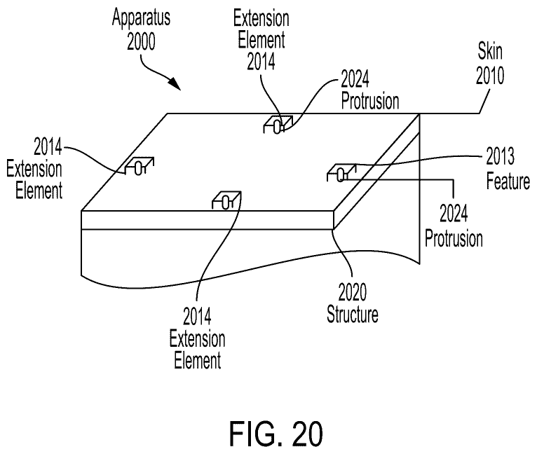

FIGS. 20 through 23 illustrate an embodiment of an apparatus (e.g., apparatus 2000) including a skin and a structure.

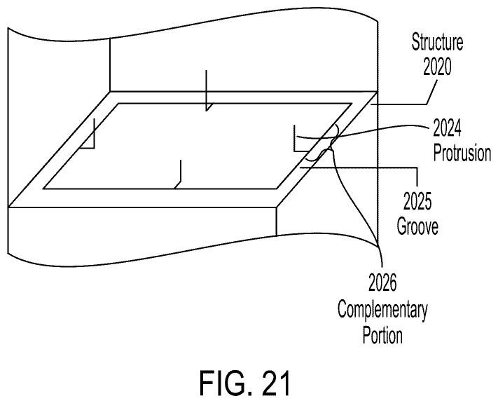

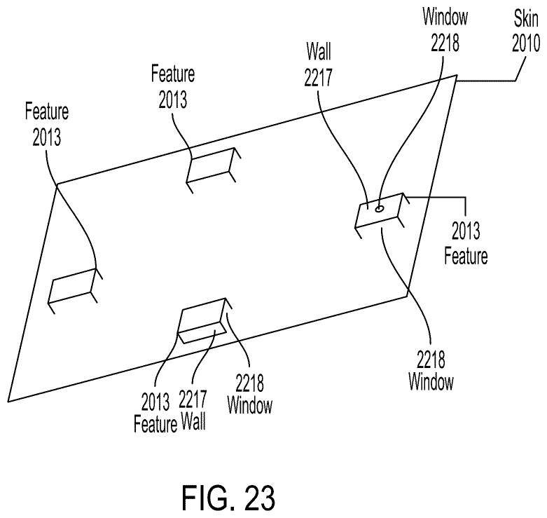

FIG. 20 illustrates an assembled and joined view of the embodiment of the apparatus including a skin 2010 and a structure 2020. Skin 2010 includes a plurality of features 2013 configured to an contain an adhesive such as a quick-cure adhesive. The features include a plurality of extension elements 2014. FIG. 20 illustrates four features however, more than four features or less than four features may be included within the skin. FIG. 20 also illustrates each feature includes two or three extension elements. However, more than two extension elements or less than two extension elements may be included with each of the features. The extension elements 2014 offset features 2013 from the surface of the skin and the elements may include legs. More details of the features will be disclosed below in FIG. 23. Structure 2020 includes a plurality of protrusions 2024 configured to connect with a corresponding feature 2013 through the adhesive (e.g., quick-cure adhesive) to fix the skin to the structure once the adhesive is cured with radiation as will be explained below. FIG. 20 illustrates four protrusions and each protrusion being associated with a corresponding feature 2013. However, more than four protrusions or less than four protrusions may be included within the structure. More details of the skin and the structure of and assembling of the apparatus 2000 are provided and illustrated in FIGS. 21 through 23.

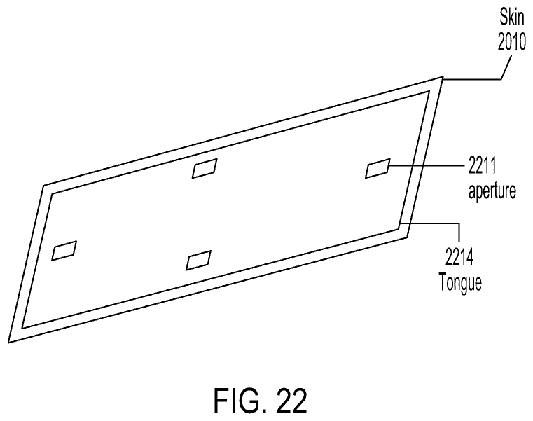

FIG. 21 illustrates more details of structure 2020 and the orientation of the structure such that the plurality of protrusions extend within the features as shown in FIG. 20. Structure 2020 includes a complementary portion 2026, a groove 2025 and the plurality of protrusions (i.e., protrusions 2024). The complementary portion may be a surface of the structure such as a flat or curved surface associated with the adhesive within the feature. For example, the complementary portion being associated with the adhesive may include a region of the structure where the first adhesive fixes the skin to the structure. The complementary portion may include each protrusion 2024. Groove 2025 may be a single groove or a plurality of grooves. The groove(s) may contain a structural adhesive or a glue, a weld, a brazing material, rivets, screws or fasteners or a combination thereof. A recess may be any one of the grooves. The groove of the structure is configured to contain at least a portion of a tongue of the skin as shown in FIG. 22.

FIG. 22 illustrates more details of skin 2010 and the orientation of the skin such that protrusions 2024 of the structure extend through apertures 2211 of the skin and within the features as shown in FIG. 20. FIG. 22 illustrates skin 2110 including a plurality of apertures 2111 configured to have protrusions 2024 pass therethrough and a tongue 2214 configured to extend into groove 2025. Each aperture 2111 may include one or more openings, similar to the openings of the windows. The tongue may be a single tongue or a plurality of separated tongues. The tongue(s) may be a protrusion. The tongue of the skin is configured to be connected with the material such as a structural adhesive, a glue, a weld, a brazing material, rivets, screws or fasteners or a combination thereof within the groove of the structure to form a structural connection.

FIG. 23 illustrates skin 2010 including plurality of the features 2013 configured to contain the adhesive such as a quick quire adhesive. The features may include a plurality of windows 2218 and walls 2217. One wall may include a window therein such that the radiation may pass therethrough and configured to cure the adhesive within the feature. Also, a protrusion 2024 may penetrate through a corresponding window. Each feature may include two or more windows and each wall may include two or more windows. Now that the elements of the skin and structure have been illustrated and described in the embodiment of FIGS. 20 through 23, a description of the joining process will be described showing the formation of the apparatus of FIG. 23. The apparatus is joined and formed by moving the skin and/or the structure by a robot of the robotic system such that the skin and structure are in joining proximity of one another. For example, a joining proximity may be a first surface of the skin having a distance ranging from about 0.05 mm to about 150 mm from a second surface of a structure. At the joining proximity, the protrusions 2024 of the structure 2020 are inserted through the apertures 2211 of the skin 2010 and within at least of portion of the adhesive (e.g., a quick cured adhesive) contain within the features 2013 of the skin and at least a portion of the tongue 2214 of the skin is inserted into the material (e.g., a structural adhesive, a glue, a weld, a brazing material, rivets, screws or fasteners or a combination thereof) within the groove 2025. Radiation from a radiation source enters/passes through the one or more windows of the features to at least partially cure the adhesive to fix the skin to the structure. The tongue within the material within the groove 2025 forms the structural connection. The apparatus may be place in a heater such as an oven to cure the material within the groove. Thus, the structural connection may include the material or heating of the material within the groove. The process of forming the apparatus may be formed and assembled by the above example assembly systems and operations of FIGS. 2-9. An example of the process is a robot of the robotic system applies a first adhesive within one or more features of the skin and the first robot or a second robot of the robotic system applies a second adhesive within the groove of the structure. By the skin or the structure moved by a robot, each protrusion 2024 of the structure is inserted through corresponding aperture 2211 and within corresponding feature 2013 of the skin such that each protrusion of the structure contacts the first adhesive within the feature, fixing the skin to the structure when the first adhesive is cured or at least partially cured by the radiation applied thereto by a tool of a robot, and the tongue of the skin is inserted into at least a portion of the second adhesive contained within a portion of the groove to form a structural connection between the skin and the structure. One example of the embodiment of the apparatus is having the skin cover and connect to at least a portion of an outer surface of the structure, which may be a single formed structure or a plurality of components formed, assembled and joined together by the above example assembly systems and operations of FIGS. 2-9. Also, the skin may be a single formed structure or a plurality of components formed, assembled and joined together by the above example assembly systems and operations of FIGS. 2-9. In this one example, one or more features may be formed on an outer surface of the skin and optionally, the one or more features may be removed (i.e., cut off or removed by other methods) in an automatic manner (e.g., by a tool of a robot cutting off the feature) or manually (e.g., by a tool operated by an individual). Because, as explained above, a corresponding protrusion is within a corresponding feature, the optional removal of each feature may include removal of the corresponding protrusion (i.e., the protrusion within the feature). Further, in the one example, one or more apertures may be filled with a material such as an alloy, a plastic or a combination thereof so the surface of the skin is devoid of openings exposed to an exterior environment. For example, if the skin is on the exterior structure of a wing or a fuselage of an aircraft, atmospheric airflow over the skinned wing or fuselage will not flow through the skin. The composition of the first adhesive, or the quick-cure adhesive or the adhesive within the feature of the skin and/or the structure may be the same as or different from the composition of the second adhesive or the structural adhesive. The first adhesive, or the quick-cure adhesive or the adhesive within the feature of the skin and/or the structure may have a composition of a back-bone chemistry and a cure chemistry. The back-bone chemistry may include polyurethane, silicone, aliphatic, aromatic, polyether, polyester, polyurea, polyacrylate, polyamide, etc. and the cure chemistry may include acrylates (e.g., an ethyl or methyl acrylate), isocyanate reactions, hydrosilylation, thiolene, etc. For example, the first adhesive, or the quick-cure adhesive or the adhesive within the feature of the skin and/or the structure may include an polyurethane and an acrylate. Another example of the first adhesive, or the quick-cure adhesive or the adhesive within the feature of the skin and/or the structure may include a polyamide and an acrylate. The cure mechanism of the first adhesive, or the quick-cure adhesive or the adhesive within the feature of the skin and/or the structure may be electromagnetic radiation such as visible light (i.e., wavelengths of 400-750 nanometers) or ultraviolet (UV) radiation (i.e., wavelengths of 10-400 nanometers). The second adhesive or the structural adhesive may have a composition including a back-bone chemistry and a cure chemistry. The back-bone chemistry may include polyurethane, silicone, aliphatic, aromatic, polyether, polyester, polyurea, polyacrylate, polyamide, etc. and the cure chemistry may include acrylate, epoxy, silane, hydrosilylation, isocyanate, methacrylate, thiolene, etc. For example, the second adhesive or the structural adhesive may include an polyurethane and an acrylate. Another example of the second adhesive or the structural adhesive may include silicone and an epoxy. The cure mechanism of the second adhesive or the structural adhesive may include light, heat (including room temperature), moisture, or combinations thereof.

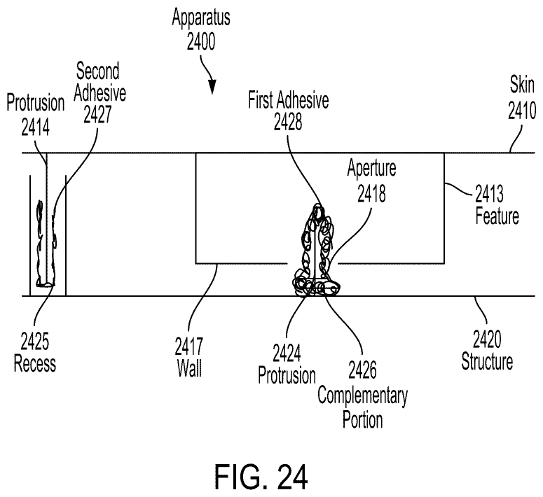

FIG. 24 illustrates an front view of an assembled and joined view of an embodiment of an apparatus 2400 including a skin 2410 joined to a structure 2420. The skin may include a feature 2413 formed on an inner surface of the skin and configured to an contain an adhesive 2428 such as a quick-cure adhesive. The feature may include a wall 2417 and an aperture 2418. The structure may include a complementary portion 2426 and a protrusion 2424 configured to pass through aperture 2418 and contact adhesive 2428 fixing the skin to the structure when radiation is applied through a window or the aperture of the feature. The window may be the window of the feature illustrated in FIG. 20. The complementary portion may be a surface of the structure such as a flat or curved surface associated with the first adhesive. For example, the complementary portion being associated with the first adhesive may include a region of the structure where the first adhesive fixes the skin to the structure. The skin may include protrusion 2414 configured to be inserted into at least a portion of a second adhesive 2427 within a recess 2425 of the structure forming a structural connection. In FIG. 24, the skin shows one feature 2413 and one protrusion 2414 and the structure shows one protrusion 2424 and one recess 2425. However, the skin may include a plurality of features and a plurality of protrusions. The structure may include a plurality of protrusions inserted into the corresponding plurality of features of the skin and a plurality of recesses into which the corresponding plurality of protrusions of the skin is inserted therein. Alternatively or in addition, the skin may include a plurality of recesses and the structure includes a plurality of protrusions such that corresponding protrusions of the plurality of protrusions of the structure are inserted into corresponding recesses of the skin. Alternatively or in addition, the structural connection may include a glue, a weld, a brazing material, rivets, screws or fasteners or a combination thereof connecting the skin to the structure. The assembled and joined apparatus may be formed by the example assembly systems and operations of FIGS. 2-9. For example, a first robot of the robotic system applies a first adhesive within the feature of the skin and the first robot or a second robot of the robotic system applies a second adhesive within the recess of the structure. The protrusion of the structure is inserted within the feature of the skin such that the protrusion of the structure contacts the first adhesive within the feature, fixing the skin to the structure when the first adhesive is cured or at least partially cured radiation applied through the window or aperture by a tool of a robot, and the protrusion of the skin is inserted into at least a portion of the recess of the structure to contact the second adhesive to form a structural connection between the skin and the structure. Alternatively or in addition, the structure may have the protrusion that is inserted into at least a portion of the recess of the skin to contact the second adhesive applied within the recess to form the structural connection between the skin and the structure. One example the embodiment of the apparatus is having the skin cover and connect to at least a portion of an outer surface of the structure, which may be a single formed structure or a plurality of components formed, assembled and joined together by the above example assembly systems and operations of FIGS. 2-9. Also, the skin may be a single formed structure or a plurality of components formed, assembled and joined together by the above example assembly systems and operations of FIGS. 2-9. The skin may be on the exterior structure of a wing or a fuselage of an aircraft. The composition of the first adhesive may be the same as or different from the composition of the second adhesive.

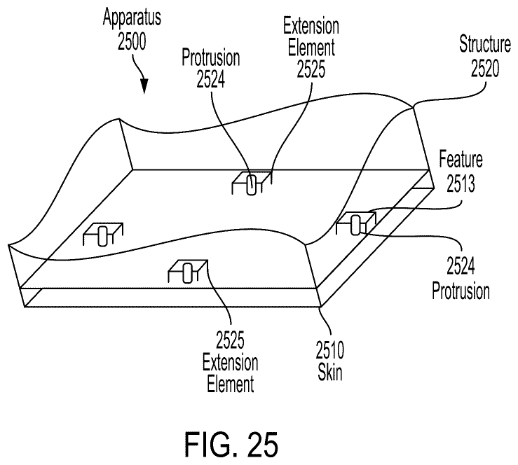

FIGS. 25 through 28 illustrate an embodiment of an apparatus 2500 including a skin and a structure.

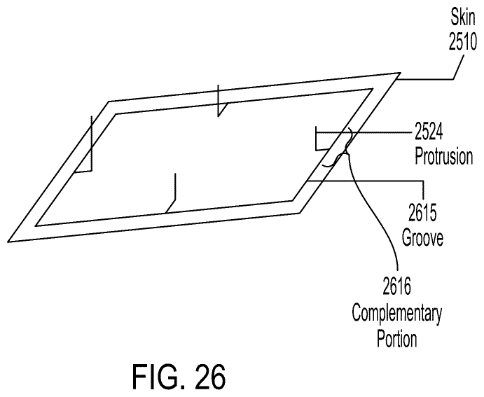

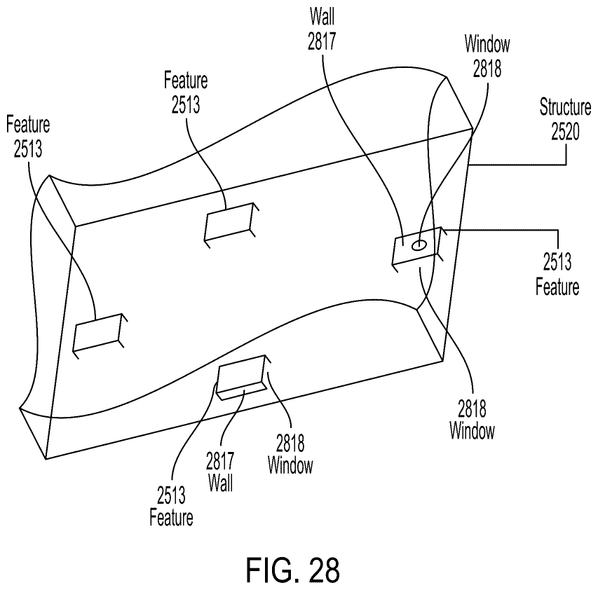

FIG. 25 illustrates an assembled and joined view of the embodiment of the apparatus including a skin 2510 and a structure 2520. Structure 2520 includes a plurality of features 2513 configured to an contain an adhesive such as a quick-cure adhesive. The features include a plurality of extension elements 2525. FIG. 25 illustrates four features however, more than four features or less than four features may be included within the structure. FIG. 25 also illustrates each feature includes two or three extension elements. However, more than two extension elements or less than two extension elements may be included with each of the features. The extension elements 2525 offset features 2513 from the surface of the skin and the elements may include legs. More details of the features will be disclosed below in FIG. 28. Skin 2510 includes a plurality of protrusions 2524 configured to connect with a corresponding feature 2513 through the adhesive (e.g., quick-cure adhesive) to fix the skin to the structure once the adhesive is cured with radiation as will be explained below. FIG. 25 illustrates four protrusions and each protrusion being associated with a corresponding feature 2513. However, more than four protrusions or less than four protrusions may be included within the structure. More details of the skin and the structure of and assembling of the apparatus 2500 are provided and illustrated in FIGS. 26 through 28.

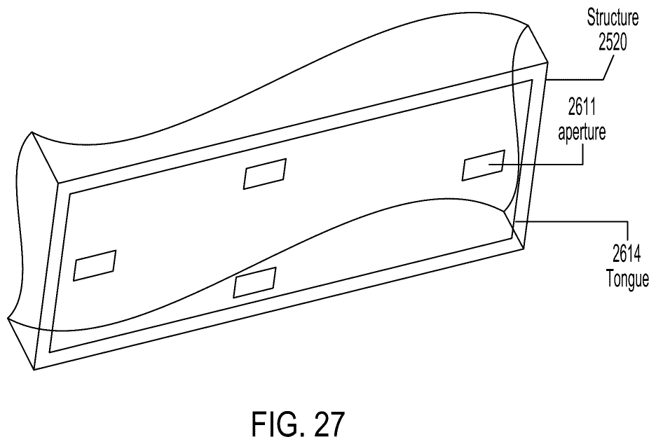

FIG. 26 illustrates more details of skin 2510 and the orientation of the skin such that the plurality of protrusions extend within the features as shown in FIG. 25. Skin 2510 includes a complementary portion 2616, a groove 2615 and the plurality of protrusions (i.e., protrusions 2524). The complementary portion may be a surface of the structure such as a flat or curved surface associated with the adhesive within the feature. For example, the complementary portion being associated with the adhesive configured to be within the feature of the structure and may include a region of the structure where the adhesive fixes the skin to the structure. The complementary portion may include each protrusion 2524. Groove 2615 may be a single groove or a plurality of grooves. The groove(s) may contain a structural adhesive or a glue, a weld, a brazing material, rivets, screws or fasteners or a combination thereof. A recess may be any one of the grooves. The groove of the skin is configured to contain at least a portion of a tongue of the structure as shown in FIG. 27. The protrusions 2524 of the skin extend through apertures 2611 of the structure (see FIG. 27) and within the features as shown in FIG. 25.

FIG. 27 illustrates structure 2520 including a plurality of apertures 2611 configured to have protrusions 2524 of the skin pass therethrough and a tongue 2614 configured to extend into groove 2615 of the skin. Each aperture 2611 may include one or more openings, similar to the openings of the windows. The tongue may be a single tongue or a plurality of separated tongues. The tongue(s) may be a protrusion. The tongue of the structure is configured to be connected with the material such as a structural adhesive, a glue, a weld, a brazing material, rivets, screws or fasteners or a combination thereof within the groove of the skin to form a structural connection.

FIG. 28 illustrates structure 2520 including plurality of the features 2513 configured to contain the adhesive such as a quick quire adhesive. The features may include a plurality of windows 2818 and walls 2817. One wall may include a window therein such that the radiation may pass therethrough and configured to cure the adhesive within the feature. Also, protrusion 2524 may penetrate through a corresponding window. Each feature may include two or more windows and each wall may include two or more windows. Now that the elements of the skin and structure have been illustrated and described in the embodiment of FIGS. 25 through 28, a description of the joining process will be described showing the formation of the apparatus of FIG. 25. The apparatus is joined and formed by moving the skin and/or the structure by a robot of the robotic system such that the skin and structure are in joining proximity of one another. For example, a joining proximity may be a first surface of the skin having a distance ranging from about 0.05 mm to about 150 mm from a second surface of a structure. At the joining proximity, the protrusions 2524 of the skin 2520 are inserted through the apertures 2611 of the structure 2520 and within at least of portion of the adhesive (e.g., a quick cured adhesive) contain within the features 2513 of the skin and at least a portion of the tongue 2614 of the structure is inserted into the material (e.g., a structural adhesive, a glue, a weld, a brazing material, rivets, screws or fasteners or a combination thereof) within the groove 2615. Radiation from a radiation source enters/passes through the one or more windows of the features to at least partially cure the adhesive to fix the skin to the structure. The tongue within the material within the groove forms the structural connection. The apparatus may be place in a heater such as an oven to cure the material within the groove. Thus, the structural connection may include the material or heating of the material within the groove. The process of forming the apparatus may be formed and assembled by the above example assembly systems and operations of FIGS. 2-9. An example of the process is a robot of the robotic system applies a first adhesive within one or more features of the structure and the first robot or a second robot of the robotic system applies a second adhesive within the groove of the skin. By the skin or the structure moved by a robot, each protrusion 2524 of the skin is inserted through corresponding aperture 2611 and within corresponding feature 2513 of the structure such that each protrusion of the skin contacts the first adhesive within the feature, fixing the skin to the structure when the first adhesive is cured or at least partially cured by the radiation applied thereto by a tool of a robot, and the tongue of the structure is inserted into at least a portion of the second adhesive contained within a portion of the groove to form a structural connection between the skin and the structure. One example of the embodiment of the apparatus is having the skin cover and connect to at least a portion of an outer surface of the structure, which may be a single formed structure or a plurality of components formed, assembled and joined together by the above example assembly systems and operations of FIGS. 2-9. Also, the skin may be a single formed structure or a plurality of components formed, assembled and joined together by the above example assembly systems and operations of FIGS. 2-0. In this one example, the features may be formed on a surface of the structure and optionally, the features may be removed (i.e., cut off or removed by other methods) in an automatic manner (e.g., by a tool of a robot cutting off the feature) or manually (e.g., by a tool operated by an individual). Because, as explained above, a corresponding protrusion is within a corresponding feature, the optional removal of each feature may include removal of the corresponding protrusion (i.e., the protrusion within the feature). Further, in the one example, apertures 2611 may be filled with a material such as an alloy, a plastic or a combination thereof so the surface of the structure is devoid of openings exposed to an exterior environment. The composition of the first adhesive, or the quick-cure adhesive or the adhesive within the feature of the skin and/or the structure may be the same as or different from the composition of the second adhesive or the structural adhesive. The first adhesive, or the quick-cure adhesive or the adhesive within the feature of the skin and/or the structure may have a composition of a back-bone chemistry and a cure chemistry. The back-bone chemistry may include polyurethane, silicone, aliphatic, aromatic, polyether, polyester, polyurea, polyacrylate, polyamide, etc. and the cure chemistry may include acrylates (e.g., an ethyl or methyl acrylate), isocyanate reactions, hydrosilylation, thiolene, etc. For example, the first adhesive, or the quick-cure adhesive or the adhesive within the feature of the skin and/or the structure may include an polyurethane and an acrylate. Another example of the first adhesive, or the quick-cure adhesive or the adhesive within the feature of the structure and/or the structure may include a polyamide and an acrylate. The cure mechanism of the first adhesive, or the quick-cure adhesive or the adhesive within the feature of the skin and/or the structure may be electromagnetic radiation such as visible light (i.e., wavelengths of 400-750 nanometers) or ultraviolet (UV) radiation (i.e., wavelengths of 10-400 nanometers). The second adhesive or the structural adhesive may have a composition including a back-bone chemistry and a cure chemistry. The back-bone chemistry may include polyurethane, silicone, aliphatic, aromatic, polyether, polyester, polyurea, polyacrylate, polyamide, etc. and the cure chemistry may include acrylate, epoxy, silane, hydrosilylation, isocyanate, methacrylate, thiolene, etc. For example, the second adhesive or the structural adhesive may include an polyurethane and an acrylate. Another example of the second adhesive or the structural adhesive may include silicone and an epoxy. The cure mechanism of the second adhesive or the structural adhesive may include light, heat (including room temperature), moisture, or combinations thereof.

FIG. 29 illustrates an front view of an assembled and joined view of an embodiment of an apparatus 2900 including a skin 2910 joined to a structure 2920. Structure 2920 may include a feature 2923 formed on an inner surface of the structure and configured to an contain an adhesive 2938 such as a quick-cure adhesive. The feature may include a wall 2927 and an aperture 2928. Skin 2910 may include a complementary portion 2936 and a protrusion 2914 configured to pass through aperture 2928 and contact adhesive 2938 fixing the skin to the structure when radiation is applied through a window or the aperture of the feature. The window may be the window of the feature illustrated in FIG. 20. The complementary portion may be a surface of the skin such as a flat or curved surface associated with the first adhesive. For example, the complementary portion being associated with the first adhesive may include a region of the skin where the first adhesive fixes the skin to the structure. The structure may include protrusion 2924 configured to be inserted into at least a portion of a second adhesive 2929 within a recess 2919 of the skin forming a structural connection. In FIG. 29, the structure shows one feature 2923 and one protrusion 2924 and the skin shows one protrusion 2914 and one recess 29195. However, the structure may include a plurality of features and a plurality of protrusions. The skin may include a plurality of protrusions inserted into the corresponding plurality of features of the structure and a plurality of recesses into which the corresponding plurality of protrusions of the structure is inserted therein. Alternatively or in addition, the skin may include a plurality of recesses and the structure includes a plurality of protrusions such that corresponding protrusions of the plurality of protrusions of the structure are inserted into corresponding recesses of the skin. Alternatively or in addition, the structural connection may include a glue, a weld, a brazing material, rivets, screws or fasteners or a combination thereof connecting the skin to the structure. The assembled and joined apparatus may be formed by the example assembly systems and operations of FIGS. 2-9. For example, a first robot of the robotic system applies a first adhesive within the feature of the structure and the first robot or a second robot of the robotic system applies a second adhesive within the recess of the skin. The protrusion of the skin is inserted within the feature of the structure such that the protrusion of the skin contacts the first adhesive within the feature, fixing the skin to the structure when the first adhesive is cured or at least partially cured radiation applied through the window or aperture by a tool of a robot, and the protrusion of the structure is inserted into at least a portion of the recess of the skin to contact the second adhesive to form a structural connection between the skin and the structure. Alternatively or in addition, the skin may have a protrusion 2914 that is inserted into at least a portion of a recess 2925 of the structure to contact the second adhesive applied within the recess to form the structural connection between the skin and the structure. One example the embodiment of the apparatus is having the skin cover and connect to at least a portion of an outer surface of the structure, which may be a single formed structure or a plurality of components formed, assembled and joined together by the above example assembly systems and operations of FIGS. 2-9. Also, the skin may be a single formed structure or a plurality of components formed, assembled and joined together by the above example assembly systems and operations of FIGS. 2-9. The skin may be on the exterior structure of a wing or a fuselage of an aircraft. The composition of the first adhesive may be the same as or different from the composition of the second adhesive.

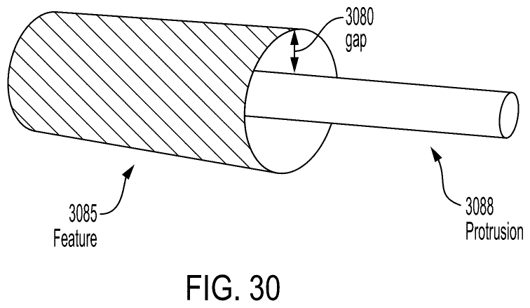

FIG. 30 illustrates an example of a spacing/gap (e.g., gap 3080) between features of components that are configured to be joined together such that components do not contact one another at the joined surfaces of the components. For example, feature 3085 may be a portion/section/segment of the skin or the structure of any of the disclosed embodiments and protrusion 3088 may be a portion/section/segment of the skin or the structure of any of the disclosed embodiments. For example, the skin may include feature 3085 and the structure may include protrusion 3088. An adhesive such as a quick-cure adhesive may be applied within the gap such that the adhesive fixes or connects feature 3085 of the skin or the structure with protrusion 3088 of the skin or the structure such that surfaces of the skin and structure do not contact (e.g., do not directly contact). The components, feature and protrusion may be joined together and formed by the example assembly systems and operations of FIGS. 2-9. Gap 3080 (and gap 1341 in FIG. 13) may maintain galvanic isolation between the components (e.g., a skin and a structure) being joined whilst retaining the assembled position of the components during the assembly process. In an embodiment, controlling the movement of one or more of the components (e.g., a skin and/or a structure) relative to one another such that they may be able to be joined together (i.e., be in joining proximity) and controlling/maintaining a gap (e.g., gap 3080,1341) between the skin and the structure are disclosed below and may be performed by the example assembly systems and operations of FIGS. 2-9. Controlling the movement of the components and/or controlling/maintaining a gap between the skin and the structure may include using spacing material and/or a sensor and/or a visual device/system and/or force feedback. A visual device/system and/or a sensor and/or force feedback may include metrology system 531 of FIG. 5, or other sensor, feedback and visual devices/systems, which may include a tracker-machine control sensor (T-MAC), a laser metrology device (e.g., configured for laser scanning and/or tracking), a photogrammetry device, a camera (e.g., configured to capture still images and/or video), and/or another device configured to obtain information and/or data and make decisions based on the information and/or data. One example of controlling the movement of the skin and/or the structure and/or controlling/maintaining a gap between the skin and the structure may include a tool of a robot of the robotic system applying an adhesive between the skin and the structure or designing the shape and size of the feature configured to contain an adhesive and applying/placing an adhesive within the feature by a tool of a robot of the robotic system at a location and/or in a desired volume for mating/joining/connecting of the components (e.g., the skin and the structure). When one or more robots move the skin and/or the structure such that the proximity of the skin relative to the structure is at the desired range (e.g., at a joining proximity between the first structure/skin and the second structure/structure, where the joining proximity may be a first surface of a first structure having a distance ranging from about 0.05 mm to about 150 mm from a second surface of a second structure) the adhesive may be flattened by a portion of the skin and/or the structure (e.g., a surface or a protrusion of the skin and/or structure) and pushed towards one or more sides of the feature and/or the skin and/or the structure and/or through a sight tube such as a weep tube. The visual device such a camera or a laser obtains information such visual or measurement information including a distance the adhesive is within the weep tube and/or a length of the adhesive outside of the feature and/or the skin and/or the structure. The visual device communicates (e.g., wirelessly or a wired connection) the information and/or data with a computer system (e.g., computer system 529) to determine via a processor (e.g., in the camera or the computer system) if the obtained information satisfies one or more criterion (e.g., range of distance the adhesive is within the weep tube and/or range of the length of the adhesive outside of the feature and/or the skin and/or the structure). If the one or more criterion is satisfied, the computing system communities with the one or more robots (e.g., each robot controller) to stop movement of the one or more robots, which stops the movement of the skin and/or the structure. With this proper design and disclosed process and gap control, the gap will correlate with the adhesive squeeze out of the feature, allowing precise gap achievement based on visually monitoring of the adhesive push out from the feature and/or the skin and/or the structure. A gap measuring feature may be added to the skin and/or the structure. For example, a weep tube may be incorporated into the skin and/or the structure. Another example of controlling the movement of the skin and/or the structure and/or controlling/maintaining a gap between the skin and the structure may include a tool of a robot of the robotic system applying an adhesive between the skin and the structure or designing the shape and size of the feature configured to contain an adhesive and applying/placing an adhesive within the feature by a tool of a robot of the robotic system at a location and/or in a desired volume for mating/joining/connecting of the components (e.g., the skin and the structure). A sensor may be mounted on a robot such as the robot's arm or on a tool of the robot. When the one or more robots move the skin and/or the structure such that the proximity of the skin relative to the structure is at the desired range (e.g., at a joining proximity between the first structure/skin and the second structure/structure, where the joining proximity may be a first surface of a first structure having a distance ranging from about 0.05 mm to about 150 mm from a second surface of a second structure) the adhesive may be flattened by a portion of the skin and/or the structure (e.g., a surface or a protrusion of the skin and/or the structure) and pushed towards one or more sides of the feature and/or the skin and/or the structure and/or through a sight tube such as a weep tube. The sensor obtains information and or data (e.g., force feedback information and/or data) such as a force generated by the surface or protrusion applied to the adhesive and then the sensor communicates the force data and/or information (e.g., wirelessly or a wired connection) with a computer system (e.g., computer system 529) to determine via a processor (e.g., in the sensor or the computer system) if the obtained information and/or data satisfies one or more criterion (e.g., range of force values obtained). If the one or more criterion is satisfied, the computing system communities with the one or more robots (e.g., each robot controller) to stop movement of the one or more robots, which stops the movement of the skin and/or the structure. Thus, as the required gap spacing is achieved, the force information and/or data enables the one or more assembly robots to stop further moving/pushing the one or more components such as the skin and/or the structure. The sensor may not be mounted on the robot but rather may be mounted on any structure configured to receive the force generated by the portion of the skin and/or the structure inserted into the adhesive.

In any of the disclosed embodiments, apparatuses and methods, the first adhesive, or the quick-cure adhesive or the adhesive within the feature of the skin and/or the structure may have a composition of a back-bone chemistry and a cure chemistry. The composition of the first adhesive, or the quick-cure adhesive or the adhesive within the feature of the skin and/or the structure may be the same as or different from the composition of the second adhesive or the structural adhesive. The back-bone chemistry of the first adhesive, or the quick-cure adhesive or the adhesive within the feature of the skin and/or the structure may include polyurethane, silicone, aliphatic, aromatic, polyether, polyester, polyurea, polyacrylate, polyamide, etc. and the cure chemistry may include acrylates (e.g., an ethyl or methyl acrylate), isocyanate reactions, hydrosilylation, thiolene, etc. For example, the first adhesive, or the quick-cure adhesive or the adhesive within the feature of the skin and/or the structure may include an polyurethane and an acrylate. Another example of the first adhesive, or the quick-cure adhesive or the adhesive within the feature of the skin and/or the structure may include a polyamide and an acrylate. The cure mechanism of the first adhesive, or the quick-cure adhesive or the adhesive within the feature of the skin and/or the structure may be electromagnetic radiation such as visible light (i.e., wavelengths of 400-750 nanometers) or ultraviolet (UV) radiation (i.e., wavelengths of 10-400 nanometers). Also, in any of the disclosed embodiments, apparatuses and methods, the second adhesive or the structural adhesive may have a composition including a back-bone chemistry and a cure chemistry. The back-bone chemistry of the second adhesive or the structural adhesive may include polyurethane, silicone, aliphatic, aromatic, polyether, polyester, polyurea, polyacrylate, polyamide, etc. and the cure chemistry may include acrylate, epoxy, silane, hydrosilylation, isocyanate, methacrylate, thiolene, etc. For example, the second adhesive or the structural adhesive may include an polyurethane and an acrylate. Another example of the second adhesive or the structural adhesive may include silicone and an epoxy. The cure mechanism of the second adhesive or the structural adhesive may include light, heat (including room temperature), moisture, or combinations thereof. Furthermore, the first adhesive and/or second adhesive may be applied or dispensed by a tool of a robot of the robotic system onto a surface of the structure or the skin. The first adhesive and/or second adhesive may be separated spatially, and the height of the first adhesive and/or second adhesive prior to assembly is/are greater than the maximum allowable bond gap to ensure contact in the assembled position.

In any of the disclosed embodiments, apparatuses and methods, the structural connection may include the first adhesive, and/or the second adhesive and/or the protrusion and recess/groove connection and/or the protrusion contacting the adhesive within the feature of the skin and/or the structure.

In any of the disclosed embodiments, apparatuses and methods, the skin may be comprised of an alloy, sheet metal, plastics, carbon fiber or a combination thereof. For example, the skin may be comprised of an alloy such as a high temperature and/or high strength alloy.

In any of the disclosed embodiments, apparatuses and methods, the structure may be comprised of an alloy, sheet metal, plastics, carbon fiber or a combination thereof. For example, the structure may be comprised of an alloy such as a high temperature and/or high strength alloy.

In any of the disclosed embodiments, apparatuses and methods, the spacing material may be transparent. The function of these spacing material is to set a gap (e.g., gap 1341,3080) spacing for the assembly of components such as a skin and a structure. The spacing material may be solid or hollow elements having any geometrical shape such as spherical, oval, round, elliptical shaped, etc. The spacing material may be solid or hollow glass beads. The spacing material may be material attached or bonded to the skin and/or the structure. The spacing material may be the material of the printed skin and/or structure. The spacing material may be co-printed with the skin and/or the structure. A diameter/hydraulic diameter of the spacing material may be used to control the gap between components (e.g., the skin and the structure) during assembly. In this embodiment, at least one degree-of-freedom is controlled by utilizing the spacing material (e.g., spheres or glass spheres) as a mechanical hard stop. This results in a mechanical kinematic connection between the components after a first adhesive or quick-cure adhesive, or the adhesive within the feature of the skin and/or the structure is cured and maintains their galvanic isolation.

In any of the disclosed embodiments, apparatuses and methods, the skin and the structure being proximate to one another for joining and/or the joining proximity may be a first surface of a first structure having a distance ranging from about 0.05 mm to about 150 mm from a second surface of a second structure. The first surface of a first structure may be a joining surface to the second structure or to a feature (e.g., a wall, recess/groove, protrusion, opening or feature containing an adhesive) of the second structure. The second surface of a second structure may be a joining surface to the first structure or to a feature (e.g., a wall, recess/groove, protrusion, opening or feature containing an adhesive) of the first structure.

In any of the disclosed embodiments, apparatuses and methods, obtaining information of a proximity regarding of the skin or the structure may include a distance between the skin and the structure, and/or a visual feature of the adhesive, where the visual feature is a view of the adhesive coming out from the feature and/or a joint, and/or a measurement of a force applied to a tool of a robot by the protrusion of the structure and/or skin contacting the adhesive, and/or controlling the movement of at least the skin or the structure based on the obtained information. One or more robots of the robotic system may control the movement of the skin and the structure. Controlling the movement may include stopping (e.g., one or more robots stopping or the arm of the robot stops moving) the movement of the skin or the structure. The obtained information may include a force feedback, and/or sensor information and/or data, and/or at least visual information, and/or information of a weep tube.

In any of the disclosed embodiments, apparatuses and methods, the skin and the structure including their features, recesses, grooves, protrusions, walls, openings, voids may be 3D printed for example, powder bed fusion (PBF) printed. Any recess or groove may be at single recess or groove or be continuous in a manner that will allow outer positioned recesses/grooves to make an uninterrupted connection. The recesses/grooves may be closely attached or bonded to the skin or structure or may be offset by an extension from the skin or the structure.

In any of the disclosed embodiments, apparatuses and methods, the protrusion configured to be inserted into the recess/groove may a tongue such that a tongue and groove connection is made between the skin and the structure. Also, the feature configured to contain the first adhesive or quick cure adhesive may be in the same recess/groove where the second adhesive or the structural adhesive is located or may protrude from any location on the skin or structure that minimizes overlap of the first and second adhesives. The connections/joints between the skin and the structure may be continuous throughout the skin's surface or the structure's surface or may be restricted to certain areas or printed portions of the skin or structure.

In any of the disclosed embodiments, apparatuses and methods, the skin and/or structure may have an attachment feature/point for a robotic arm of a robot of the robotic system to engage/grab and manipulate the skin and/or structure. The attachment feature/point may be co-printed with the skin and/or structure. At times the skin attachment to the structure may need to be delayed for placement of large parts into the built/assembled structures. It is also understood that this assembly process of the skin and structure is flexible and will allow for post (i.e., after the structure is formed and/or in a different location after the structure is assembled) attachment of the one or more skins.

The detailed description set forth above in connection with the appended drawings is intended to provide a description of various example embodiments and is not intended to represent the only embodiments in which the present disclosure may be practiced. The terms “exemplary,” “illustrative,” and the like used throughout the present disclosure mean “serving as an example, instance, or illustration,” and should not necessarily be construed as preferred or advantageous over other embodiments presented in the present disclosure. The detailed description includes specific details for the purpose of providing a thorough and complete disclosure that fully conveys the scope of the present disclosure to those skilled in the art. However, the present disclosure may be practiced without these specific details. In some instances, well-known structures and components may be shown in block diagram form, or omitted entirely, in order to avoid obscuring the various concepts presented throughout the present disclosure. In addition, the figures may not be drawn to scale and instead may be drawn in a way that attempts to most effectively highlight various features relevant to the subject matter described. In addition, it should be understood that some elements that are described in the singular can also be implemented as more than one element, and some elements described in the plural can also be implemented as a single element. For example, description of “a processor,” “a memory,” etc., should be understood to include implementations that have multiple processors, memories, etc., performing the task(s) described. Likewise, description of “multiple processors,” “multiple memories,” etc., should be understood to include implementations that have a single processor, a single memory, etc.

The present disclosure is provided to enable any person skilled in the art to practice the various aspects described herein. Various modifications to these example embodiments presented throughout the present disclosure will be readily apparent to those skilled in the art, and the concepts disclosed herein may be applied to other techniques for printing nodes and interconnects. Thus, the claims are not intended to be limited to the example embodiments presented throughout the disclosure, but are to be accorded the full scope consistent with the language of the claims. All structural and functional equivalents to the elements of the example embodiments described throughout the present disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f), or analogous law in applicable jurisdictions, unless the element is expressly recited using the phrase “means for” or, in the case of a method claim, the element is recited using the phrase “step for.”

What is claimed is:

1. A method of connecting a skin to a structure, wherein (i) the skin comprises a window and the structure comprises a complementary portion, the complementary portion corresponding to the window, or (ii) the structure comprises the window and the skin comprises the complementary portion, the method comprising:
controlling a robotic system to:
move at least the skin or the structure such that the window and the complementary portion are proximate to each other;
apply a first adhesive between the window and the complementary portion, wherein the first adhesive is a radiation cured adhesive;
cure the first adhesive by applying a radiation through the window to the first adhesive such that the skin is fixed to the structure; and
form a structural connection between the skin and the structure, wherein the structural connection is separate from the first adhesive.

2. The method of claim 1, wherein the first adhesive spans the window.

3. The method of claim 1, wherein the structure comprises a frame, and wherein controlling the robotic system comprises covering an outer surface of the frame with the skin.

4. The method of claim 1, wherein the structure is part of a vehicle.

5. The method of claim 1, wherein moving at least the skin or the structure comprises a robot moving the structure relative to the skin.

6. The method of claim 1, wherein moving at least the skin or the structure comprises a robot moving the skin relative to the structure.

7. The method of claim 1, wherein forming the structural connection comprises forming the structural connection such that the skin and the structure do not contact.

8. The method of claim 1, further comprising controlling a gap between the skin and the structure.

9. The method of claim 8, wherein controlling the gap comprises providing a spacing material between the skin and the structure.

10. The method of claim 9, wherein the spacing material is transparent to the radiation.

11. The method of claim 9, wherein the first adhesive contains the spacing material.

12. The method of claim 9, wherein at least the skin or the structure comprises the spacing material.

13. The method of claim 12, further comprising additively manufacturing at least the skin or the structure.

14. The method of claim 13, further comprising co-printing the spacing material with at least the skin or the structure.

15. The method of claim 1, wherein the complementary portion comprises a feature configured to contain the first adhesive.

16. The method of claim 15, wherein the feature is at least on an inner surface or an outer surface of the structure.

17. The method of claim 1, wherein moving at least the skin or the structure comprises retaining at least the skin or the structure without a fixture.

18. The method of claim 17, wherein retaining the skin or the structure without a fixture comprises controlling one or more robots of the robotic system to engage a corresponding attachment feature of at least the skin or the structure.

19. The method of claim 1, further comprising obtaining information of a proximity regarding the skin or the structure, and wherein controlling the movement of at least the skin or the structure is based on the information.

20. The method of claim 19, wherein the information comprises a force feedback.

21. The method of claim 19, wherein the information comprises at least visual information or information of a weep tube.

22. The method of claim 19, wherein controlling the movement comprises stopping the movement of at least the skin or the structure.

23. The method of claim 1, wherein forming the structural connection comprises applying a second adhesive between the skin and the structure.

24. The method of claim 23, wherein the second adhesive contains a spacing material.

25. The method of claim 23, wherein the first adhesive comprises a first composition and the second adhesive comprises a second composition, wherein the first composition is different from the second composition.

26. The method of claim 23, wherein the first adhesive comprises a first composition and the second adhesive comprises a second composition, wherein the first composition is the same as the second composition.

27. The method of claim 23, wherein forming the structural connection comprises curing the second adhesive such that the skin is connected to the structure.

28. The method of claim 27, wherein the first adhesive is cured at a first rate and the second adhesive is cured at a second rate, wherein first rate is different from the second rate.

29. The method of claim 23, wherein the structure comprises a first feature configured to contain the second adhesive.

30. The method of claim 29, wherein the first feature comprises a recess.

31. The method of claim 30, wherein the skin comprises a first protrusion and wherein controlling the robotic system comprises inserting at least a portion of the first protrusion within at least a portion of the recess.

32. The method of claim 1, wherein the window comprises a second feature configured to contain at least a portion of the first adhesive.

33. The method of claim 32, wherein the second feature comprises an offset from a surface of the skin by an extension element.

34. The method of claim 32, wherein the complementary portion comprises a second protrusion and wherein controlling the robotic system comprises inserting at least a portion of the second protrusion within the second feature.

35. The method of claim 34, wherein the window comprises an aperture and wherein controlling the robotic system comprises inserting the second protrusion within the aperture.

36. The method of claim 32, wherein the second feature comprises at least one or more walls.

37. The method of claim 36, wherein the complementary portion comprises a second protrusion, wherein one wall of the one or more walls comprises an aperture, and wherein controlling the robotic system comprises inserting the second protrusion through the aperture.

38. An apparatus comprising:
(i) a skin comprising a window and a structure comprising a complementary portion; or
(ii) the structure comprising the window and the skin comprising the complementary portion,
wherein the window comprises a first region of the skin or the structure, and the complementary portion corresponds to the window;
a first adhesive fixing the window to the complementary portion such that the first region is fixed to the complementary portion by the first adhesive, wherein the first adhesive is a radiation cured adhesive; and
a structural connection between a second region of the skin and the structure.

39. The apparatus of claim 38, wherein the first adhesive spans the window.

40. The apparatus of claim 38, wherein the skin comprises a first attachment feature configured to be engaged by a robot.

41. The apparatus of claim 38, wherein the structure comprises a second attachment feature configured to be engaged by a robot.

42. The apparatus of claim 38, wherein the structure comprises a frame and an outer surface of the frame is covered by the skin.

43. The apparatus of claim 38, wherein the structure is part of a vehicle.

44. The apparatus of claim 38, further comprising a spacing material between the skin and the structure.

45. The apparatus of claim 44, wherein the spacing material is transparent to radiation.

46. The apparatus of claim 44, wherein the first adhesive contains the spacing material.

47. The apparatus of claim 44, wherein at least the skin or the structure comprises the spacing material.

48. The apparatus of claim 38, wherein the complementary portion comprises a feature configured to contain the first adhesive.

49. The apparatus of claim 48, wherein the feature is at least on an inner surface or an outer surface of the structure.

50. The apparatus of claim 38, wherein the structural connection comprises a second adhesive between the skin and the structure.

51. The apparatus of claim 50, wherein the second adhesive contains a spacing material.

52. The apparatus of claim 50, wherein the first adhesive comprises a first composition and the second adhesive comprises a second composition, wherein the first composition is different from the second composition.

53. The apparatus of claim 50, wherein the first adhesive comprises a first composition and the second adhesive comprises a second composition, wherein the first composition is the same as the second composition.

54. The apparatus of claim 50, wherein the second adhesive is cured such that the skin is connected to the structure.

55. The apparatus of claim 54, wherein the first adhesive is cured by radiation at a first rate and the second adhesive is cured at a second rate, wherein the first rate is different from the second rate.

56. The apparatus of claim 50, wherein the structure comprises a first feature configured to contain the second adhesive.

57. The apparatus of claim 56, wherein the first feature comprises a recess.

58. The apparatus of claim 57, wherein the skin comprises a first protrusion within at least a portion of the recess.

59. The apparatus of claim 38, wherein the window comprises a second feature configured to contain at least a portion of the first adhesive.

60. The apparatus of claim 59, wherein the second feature comprises an offset from a surface of the skin by an extension element.

61. The apparatus of claim 59, wherein the complementary portion comprises a second protrusion extending into at least a portion of the second feature.

62. The apparatus of claim 61, wherein the window comprises an aperture and the second protrusion extends within the aperture.

63. The apparatus of claim 59, wherein the second feature comprises at least one or more openings or one or more walls.

64. The apparatus of claim 63, wherein one wall of the one or more walls comprises an aperture.

65. The apparatus of claim 64, wherein the complementary portion comprises a second protrusion, and wherein the second protrusion extends through the aperture.
